(19) United States
(12) Patent Application Publication
(10) Pub. No.: US 2013/0073344 A1
(43) Pub. Date: Mar. 21, 2013

(54) METHOD AND SYSTEM OF FUNCTION ANALYSIS FOR OPTIMIZING PRODUCTIVITY AND PERFORMANCE OF A WORKFORCE WITHIN A WORKSPACE

(71) Applicant: Karen Parent, Duncan (CA)

(72) Inventor: Karen Parent, Duncan (CA)

(21) Appl. No.: 13/451,463

(22) Filed: Apr. 19, 2012

Related U.S. Application Data
(60) Provisional application No. 61/477,131, filed on Apr. 19, 2011.

(51) Int. Cl. G06Q 10/06

(52) U.S. Cl. 705/7.39

(57) ABSTRACT

An integrated method for optimizing productivity and performance of a workforce (comprising at least one person) within a workspace, comprises the steps of a) acquiring at least one real time, continuous, data point set relating to said workforce, which includes data points relating to all activities, roles and functions of a person within a selected time frame, such data set being measured down to the level of a second (the “benchmark data point set”); b) measuring and comparing the benchmark data point set against previously compiled data points from within a usefully comparable, like workforces within a like workplaces and timeframes (the “comparable data point set”); and c) utilizing differences and similarities between the benchmark data point set and the comparable data point set to produce simulation models which identify and direct specific improvements to be made to increase the productivity and performance of the workforce.

### TECHNICAL FIELD

This invention relates to workplace time, task, facilities and personnel optimization.

### BACKGROUND

Healthcare today throughout the developed world is challenged with three core problems:

1) Shortage of healthcare professionals

2) Demand for improved patient outcomes

3) Inefficient healthcare delivery workflows

These problems are compounded by demographics with an aging baby boomer generation, expanding life expectancy and government budget pressures which place increasingly greater burdens on the cost-effective delivery of patient care services.

Current solutions to improve efficiencies in the healthcare delivery system are limited to these three approaches:
1) The made-for-manufacturing “Lean” solution, whereby hospitals adapt Lean principles to their own workflows in an effort to make them more effective.
2) Off-the-shelf software solutions that provide a framework but leave the healthcare institution to interpret and apply their own solution.
3) Operational efficiency consultants who may work on their own or in conjunction with approach #1 or 2, but without any proprietary and focussed methodology.

The consequence of these problems and their limited current solutions is burgeoning public healthcare costs. For example, healthcare expenditures in Canada in 2008 were $172 billion or 10.7% of GDP, an increase of 6.4% over the prior year and 70% of this was public expenditure (Canadian Institute for Health Information 2008). In the US, healthcare expenditures account for a staggering 15.3% of $12.4 trillion GDP ($1.9 trillion) and more than half of this is public expenditure. Throughout the developed world the average expenditure on healthcare is 9.0% of GDP and rising (OECD Health Data published July 2007 on 2005 statistics). Such expenditures are not sustainable.

Prior to the present invention, the open literature described two main approaches in dealing with healthcare workplace time, task, facilities and personnel optimization:
1) Statistical approaches: a popular tool in Healthcare studies is that of computer simulation. Simulation is a tool in which a mathematical model is built to act like (simulate) a system of interest (e.g. the specific Department such as ER) in certain important respects such as patient care scheduling, for example. However, to perform simulation, the behavior of several parameters (e.g. case duration) would be represented by a probability distribution. Detailed studies have shown conclusively that such mathematical representations are not appropriate to real-time practice data.
2) High level role/function approaches: References such as (1) Capuano T., Bokovoy J., Halkins, D, Hichings, K. (2004) Workflow Analysis: eliminating non-valued added work. J Nursing Administration 34:246-256.; (2) Value Added Care: a new way of assessing nursing staffing ratios and workload variability by Upenieks et al, J Nursing Administration, May 2007 show studies focusing on the healthcare provider and patient interactions only at the highest level (that is, Main Role and Function). The framework used comprised seven domains, namely: direct patient care, indirect activities, unit related, personal, knowledge exchange, documentation and suspensions. Data collection was self-measurement by the RN with very coarse measurement intervals of every 10-15 minutes. The focus of these high level studies was only on value-added activities (defined as of direct benefit to the patient).

None of the available approaches is of the depth and scope to direct meaningful practise and workplace optimization. It is an object of the present invention to obviate or mitigate the above disadvantages.

### SUMMARY

The present invention provides an integrated method for optimizing productivity and performance of a workforce (comprising at least one person) within a workspace, comprising the steps of:
a) acquiring at least one real time, continuous, data point set relating to said workforce, which includes data points relating to all activities, roles and functions of a person within a selected time frame, such data set being measured down to the level of a second (the “benchmark data point set”);
b) measuring and comparing the benchmark data point set against previously compiled data points from within a usefully comparable, like workforces within a like workplaces and timeframes (the “comparable data point set”); and
c) utilizing differences and similarities between the benchmark data point set and the comparable data point set to produce simulation models which identify and direct specific improvements to be made to increase the productivity and performance of the workforce.

The present invention further provides a computer implemented method of optimizing productivity and performance of a workforce (comprising at least one person) within a workspace, comprising the steps of:
a) acquiring at least one real time, continuous, data point set relating to said workforce, which includes data points relating to all activities, roles and functions of a person within a selected time frame, such data set being measured down to the level of a second (the “benchmark data point set”);
b) measuring and comparing the benchmark data point set against previously compiled data points from within a usefully comparable, like workforces within a like workplaces and timeframes (the “comparable data point set”); and
c) utilizing differences and similarities between the benchmark data point set and the comparable data point set to produce simulation models which identify and direct specific improvements to be made to increase the productivity and performance of the workforce.

The present invention further provides, in another aspect, a system for optimizing productivity and performance of a workforce (comprising at least one person) within a workspace, comprising a) a first computer for acquiring at least one real time, continuous, data point set relating to said workforce, which includes data points relating to all activities, roles and functions of a person within a selected time frame, such data set being measured down to the level of a second (the “benchmark data point set”) from a second computer over a network; b) at least one of the first or second computers configured to measure and compare the benchmark data point set against previously compiled data points from within a usefully comparable, like workforces within a like workplaces and timeframes (the “comparable data point set”); and c) utilize differences and similarities between the benchmark data point set and the comparable data point set to produce simulation models which identify and direct specific improvements to be made to increase the productivity and performance of the workforce.

The present invention further provides a computer-readable storage medium having computer-executable code encoded therein for collecting, analyzing, comparing and displaying benchmark data point set and comparable data point sets, as noted above.

### BRIEF DESCRIPTION OF THE DRAWINGS

FIG. 1 is a sample data compiler controller;

FIG. 2 is a graph showing a sample performance report by date;

FIG. 3 is a graph showing a sample performance report by role;

FIG. 4 is a graph showing a sample performance report by unit;

FIG. 5 is a graph showing a sample report on patients;

FIG. 6 is a flow chart showing a basic and preferred methodology within the FA process;

FIG. 7 is a photographic representation of the hierarchical database;

FIG. 8 is a floor plan screen shot schematic;

FIG. 9 is a bed status screenshot overview;

FIG. 10 is a resources screenshot overview

FIG. 11 is a data dictionary development illustration.

FIG. 12 is an illustration of adding a role to the Compiler.

FIG. 13 is an illustration of removing a role from the Compiler.

FIG. 14 is an illustration of removing a variable from the Compiler.

FIG. 15 is an illustration of editing the levels titles in the Compiler.

The figures depict an embodiment of the present invention for purposes of illustration only. One skilled in the art will readily recognize from the following description that alternative embodiments of the structures and methods illustrated herein may be employed without departing from the principles of the invention described herein

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### TERMS

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer.

Within the scope of the present invention “Data Dictionary” is taken to mean and object library or repository for a set of attributes and/or variables usable to build a customized containment hierarchy and a field list for a Functional Analysis study (defined below).

Within the scope of the present invention “Field List” is taken to mean a set of measurable, observable and mutually exclusive variables representing the tasks, activities, contacts and conversation topics listed in the Data Dictionary.

The present invention provides supporting technology and techniques that comprise Function Analysis (“FA™”), a proprietary (to the inventor) work-sampling methodology designed to collect continuous, multi-dimensional measurement data using a palm held device (PDA). FA is initiated with a detailed Data Dictionary of predetermined measurable tasks and activities in preparation for data collection. Using this Data Dictionary, FA then creates a hierarchical database that allows the collection of robust and quantitative data on multiple, nested levels. Using FA, continuous observations of health care provider activity provides time points to determine mean time and total time spent in role and function categories

The FA tool collects observational data on a variety of predefined work activities at multiple levels reflecting the scope and complexity of the work. A multi-level breakdown of tasks is generated in the form of a hierarchical database, known as a Data Dictionary, and forms the basis of the FA methodology. Within this Data Dictionary, an innovation is the representation of a job description as a complete set of discrete tasks or activities sufficient to enable a minute-by-minute measurement of a workday for a given professional. This Task or Activity definition includes not only the implementation of defined medical tasks (for which the professional is trained) but all the types of communication, the various interfaces involved together with the geographical (location; travel) modes involved in implementing these Tasks or Activities.

What is unique about this methodology, which differentiates it from other approaches, is the multifaceted and granular quantitative data gathered using the FA tool as a primary source of data collection which is augmented by a questionnaire and key informant interviews (qualitative sources). This represents a new approach to examining the physical and mental aspects of any workforce, and in particular the nursing practice. It is to be understood, however, that this method is equally suitable to a human and resource optimization analysis in many different types of workplaces.

Using the FA tool, continuous observations of worker (for example, a health care provider) activity provides time points to determine mean time and total time spent in each of the predetermined role and function categories. Hundreds of thousands of data points are gathered throughout the FA observational period. The data are aggregated and processed to produce evidence-based findings. FA data is sorted by role functions and activities to examine the time spent in specific types of activities associated with their role functions as well as the people contacted to do their work (with whom), their mode of communication (method of communicating) and finally the focus of conversation during the contact (topic of conversation). The data is then analyzed by using standard descriptive statistics and cross tabulations to determine the percent time, and time in minutes/hours spent of activities.

Finally, one-on-one key informant interviews throughout the period of observation with staff provide qualitative data on the daily context in which the work-space team operates. These key informant interviews augmented the FA data by capturing the critical thinking and decision-making processes associated with the observed staff roles.

The FA method and system provides a means to collect continuous multi-dimensional measurement data using, preferably, a palm held device (PDA) for use in any given work field. The FA method and system provides a hierarchical relational database that allows the collection of robust quantitative data on multiple distinct, yet interrelated levels of granularity. The FA protocol aims to preserve as many of the elements of naturally occurring behaviors, while still accomplishing the goals of any given study.

### ADVANTAGES

The evidence-based approach of the present invention provides workforce administrators with deep insights into their business and a means to objectively predict performance improvements with a high degree of accuracy. Using the FA methodology of the present invention, real-time data of workplace activities is captured, analyzed by comparison to a robust database of like workforces in like workspaces, allowing simulation modeling to be used to predict improvements in performance to facilitate decision making prior to costly and critical implementation of changes.

In a typical FA study, the study operators or observers would work in advance with key workplace personnel (for example, hospital administrators) to define their unique operational processes, develop process maps and activity/task dictionaries and then conduct the actual study.

It is contemplated that the data gatherers or observers may gather and record thousands of detailed observations (sometimes hundreds of thousands) over thousands of people-hours, capturing each person's activity by pre-specified category, following these activities throughout their shift and covering all personnel 24 hours each day, as applicable (the “benchmark data points”). These data points resulting are systematically analyzed using software and the results are compiled in reports. Within the scope of the present invention, “what-if” scenarios can be run based on the benchmark data-set compared to previously collected and collated data of like workforces in like workspaces, which can have millions of useful data points.

Without this valuable detailed data, many businesses and operations (such as hospitals) are running blind, without any baseline measurements nor any benchmarks for improvement nor processes to optimize workflow and improve customer services (such as patient care). This methodology is particularly needed in the healthcare field. Current burdens on healthcare systems throughout the developed world mean that such blindness cannot continue unresolved. The method the present invention addresses head-one the issue of inefficient healthcare delivery workflows, bringing light to shine on improving patient outcomes through better utilization of scarce and expensive healthcare professionals.

One preferred aspect of the present invention is to structure a relational database in a hierarchical manner so as to facilitate accurate data capture throughout the medical system-to-patient process.

Another key aspect of the present invention is the collection of “real-time” practice data rather than administrative-type data so as to ensure a real-life study emphasis.

The FA of the present invention focuses on an evidence-based philosophy to problem solving thus providing decision makers with an unprecedented level of insight into their organization and a means to objectively predict performance improvements with an exceptionally high degree of accuracy. There is no comparable technology in the art, to date.

As a methodology, FA can be summarized as follows: —
it provides a process for collecting essential information;
it emphasizes a comprehensive, systematic review;
it delivers both Qualitative and Quantitative data; and,
it is focused on Scope, Role and Function.

More specifically, the FA tool collects observational data on a variety of predefined work activities at multiple levels reflecting the scope and complexity of the work. This hierarchical database (Data Dictionary) can be described as follows: —

The structure of each entry at each level in the Data Dictionary is (Code; Field Name; Field Description) where: —
Code=a unique code for each task at that level
Field Name=recognizable identifier of the task at that level
Field Description=clear and unambiguous description of the identifier (in the Field Name)

Within the operational description below (in a hospital environment), the hierarchical and nested nature of the FA Data Dictionary architecture is apparent. Preferably, the levels are follows: —

Level 1 Main Role and Function—this level refers to the main role and functions of the particular healthcare worker, e.g. RN. The job description of the RN would be analyzed and key functions identified and assigned a code together with its corresponding filled name and field description. So, this first level of data collection captures time spent at the macro level (main role and function); for instance, nurses are responsible for assessing the patient, identifying desired outcomes and planning/implementing required interventions and treatments. The FA provides the opportunity to delve deeper into the complexity and scope of work within each of these main categories.

Level 2 Subactivities of Main Role—this refers to any sub-activities from the Main Role (Level 1) with clear reference linking. By way of example, at Level 1, a nursing function such as 20 (Code) Infection Control (Field Name) would have Level 2 functions identified separately as: —
20 Put on glove/gown/mask
20 Request Assistance
20 Take off glove/gown/mask
20 IC other

Typical work-sampling studies would collect and aggregate total time and percent time spent in this category alone; however, as seen, Infection Control has, in theory, several (4) discrete components describing the holistic nature of the control. The FA is designed to collect percent and total time in each of these discrete areas nested with the main role and function of infection control.

Level 3 Patient Link—the FA has additional levels of data collection nested within Level 1 (Infection Control). This level refers to specific patient information (such as patient ID, specific treatment intervention needs, ADT (admission, discharge, treatment), any anecdotal information that might be useful and so on. The distribution of time among activities is important, but the real value comes from understanding the patient/nurse encounter during the assessment, treatment, discharge planning etc. The ability to provide robust data at this level of detail is a unique feature of the FA.

Level 4 Mode of Communication—this refers to types of communication. For example, phone, pager, face-to-face, computer, etc.

Level 5 Communications with Whom—this identifies with whom the various types of communication occur. So, for example, with doctor, patent, RN, RPN, Home Care, Health Professionals, etc.

Level 6 Topic of Communication—this identifies all topics not just medical assessment. So, Administration, Care Plans, complaints, hospital policies, equipment, supplies, etc. . . . Note also at this level the patient would be required to sign a consent form to record such information; this is another unique feature of this methodology.

Through these three lower levels (4,5,6) in the Data Dictionary hierarchy, the investigator will have data that examine with whom the staff interact to do their work, modes of communication (face-to-face, phone, fax, pager etc.), and the focus of conversation and/or activity during the encounter (patient care, teaching, information exchange). Recording and analyzing the appropriate combination of these four dimensions allows any work-related tasks and activity to be accurately described down to the second.

This Methodology is easily extendable to further levels and functionality, as required.
the FA Methodology is a proprietary work-sampling methodology designed to collect continuous multi-dimensional measurement data.
the FA Methodology invention is based on a unique, multi-level and hierarchical database, referred to as the Data Dictionary.
the Data Dictionary contained within this FA Methodology invention provides a unique and detailed representation of the roles, functions and daily activities of a healthcare worker; this is the first example of such detailed information availability.
the FA Methodology invention provides data collection and analysis capabilities down to the second level. The utility of having this level of detail in a data set becomes evident when decision-makers need compelling quantitative data for strategic planning. Using a palm held device the observer toggles quickly between dimensions as the activity changes and/or topic of conversation changes to ensure the depth and breadth of detail required.
the FA Methodology is unique and differentiated from other approaches through its multifaceted and granular quantitative data as a primary source of data collection, and which is then augmented by qualitative data (a questionnaire and key informant interviews). This represents a new and unique approach to examining the physical and mental aspects of nursing practice.
the FA Methodology supports continuous observations of health care provider activity thus providing time points to determine mean time and total time spent in each of the predetermined role and function categories. Hundreds of thousands of data points are gathered throughout the FA™ observational period. The data are aggregated and processed to produce evidence-based findings.
the FA Methodology focuses on collecting real-time practice data rather than administrative-type data so as to ensure a real-life study emphasis.

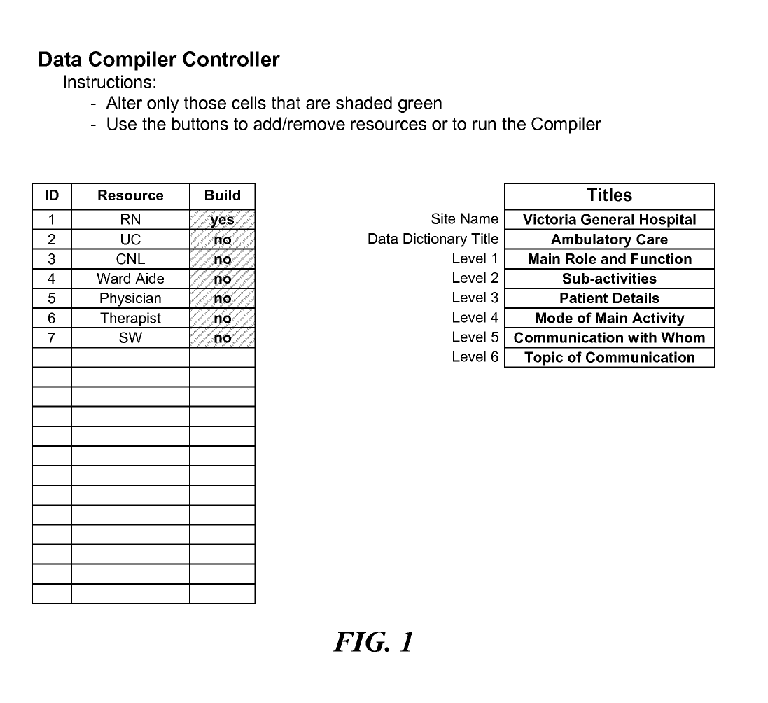

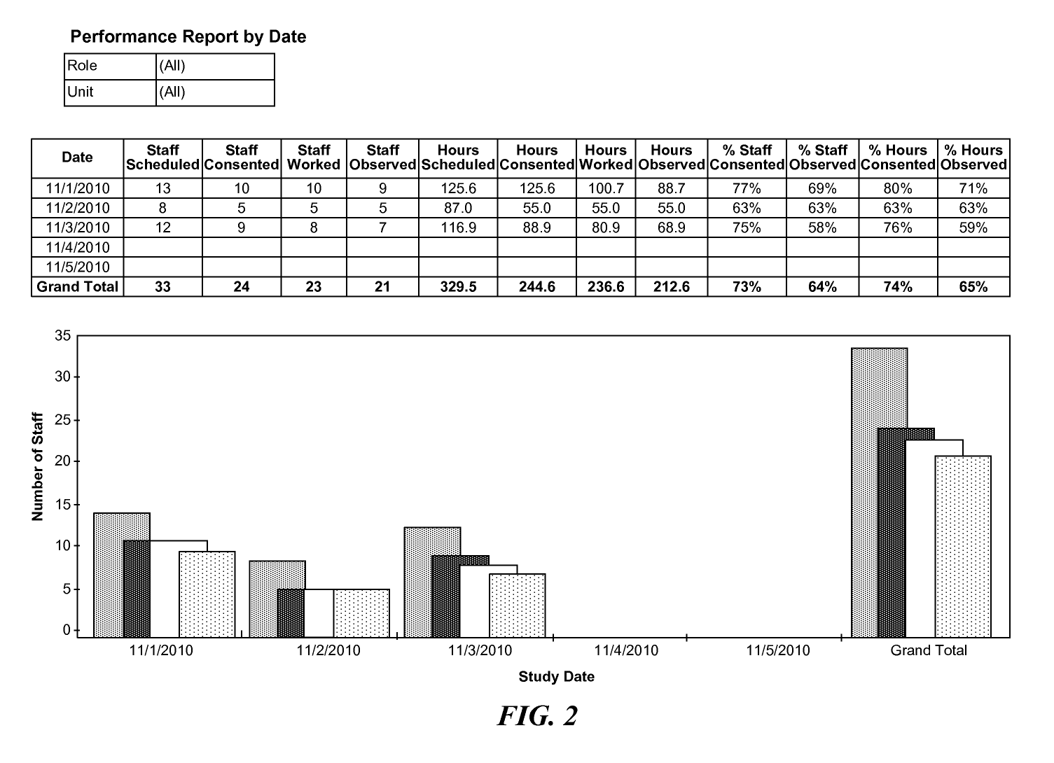

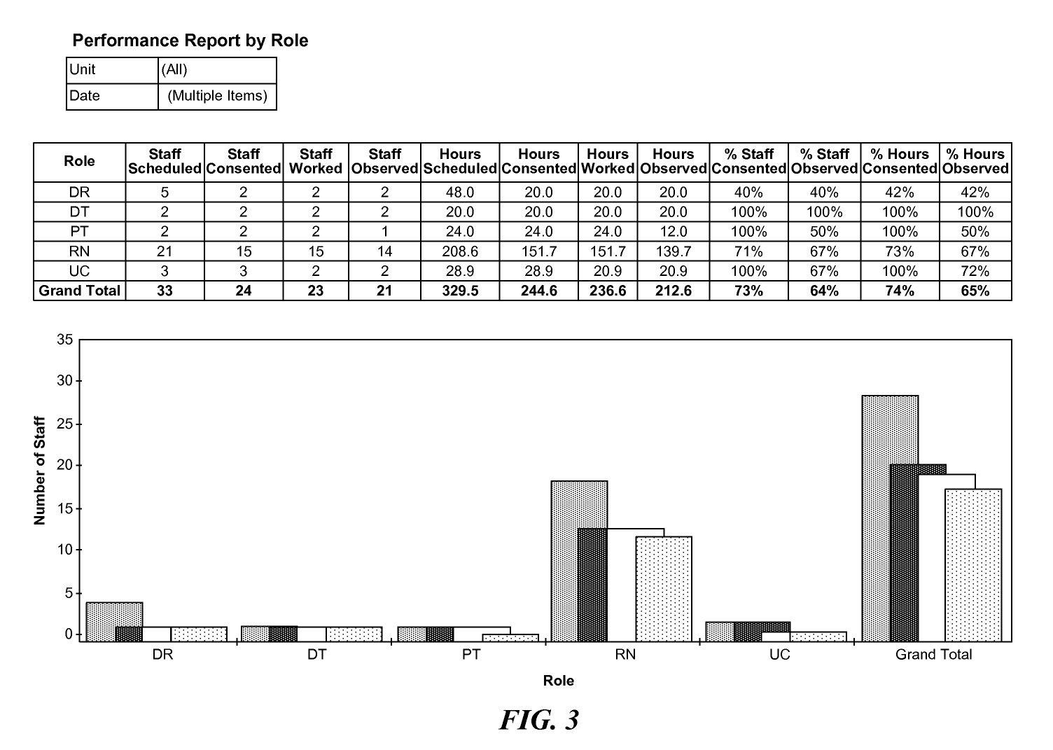

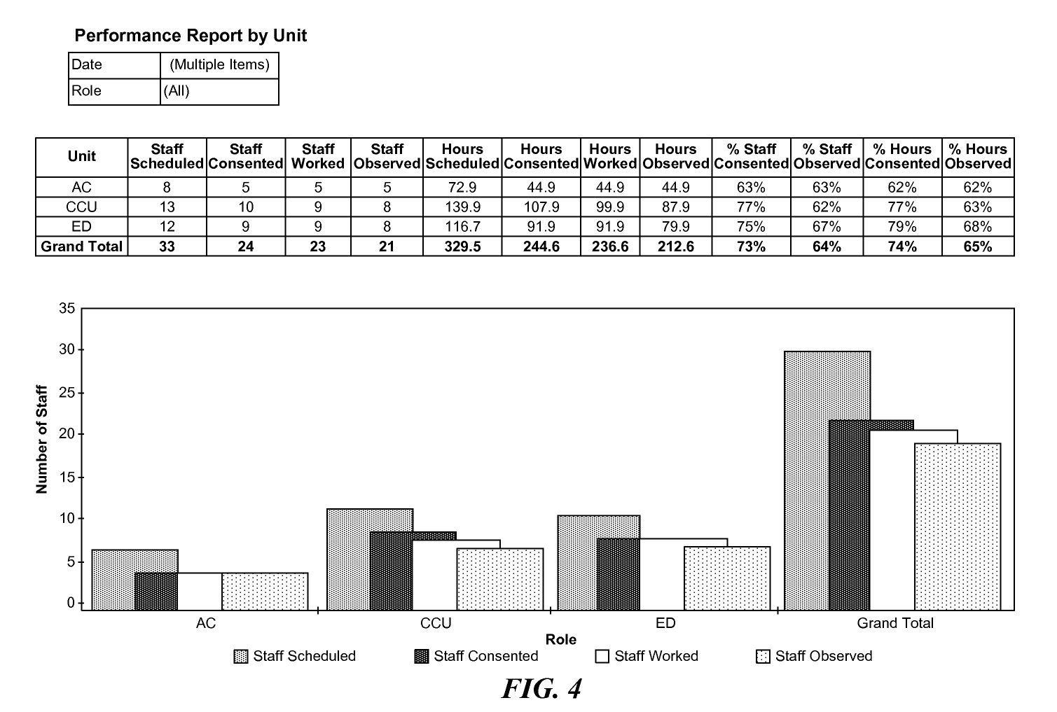

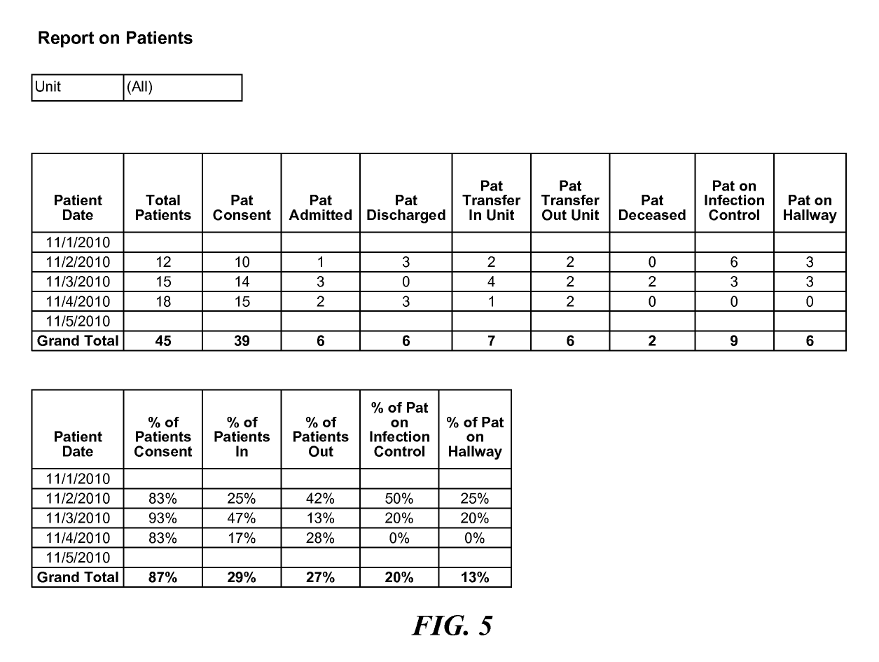

FIGS. 1-5 show the data compiler controller, and four performance and data reports generated in accordance with the method of the present invention.

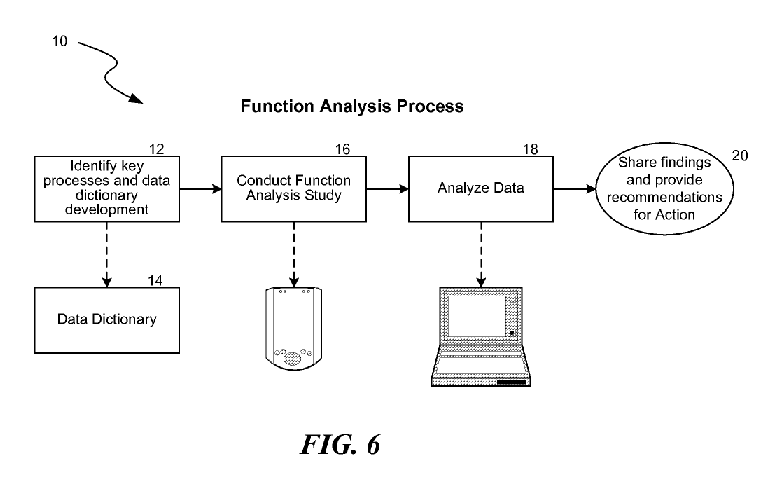

FIG. 6 describes a basic and preferred methodology of the FA process (generally at 10) commencing with, within any sector saught to be analyzed: identifying key processes 12 and developing data dictionary 14, conducting FA study 16, thereafter using FA to analyze data 18 and sharing data and analyses/making recommendations 20.

One key innovation in the approach of the present invention is the methodology in which a relational database in a hierarchical manner is created and used to facilitate accurate data capture throughout the care delivery process. Real-time practice data is collected through observation with a well-defined methodology (FIG. 6) rather than administrative-type data to ensure a real-life study emphasis. The FA approach focuses on an evidence-based philosophy to problem solving thus providing decision makers with an unprecedented level of insight into their organization and a means to objectively predict performance improvements with an exceptionally high degree of accuracy.

Within the healthcare sector, preparing for an observation period using the FA method and system occurs preferably by adhering to four phases—Preparation, Go-Live, Analysis and Completion. Within this health sector context, it takes preferably about 10-12 weeks from the start of the preparation phase to the end of the completion phase. This 12-14 week process does not include the change management work required to move evidence into action. The following describes a typical and preferred set of operational steps within a health care optimization context.

### Study Set Up

Face-to-face meetings with Senior Leadership, Unions, and other key stakeholders identified are held to share information, understand the context of the unit, and to solicit the level of support required to ensure success of the process.

Following the first round of introductory sessions that briefly explain the process, Unit managers, clinical nurse educators, and others as identified are invited to attend a half day more in-depth orientation. The agenda for the orientation includes:
1. Overview of CDMR
2. Overview of the FAs
3. Review and discussion of the roles and expectations between the VIHA and the unit participating in the FA work-sampling research.
4. Review and discussion of communication materials provided for distribution following ethics approval. It is recommended that the communications materials be vetted through the organization's own communications team. The communications package included:
   a. Frequently Asked Questions related to the FAprocess
   b. one-page information sheet for staff
   c. One-page information sheet for patients/family?
   d. CDMR Poster to provide information to the broader hospital staff and patients/families etc.
5. Determination and clarity around the roles and responsibilities for each person engaged in the work.

### Data Dictionary/Field List Development

The first step in analyzing the work of healthcare staff is to identify each measurable/observable task and activity and its relationship to other variables. Following the identification of fields for observation, each measurable task and activity and/or data object are given a description and definition with its meaning described. This collection is organized for reference into a comprehensive document called a data dictionary. The process of confirming the data dictionary variables is a vital to ensure staff engagement and buy-in from the beginning Staff representing their specific role and function within the core care team are generally asked to:
1. Describe the daily activities and the types of patients they take care of
2. Describe how patients are assigned to the unit staff
3. Indicate who they communicate with on any given day?
   a. Describe what topics are discussed with the following groups:
   b. Peers
   c. Allied Health
   d. Assistive Personnel
   e. Physicians
   f. Patients
   g. Families
   h. Other
4. Describe what activities/tasks they engage in that are the most important to them.
5. Describe what activities/tasks patients' value most.

The data dictionary is key to ensuring the model of care delivery is theory and reality driven and staff are aware of what's being collected. The data dictionary represents a typology of observations consisting of multiple variables placed in an organized format to facilitate the flow and collection of data.

The FA methodology has the ability to collect observational data on multiple levels. Within the health care sector (hospital optimization, six levels are preferred). Within each of these levels are variables that are considered observable and measurable. For instance, nurse data dictionary may have 1300 unique variables to observe and enter into the PDA. More specifically, the FA 10 tool collects observational data on a variety of predefined work activities, to the depth of six levels, reflecting the scope and complexity of the work. The first level of data collection captures time spent at the macro level (main role and function). For instance, nurses are responsible for assessing the patient, identifying desired outcomes and planning/implementing required interventions and treatments. The FA provides the opportunity to delve deeper into the complexity and scope of work within each of these main categories.

To illustrate this point, consider one nursing role and function such as the nursing assessment. Typical work-sampling studies collect and aggregate total time and percent time spent in this category alone. However, a nursing assessment theoretically is holistic in nature and should include assessing the individual from a variety of perspectives (psychosocial, physical, financial, spiritual etc.). The analysis from the FA can provide that level of detail.

The FA collects percent and total time in each of these discrete areas nested with the main role and function of the assessment. Following through with this example, the FA has an additional three levels of data collection nested within level 1 (assessment). The distribution of time among activities is important, but the real value comes from understanding the patient/nurse encounter during the assessment, treatment, discharge planning etc.

The ability to provide robust data at this level of detail is a unique feature of the FA method and system.

### Observer Training and Field Validation

Observer training, validity checks and piloting of the data fields takes place to validate the classification of the variables and to ensure internal consistency of observer behavior. This period allows for a final refinement of the fields prior to data collection and an opportunity for the observer and staff to acquaint themselves with the routine on the unit and each other. Where possible, the observer is assigned to the same staff member for the duration of the observational period to ensure continuity for the staff and to enhance data quality.

Preferably, over a multi-day period the data gatherers are prepared off-site in a classroom setting for the “go-live” observational phase. The training begins with each individual data gatherer going through the eight e-learning modules ending with a training module quiz. Following the e-learning sessions, prospective data gatherers are tested on their knowledge of the context, content, and their ability to work with the technology in the field.

### Go-Live Phase

During the observational period, both professional and non-professional staff are observed during their shifts (days, evenings, nights) and on the weekend. Unlike many observational studies, the observation is continuous, allowing for a factual and detailed snapshot of the work being done by the (in this scenario) healthcare team. The observer uses a hand held device (PDA) to capture the different activities being completed at the moment they occur. Within the health care sector specifically, because the research goes through a process of securing ethic approval, a detailed consent process for both the staff and patients is required. This is described below:

### Patient Consent

Although patients are not being observed directly, conversations between health care providers and patients and/or families are captured, which require patient consent. A member of the care team in collaboration with the unit manager, approach patients on each unit to request consent. Patients will be made aware of the following:
1. Only staff activities are being observed and data collected;
2. Observers will respect confidentiality related to all verbal exchanges between patients and healthcare providers.
3. Patients are asked to give permission for demographic data to be abstracted from their respective charts.
4. Patients are made aware that consent is voluntary—patient care will not be affected if they do not wish to consent.

### Exclusion Criteria

Patients who are unable to give informed consent are excluded from the study as well as patients under the age of 18 years, those who do not speak English, and those restricted to isolation rooms. In such cases the observers are instructed to wait outside the patient's room during any interactions between the healthcare provider and the patient.

### Staff Consent

Staff working on the unit are also invited to participate in the work-sampling study and sign a consent to:
1. Being observed on their shift as they go about their professional activities. No personal data is captured.
2. Respond to open-ended questions related to their perception of their workload that day, any unusual events that should be noted to put the FA data into context and any ideas they may have to improve the environment for themselves and the customers/patients.

### Analysis Phase

### Preparing the Data for Analysis

The volume of observational data points for each individual observed is significant and requires ongoing quality checks throughout the period of observation. The data is checked for any errors or omissions based on predetermined business rules.

### Function Analysis (FA Data:

FA details are sorted by role functions and activities to examine the time spent in specific types of activities associated with their role functions as well as the people contacted to do their work (with whom), their mode of communication (method of communicating) and finally the focus of conversation during the contact (topic of conversation). The data is analyzed by using standard descriptive statistics and cross tabulations to determine the percent time, and time in minutes/hours spent of activities. Specifically, the steps for analysis and reporting on the data include:
Data comprehensiveness validation (to ensure all datasets are present for observed shifts)
Data quality validations (to ensure timestamps are valid and shift duration is accounted for)
Compiling files collapse the hierarchical data into one line of data
Further manipulation of the data to preparation of analysis
Prepare descriptive statistics for each role and focused activities
Prepare a Report
Interpretation guide is prepared based on the descriptive data analysis

Table 2 illustrates typical Data Dictionary Typology.

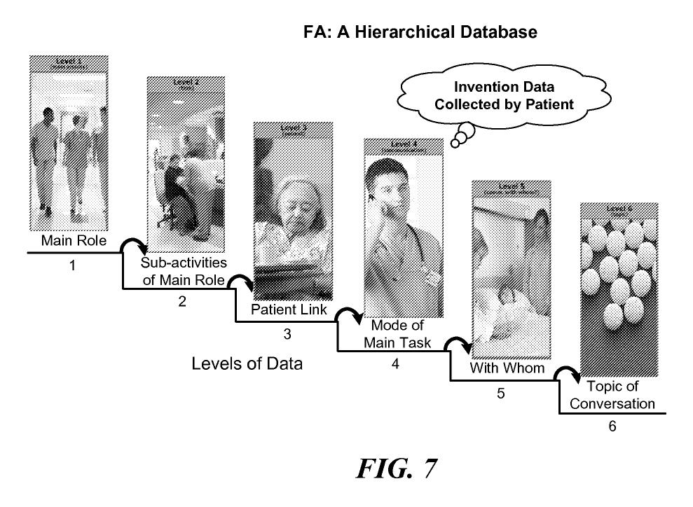

FIG. 7 depicts the hierarchical or nested nature of the FA database architecture. Using a PDA, the observer toggles quickly between dimensions as the activity changes and/or topic of conversation changes to ensure the capture of the required depth and breadth of detail

It is to be understood and appreciated that the method of the present invention is not limited for use in the healthcare sector, although there is great need for workforce optimization therein. In particular, this method may be employed in workplaces selected from the group consisting of a hospital, an acute care facility, an extended care facility, a psychiatric facility, and a geriatric facility.

This method may similarly be adapted and applied to a wide variety of other workforces, including, but not limited to: lawyers, teachers, other education providers, governments, social service providers, and truck drivers.

The present invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer or microcomputer configurations, including hand-held devices, Smartphones (for example, iPhone, Blackberry, Android), as an application on iPad or via multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during start-up.

The computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is mark-up language based, such as hypertext mark-up language (“HTML”), extensible mark-up language (“XML”) or wireless mark-up language (“WML”), and operates with mark-up languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

Further and in addition to the other computing system related disclosure provided herein, it will be readily apparent to one of ordinary skill in the art that the various processes and methods (and system) described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino® processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

The invention will be described by the following non-limiting examples:

### Example 1

### Workflow Process

### Function Analysis: Data Processing—Workflow Process

Roles and Responsibilities:
To collect, analyze and consolidate data over the duration of the study period
More specifically, to:
   Prepare compiler and, subsequently, the field lists, data dictionaries and CSV files;
   Educate and train the research team (also known as data gatherers or DGs) on how the data from PDAs is processed and structured, and how to navigate and calibrate the PDA;
   Assist with the coordination of the field testing exercise;
   Download data from PDAs, quality analysis and consolidation;
   Collect, secure, consolidate and clean study files in the database on a daily basis;
   Direct and manage the day to day operations as they relate to the WIN technology hardware (PDA) and software;
   Provide daily feedback (oral and written) to the research team; and,
   Generate the lean (consolidated) data file and final reports as required and requested.

Data Workflow

What is the Compiler?

The compiler is a tool that allows the modification of data variable options and architecture (how the data is organized) according to the study design requirements. The compiler generates 3 distinct files: the data dictionary, the field list and the CSV file for every role under observation. The data dictionary and the field list provide the data gatherer with detailed reference material specific to the study (see Appendix A).

The CSV (Text format data) file is a specifically formatted version of the field list which is uploaded to the PDA.

The study design articulates the sample size, the roles being observed and the research objectives. These details will determine what new roles and/or variables need to be added to the compiler.

Step 1: Preparing Compiler

A key outcome in the Prepare the Go-Live Team work package is to ensure all tools, documentation and materials are operational and standing-by prior to the go live study. Preparing the compiler is central to this process (see Appendix B). The compiler is the tool which generates the PDA files and reference documents used by the research team during the Function Analysis™ (FA) study. Every study is distinct and as such, the variables housed in the compiler must meet the specific criteria and objectives identified in the study design.

Key elements to be reviewed and revised in the compiler are:
Addition, deletion or redefinition of variables: removing the non-applicable variables, adding new variables representative of the program and/or roles and redefining existing variables with local language used on the unit(s)
Addition or deletion of staff roles: Removing staff roles no longer applicable, adding new roles be observed during the study
Adjustments to the data architecture: In some cases, changes to the variable hierarchy structure are necessary. Such changes will impact how variables are defined on every level of the task data.

Minor adjustments to the compiler may be required after field testing and client feedback. Note: It is not recommended to revise the compiler once the documents have been updated and field testing has been completed.

What is a Data Dictionary?

The Data Dictionary acts as an “object library” or repository for a set of attributes/variables used to build a customized containment hierarchy (6 levels) and field list for a Function Analysis™ study.

The field list is a set of measurable, observable and mutually exclusive variables representing the tasks, activities, contacts and conversation topics listed in the data dictionary.

Operational Definitions for each level are found in Appendix A.

Step 2: Preparing Materials and PDA for the Study

Once the documents (data dictionary and field list) have been approved and field tested, they are printed and used by the research team as reference documents throughout the study.

The final CSV files are then loaded onto the PDAs (see Appendix C) and the PDAs are run through a series of tests to verify operational functionality. These tests include:
correct CSV files loaded and visible on screen
operational navigation through all data levels
date and time zone correct
maximum battery strength
PDA calibration

Broken and sub optimal PDAs will be replaced and reported to the Operation Lead.

Step 3: Training Research Team and Conducting Field Testing

The week prior to the study, the research team will receive on-site training over a two day period. The data manager will support the training by providing instruction on the basic PDA operation (on/off, navigating the home screen, using the stylus, calibrating the PDA, troubleshooting and downloading/uploading data). The data manager will also assist in the development and execution of training scenarios aimed at providing the research team with an opportunity to practice and improve their data coding skills.

On the third day of training, the research team collects real time observational data at the study site. This is known as field practice. The objective is to provide the research team with an opportunity to become more familiar with the use of the PDA, to practice navigating through the 6 level hierarchical data structure, and to become more comfortable in the space where they will collecting the data. The data manager will support this step by analyzing the recorded data and providing feedback and technical assistance to the research team throughout the day.

Step 4: Preparing the Database

The purpose of the database is to secure, consolidate, store, organize and correct the observational data collected. The database is closely connected to and integrated with statistical information collected in the study schedule and reconciliation tables. Specifically, the names and ID numbers of the research team, staff name/role/ID number, and patient information is updated and verified using a standard naming convention. There are a number of specific steps required to prepare a database (see Appendix D).

A note about naming convention

Naming conventions are used when filing and storing data to limit data object uncertainty and ambiguity while providing a systematic and standard method of cataloguing files.

A note about the qualitative paperwork

In addition to collecting observational data using a PDA, the research team is also asked to collect qualitative information on a daily basis. The End of Shift Questions and the Data Gatherer Journal provide valuable contextual insights on the day's activities. The paperwork is reviewed for completeness by the Operations Lead and is labelled with the study file by the Data Manager.

Step 5: Managing the Data

At the end of every shift, each of the data gatherers will complete their paperwork (corrections sheet, end of shift questions and DG journal), place this information along with the PDA in an envelope and hand the envelope to the data manager. The data is then downloaded from the PDA to a computer where a unique study file and number is automatically created. This number is recorded on all paperwork related to the study file. A copy of the study file is then imported into the database where automated quality checks and corrections are performed. The original study file is saved and secured in a separate location and is never manipulated. Once a copy of the numbered study file is safely secured in a separate file, the data manager can begin to review and make corrections to the data. The correction sheet submitted by the data gatherer will identify the error (time, level and field) and note the correct variable to substitute in its place. The data manager will then conduct a manual review of the data and will highlight areas in the data file where clarification is required from the data gatherer (see Appendix E).

Step 5: Consolidating the Data

At the end of the study, the data will be consolidated into a single or “lean” file through an automated process. A final quality check is manually performed by the data manager before it is sent on for analysis. (Appendix F)

Function Analysis Study—Data Management Process—Draft Feb. 11, 2011

### APPENDIX A

### The Data Dictionary

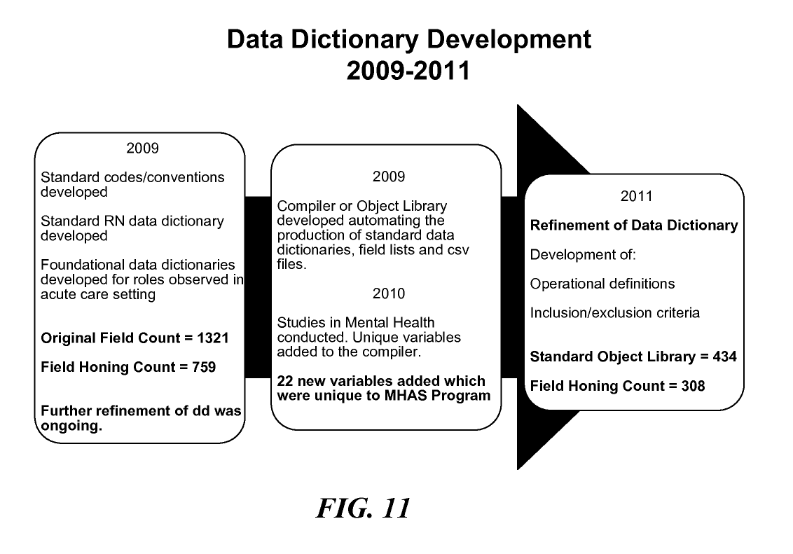

Development of the data dictionary: See FIG. 11.

The Data Dictionary acts as an “object library” or repository for a set of attributes/variables used to build customized containment hierarchies (data dictionary) for a Function Analysis study.

The Architecture: Data Dictionary Waterfall: “There are six levels of data in a data dictionary. Each level contains a list of options, from which you will choose.” See FIG. 7.

OVERARCHING PRINCIPLES—Each attribute or variable must have:
Standard language/terminology across roles
Standard codes across roles
Local or unique terms which can be mapped back to a standard term

Criteria for Inclusion/Exclusion of Object Library Attributes:
Measurable
Observable
Mutually exclusive
Capture 100% of the participants time
Must add value/contribute to understand/answer the CDMR research initiative (importance/relevance)—the variables identify task and/or activities related to the key metrics of optimization, productivity, quality and safety, and cost avoidance.

Data Dictionary Operational Definitions by Level

| | | | Criteria (the qualities that determine | |
|---|---|---|---|---|
| | | | appropriateness for inclusion and position of | |
| | | | elements within the data dictionary} | |
| | | Operational Definition: | Inclusion Criteria | Exclusion Criteria |
| | | “description of term as applied to a specific | (what is considered | (what is considered- |
| | | situation to facilitate the collection of | when deciding to | when deciding to |
| | | meaningful standardized data”—overarching | INCLUDE content | EXCLUDE content |
| Level | Name | principle | at this level?) | at this level?) |
| Level 1 | Primary Activity | Represents the main roles, functions, and/or | Activities of high cumulative | |
| | | activities of the person under observation and | duration. | |
| | | includes: | Activities of high | |
| | | Unit/Environment-Related: Activities | importance/relevance that | |
| | | associated with the nursing | occur instantaneously (occur | |
| | | unit/environment that are not patient- | in such short duration that | |
| | | specific, including activities related to | subsequent levels of coding | |
| | | travel, equipment, look for, miscellaneous, | are not feasible). | |
| | | housekeeping, code situation. | Activities of high | |
| | | FA-Related: Activities associated with the | importance/relevance or | |
| | | Function Analysis study itself; appears as | duration that are related to | |
| | | “Pause”, “FA Research Project” (includes | external circumstances. | |
| | | interview at end of day, speaking about the | | |
| | | project), “End of Data Collection”. | | |
| | | Personal: Personal activities not related to | | |
| | | patient care or unit activities such as lunch, | | |
| | | dinner, breaks, and personal | | |
| | | communication (telephone, email). | | |
| Level 2 | Sub Activity | Represents the sub-activities of Level 1, | May depend upon the | |
| | | providing a greater level of | requirements of the research | |
| | | specificity/refinement to the Level 1 Primary | question. | |
| | | Activity Areas. | Can be stated as an action | |
| | | | verb (e.g., I am patient | |
| | | | charting) | |
| Level 3 | Patient Link | Represents the patient(s) with/for/about | None. | |
| | | whom the Level 1 and 2 activities pertain. | | |
| Level 4 | Mode of Primary | Represents the mode (manner, means or | May depend upon the | |
| | or Sub Activity | method) employed to complete a Level 1/ | requirements of the research | |
| | | Level 2 activity. | question. | |
| | | | Can be stated as a noun. | |
| Level 5 | Communication | Represents the people, department, agency or | Includes the network of | |
| | with Whom | organization with whom the professional is | people required to meet the | |
| | | directly interacting. | care needs of the patient | |
| Level 6 | Topic of | Represents the subject of the communication. | | |
| | Communication | | | |

Sample Field List

| | | | 4-Mode of Primary or | 5 Communication | 6-Topic of |
|---|---|---|---|---|---|
| Primary Activity | 2-Sub-activities | 3-Patient Link | Sub Activity | with Whom | Communication |
| 10 Hands* | 20 Put on glove/gown/ | 999 Not Applicable | 999 Info Record- | 999 Care Management | 999 ADL-General |
| | mask | | Computer | Leader | |
| 20 Infection Control | 20 Request Assistance | 999 Patient Discharge | 999 Info Record-Offline | 999 Doctor-GP | 999 ADL-Patient Hygiene |
| 30 Interruption | 20 Take off glove/gown/ | 999 Patient Group | 999 Info Review- | 999 Family Meeting | 999 Administrative |
| | mask | | Computer | | |
| 50 Communication | 20 IC Other | 999 Patient New | 999 Info Review-Offline | 999 Hospital Security | 999 ALC |
| 60 Travel | 30 Knowledge Exchange | 999 Patient No | 999 Document-Handoff | 999 Med Student/ | 999 Appoint/Test |
| | | Consent | | Resident | |
| 70 Assess Evaluate | 50 Greeting patients/ | 999 Patient | 999 Email-Read | 999 OT | 999 Arrange Meeting/ |
| | visitors | Unknown | | | ____ |
| 80 Patient Needs | 50 Interview-Patient | 999 Patient 1 | 999 Email-Write | 999 Patient | 999 Arrange Peer Support |
| 90 ADL | 50 Knowledge Exchange | 999 Patient 2 | 999 Face to Face | 999 Patient Group | 999 Assessment |
| 91 IADLS | 50 Meeting-Family | 999 Patient 3 | 999 Fax | 999 Psychiatrist | 999 Bed Availability |
| 100 Medication | 50 Meeting-Other | 999 Patient 4 | 999 Filing | 999 Psychologist | 999 Bowel Care |
| 110 Treatment | 50 Meeting-Rounds | 999 Patient 5 | 999 Intercom | 999 Rehab Assistant | 999 Bowel Habits |
| 120 Documentation | 50 Report | 999 Patient 6 | 999 Not Applicable | 999 RN | 999 Care Plan |
| 130 Miscellaneous | 50 Verbal/Status Update | 999 Patient 7 | 999 Other | 999 Social Worker | 999 Census/Bed |
| | | | | | Assignment |
| 131 Equipment | 60 Med Room-E1 | 999 Patient 8 | 999 Pager | 999 Staff Group | 999 Concerns and |
| | | | | | Complaints |
| 132 Housekeeping | 60 Med Room-W1 | 999 Patient 9 | 999 Photocopy | 999 Student Nurse | 999 Cueing Action with |
| | | | | | Staff |
| 190 Waiting* | 60 Nursing Station-E1 | 999 Patient 10 | 999 Print | 999 Unit Clerk | 999 Cueing Action with |
| | | | | | Patients |
| 200 Lunch/Dinner/ | 60 Nursing Station-W1 | 999 Patient 11 | 999 Research-Computer | 999 Ambulance Service | 999 Death Related |
| Break* | | | | | |
| 210 Pause* | 60 Pt Room | 999 Patient 12 | 999 Research-Paper | 999 Central Processing | 999 Diet-Nutrition |
| | | | based | | |
| 220 Personal* | 60 Supply/Storage Rooms | 999 Patient 13 | 999 Take Out/Return | 999 Clinical Nurse | 999 Diet-Pt Meals |
| | | | Paperwork | Educator | |
| 230 Unusual Incident- | 60 Building Services | 999 Patient 14 | 999 Telephone-Transfer | 999 Clinical Nurse | 999 Directions |
| Patient* | Room-W1 | | call | Specialist | |

### APPENDIX B

### Working with the Compiler

The compiler is the main tool used to define how the data will be collected so it is necessary to have a clear perspective on how the data will be structured. That is:
A. How many different staff roles will be studied?
B. What variables will need to be added or modified to the Nursing Unit requirements?
C. Is there a major change required to the variable hierarchy?
   Once these questions are answered we can begin working with the compiler.

Set a new Compiler version:
i. For each study you will need to define a unique Compiler file:
   1. Copy the Standard Compiler file and paste in the desired folder
   2. Change the name of the file into a name more familiar to the nature of the study. Also add a reference to the date of modification and the version number since it is likely changes will be made, which you will want to keep track of (i.e. VictoriaGeneralHospital-11022010-V02)

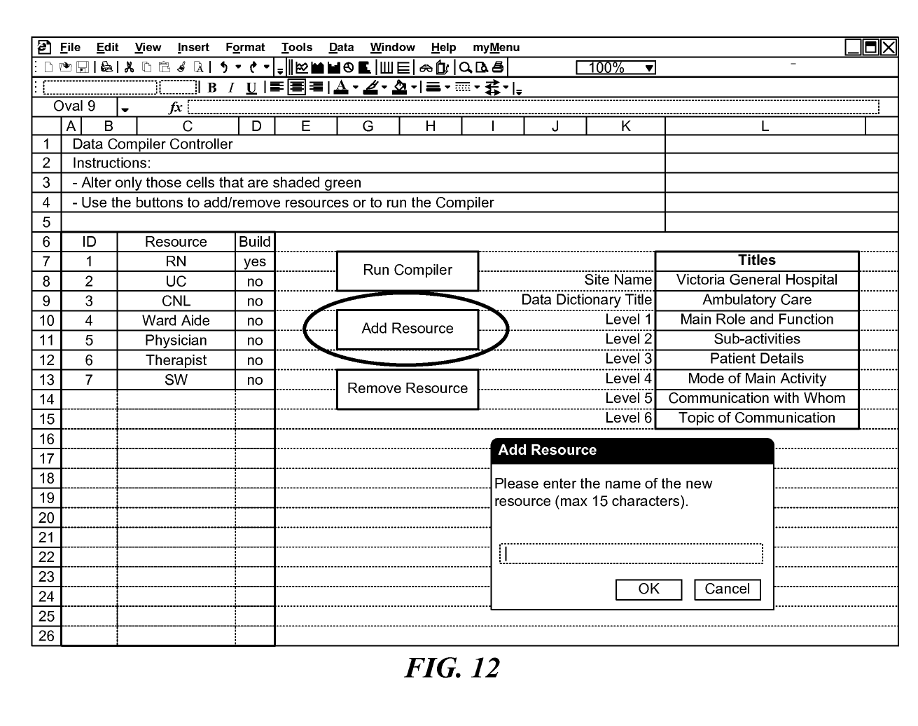

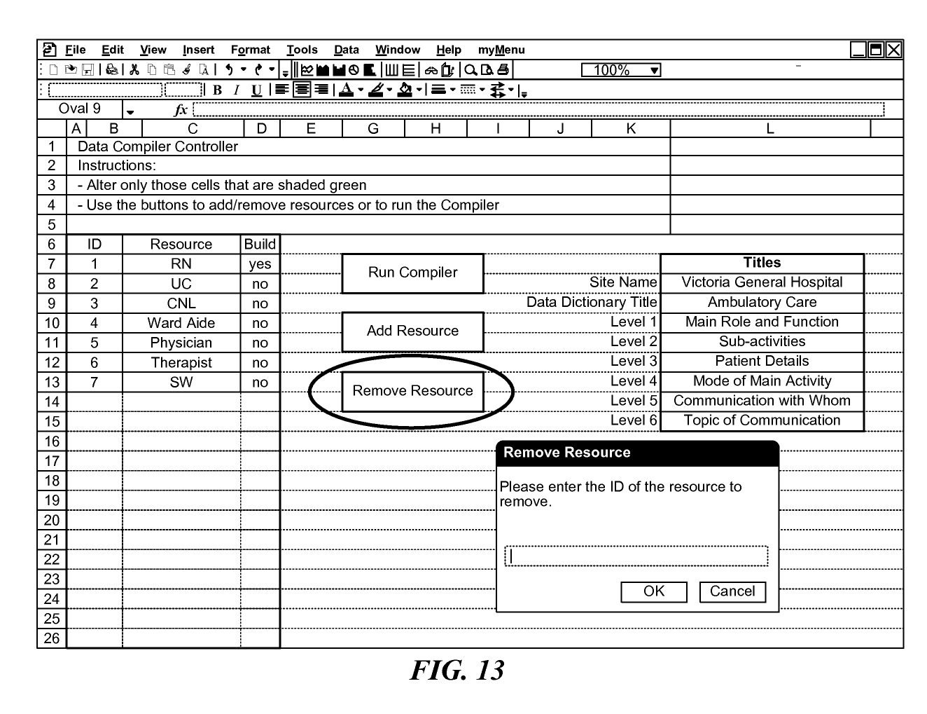

Adding or removing roles from the compiler:
i. To add a role to the Compiler, on the “Controller” Sheet, press the button “Add Resource” and type the role name. See FIG. 12.
ii. To remove a role from the Compiler, on the “Controller” Sheet, press the button “Remove Resource” and type the ID of the Role you want to remove. See FIG. 13.

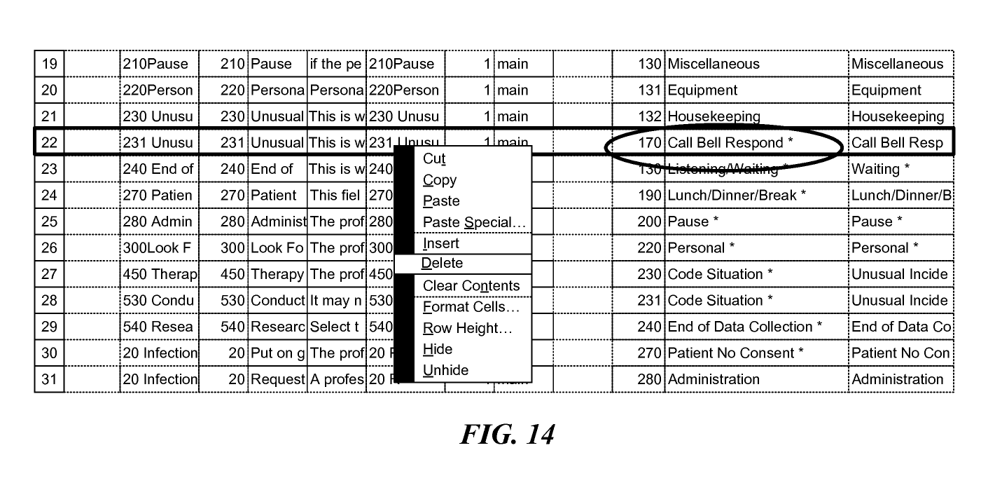

Editing, adding or removing variables from the compiler:
i. To edit a variable, go to the “Main Master” sheet. Look for the variable you want to edit. You can alter any blue-shaded cell between column J and column AI; with the exception of column N since changing cells in this column will alter the automated data handling process.
ii. To remove a variable from the Compiler, on “Main Master” sheet, select the row containing the variable you want to remove. Then, right click and select “Delete”. Remember to select the entire row or you will alter the automated data handling process. See FIG. 14.
iii. To add a variable, on the “Main Master” Sheet, insert a row anywhere in between the first and last variable listed on the table. Then Copy/Paste another variable in the just inserted row. Perform any editing required as in step i

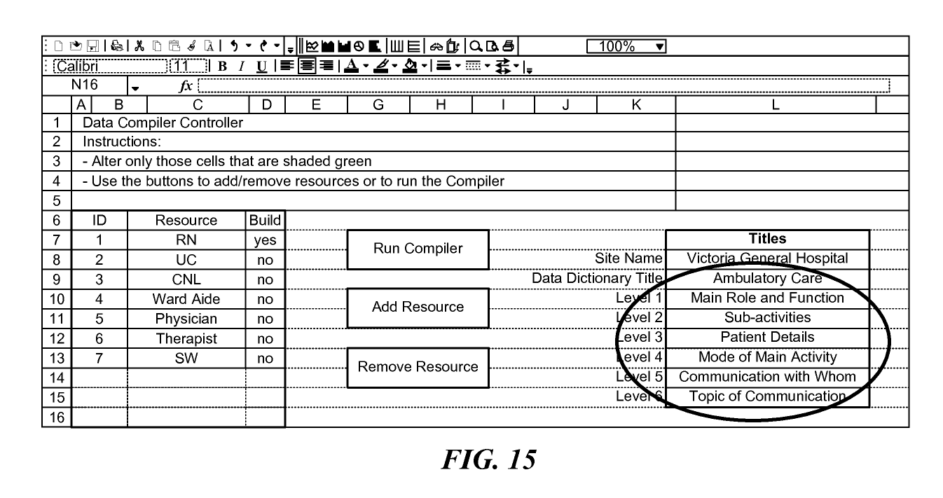

Changes to the variable hierarchy: For exceptional cases, the different levels of the data will need to be redefined. For example, one client required to analyze the body posture of the staff as they were performing their activities. Because patient characteristics were not relevant to that study, level 3 definition was changed to describe the different postures. Also, part of the study required to change other levels to track the type of furniture, type of movement, etc. Such changes are done by editing the levels titles and adding new variables. To edit the levels titles go to “Controller” sheet and edit cells L9 to L14. See FIG. 15.

### APPENDIX C

### Working with the PDA

During the study period, files will need to be uploaded to PDAs on a daily basis or as required.

Loading the PDA:
i. Identify the CSV files generated by the compiler with a unique version ID. For example, change “RNCSV” to “RNCSV02” to indicate that this is the second version of the file in the study
ii. Copy the CSV files that you want to upload to the PDA in to the following folder C:\WinFaSync\ToPda
iii. Connect the PDA to the laptop using the USB connection cable. The HotSync application will automatically start once the connection is made. Select the “Synchronize” option
iv. Once the synchronization is complete, ensure the Role menu on the CFA application of the PDA shows the same name as the CSV file you wanted to upload (identified by the version ID)
v. Select a role and check that all levels are showing the correct variable options
vi. When synchronizing, keep in mind that any record from the PDA will also be downloaded into “FromPda” folder

Testing the PDA:
i. Turn on the PDA
ii. Check Battery levels. Charge batteries if necessary (see charging batteries, page 11)
iii. Check that time and time zone are correct. To modify the time:
   a. Select “Preference Icon” on the Home menu
   b. Select “Date & Time”
iv. Check if the correct CSV files are uploaded:
   a. Select “CFA” on the Home menu
   b. Check the roles menu and see if the version ID matches the CSV file.

The Data Manager will need to also handle PDA maintenance and troubleshooting. The following are a few examples of potential problems and solutions:

PDA freezes and requires a soft re-set:
i. Turn the PDA over—you will see a small hole labelled “reset”
ii. Using a paperclip or the tip of the stylus (some tips can be unscrewed and there is a pin—like device attached)
iii. Place the clip/pin into this hole and lightly push and hold—this is a soft reset and should bring the program back on track
iv. If the clip/pin is held TOO long it is a HARD reset and the data as well as the CFA program will be lost

“Fatal Error”:
i. If “Fatal Error” occurs during the study—soft reset will usually fix this issue. If this continues, replace the PDA then upload the data from the PDA file noting 2 files will exist for this observation

“Unknown” (the user does not recognize the screen on the PDA):
i. The recommended course of action is for the user to hit the “home” button—this will return them to “home page” where the CFA icon will be displayed (if it is not—ensure that “ALL” programs are being displayed). Select the CFA program—a message will appear “do you want to resume study” select YES and the program will resume. If NO is selected the data gatherer will be required to load the CFA program again—entering names etc. Only select NO if it is a new study day

Charging Batteries:
i. Do not wait until the PDA dies. This affects many settings and reduces the lifetime of the battery
ii. Charge the PDA for at least 6 hours
iii. If you notice that a battery seems to be charging poorly, write down the serial number to keep track of the battery performance

### APPENDIX D

### Preparing the Database

Before starting to import the PDA files into the database, it is necessary to update study-specific tables in order for the data to make sense. The following steps must be followed to prepare the database:

Define the new database
i. Copy the standard version of the database to the desired folder
ii. Change the name of the file to a name representative of the study. Also, add a reference to the date of modification and a version number, since it is likely for changes to be made which you want to keep track of For example, a potential file name could be “VictoriaGeneralHospital-11022010-V02”.

Update the Patient table
i. You will need to update the patient table on a daily basis during a study. The information will come from OPS3 (Schedule Coordinator) in a file named “Patient List”. The information will include assigned patient ID, Unit and transfer type. Open the “Patients” table in the database and enter the information as listed on the Patient list.

Update the Data Gatherers table
i. At the beginning of the study, OPS3 will handle a list of the data gatherers with their assigned data gatherer ID. This information should not change over the entire study period. Open the “DGList” table in the database and enter the information as listed in the Data Gatherers list.

Update the Staff table
i. At the beginning of the study, OPS3 will handle a list of the staff members at the site with there assigned resource ID. This information should not change over the entire study period. Open the “StaffList” table in the database and add the information as listed on the Staff list.

### APPENDIX E

### Managing the Data

Once the database is set-up and ready, we can begin importing the PDA file data. Most of the quality checking and data manipulation are done automatically, however, some manual data corrections will be required.

Download the data from the PDA:
i. Make sure no files are located in the input (destination) folder before downloading. The input folder is located at C:\WinFa\Sync\FromPda\Study
ii. Create a folder named “Source” were you will archive all files coming from the PDAs. Organize this folder with subfolders labelled with the date when the data was gathered. The Source folder should be in the same directory location as the database file
iii. Open the Data gatherer envelope containing the PDA and correction sheet. Using a marker, assign a unique ID to the Correction Sheet at the top of the sheet
iv. Connect the PDA to the computer. If the PDA has no power, you will need to charge the battery for at least 30 min to be able to download the files. Synchronization will occur automatically
v. Once synchronization is complete, access the input folder and move the CSV file to the source folder
vi. Rename the file with the ID you just assigned to the correction sheet
vii. Recharge the PDA if necessary
viii. File the correction sheet in an envelope assigned to that data collection date

Import PDA data into the Database:
i. Copy the files you want to import into the database from the Source folder. Paste them to the same folder location as the database
ii. Open the database. Go to the operations form and press the “import files” button
iii. Once all files have been imported, you can delete the copies you just pasted to the database folder

Run automated quality checking and data correction:
i. Open the database. Go to the operations form and press the “Quality Checking” button

Perform manual data corrections:
i. Go through each row of data and ensure the information is making logical sense. OPS1 will guide you on this matter. Perform manual corrections as required
ii. Make manual data corrections. (Manual corrections will mostly be related to the corrections listed on the Correction sheet) To start, open the database and then open the “Main” table
iii. Pick a correction sheet from the selected envelope
iv. Look for the ID marked at the top of the correction sheet and under the field “FileID”, filter the table according to the selected ID
v. Modify the field data as required based on the notes from the correction sheet
vi. Mark the correction sheet as checked and file it back into the same envelope

### APPENDIX F

### Consolidating the Data

At the end of the study, the corrected data needs to be compressed. The idea is to keep only the records where all required levels are complete and recalculate the elapsed time of all recorded activities. Finally, the data needs to be prepared to be delivered to the client.

Compressing the data:
i. Open the database. Go to the operations form and press the “Data Compressing” button. The compressed data will appear in the “LeanData” table

Final Quality checking:
i. Once the data is compressed, a final manual check must be done. Review the “LeanData” and perform any necessary manual corrections

Generating CSV file:
i. Select all fields except “GroupID” and “Var” as they are not relevant to the client
ii. Copy/Paste the selection into a new spreadsheet in Excel
iii. Save the spreadsheet using a CSV file extension

### Example 2

### RN Data Dictionary

RN Data Dictionary: Ambulatory Care: Victoria General Hospital: April 2011: Prepared by Workflow Integrity Network

Level 1: Main Role and Function

| Code | Field Name | Field Description |
|---|---|---|
| 10 | Wash Hands* | It is important to capture the extent to which staff members are washing their hands. This includes washing with soap and water |
| | | as well as using sanitizing gel. |
| 20 | Infection | Infection Control covers activities related to the professional protecting themselves against infection by putting on/taking off |
| | Control | gloves, gown and mask. |
| 30 | Interruption | Actions on the part of another individual(s) that disrupt the professional's work activity. For example, a professional may be |
| | | interrupted by a colleague while documenting at the nursing station. The professional stops documenting to address the inquiry. |
| | | Continue past Level 1 if they conduct a conversation. |
| 50 | Communication | Professionals will engage in communication with other staff, patients, family and physicians throughout the shift. |
| | | Communication may be verbal (face to face), by telephone or by email. Note, in most cases communication between the |
| | | professional and patient will take the form of an Assessment or Treatment. You should only select Communication in these |
| | | cases if it is not clear that an Assessment or Treatment is occurring. |
| 60 | Travel | This section records the travelling a professional does on and off the unit. There are specific destinations of travel noted in |
| | | Level 2 on the field list. Once you have selected Travel from Level 1, select the correct destination from Level 2. Do not |
| | | enter the destination in Level 2 until your professional has arrived there. Continue to Level 3 if the professional travels to |
| | | the patient's room, in which case you should select the patient number in Level 3 and then return to Level 1. Once the |
| | | professional has reached her/his destination, it is important to return to Level 1 as soon as you can. Then, record the activity |
| | | happening at this new destination. This gives us 2 separate times-1 for the travel time and 1 for the time (for example) it took |
| | | to clean up the room. If the professional continues to travel after appearing to have arrived at their destination, reselect Travel |
| | | in Level 1 and repeat the same process. The exception: if you have selected Walk/Talk in Level 2 (the professional is walking |
| | | and talking with the patient) you will code down to level 6 to capture the topic(s) of conversation. |
| 70 | Assess Evaluate | Identification by a professional of the needs, preferences and abilities of a patient. Assessment considers the symptoms and |
| | | signs of the condition, the patient's verbal and nonverbal communication, medical and social history and any other information |
| | | available. The initial and ongoing assessment is critical because it provides the basis for the patient plan of care (Plan of Care |
| | | can include initial assessment, treatment/interventions/therapeutic group activity, outcomes etc). |
| 80 | Patient Needs | There are a number of tasks and activities that a professional may do over the shift to address the specific needs of patients. |
| | | For example, the professional may prepare, pick up and drop off a drink or snack for the patient. |
| 90 | ADL | Activities of daily living (ADLs): The things we normally do in daily living, including any daily activity we perform for |
| | | self-care (such as feeding ourselves, bathing, dressing, grooming). The ability or inability to perform ADLs can be used as a |
| | | very practical measure of ability/disability in many disorders. |
| 91 | IADLS | Instrumental Activities of Daily Living (IADL): The activities often performed by a person who is living independently in a |
| | | community setting during the course of a normal day, such as managing money, shopping, telephone use, travel in |
| | | community, housekeeping, preparing meals, and taking medications correctly. |
| 100 | Medication | Related to the drugs or curative substances used to treat disease and illness. |
| 110 | Treatment | Related to specific patient care and will include traditional treatments such as wound care, as well as psychosocial |
| | | interventions. The professional will work with patients suffering from psychosis, depression, and anxiety (for example), using |
| | | psychological methods such as therapeutic group or one to one therapy to engage and teach the patient techniques/skills they |
| | | can use to aid recovery and help manage any future crisis in their mental health. |
| 120 | Documentation | Any documentation including charting, updating of files, filling in forms, and reviewing charts. Please select the correct form |
| | | from level 2. Please note, some documentation may be computerized and some may be paper based. |
| 130 | Miscellaneous | Activities that fit outside the other main categories. |
| 131 | Equipment | A number of activities that are related to equipment such as cleaning, fixing or checking. |
| 132 | Housekeeping | A number of activities that are related to general housekeeping and cleaning. This may include cleaning the patient's room or |
| | | tidying the nursing station. |
| 190 | Waiting* | Select this option if your professional is waiting to speak to a professional, a patient to arrive, a meeting to begin etc. |
| 200 | Lunch/Dinner/ | The professional takes a scheduled lunch/dinner/break. This is NOT a working lunch. |
| | Break* | |
| 210 | Pause* | If the person you are observing needs to ask you a question or vice versa then you would put the PDA on pause to ensure you |
| | | don't skew the data. You would also put the PDA on pause if you needed to go to the bathroom etc. Putting the PDA on pause |
| | | keeps the actual working hours of the professional separate from anything related to the observer. |
| 220 | Personal* | Personal activities are not related to any work activities. For example, the professional may make a personal phone call, or |
| | | take a bathroom break outside of their regular Lunch/Dinner/Break. You do not need to code past Level 1. Any social |
| | | conversation with other staff, patients or their family should be coded under communication with social conversation in |
| | | Level 6. |
| 230 | Unusual | This is when your professional is directly involved with an unusual incident related to the patient. It could be a violent |
| | Incident- | patient, a patient fall etc. After coding this field you need to change to the next activity that they perform in order to deal |
| | Patient* | with the crisis. |
| 231 | Unusual | This is when your professional is directly involved with an unusual incident related to another staff member. It could be a |
| | Incident-Staff* | staff injury. After coding this field you need to change to the next activity that they perform in order to deal with the crisis. |
| 240 | End of Data | This is the last entry for your day of data collection. Always enter this immediately after the last activity has been |
| | Collection* | performed. |
| 270 | Patient No | This field should be used when a patient has not given permission to be observed. If the professional is in direct contact with |
| | Consent* | a patient then your PDA should be on Patient No Consent in Level 1. For example if your professional travels to a room |
| | | where the patient is a “no consent” you would code: Level 1-Travel, Level 2-Patient's Room, Level 3-Patient No Consent |
| | | and then return to Level 1 and select Patient No Consent*. You can leave your PDA on this until they change activities. If |
| | | the professional is not dealing directly with the patient then you are able to continue coding to Level 6. For example, Level |
| | | 1-Communication, Level 2-Knowledge Exchange, Level 3-Patient No Consent, Level 4-Face to Face, Level 5-RN, Level 6- |
| | | Care Plan. |
| 280 | Administration | The professional may conduct a number of administrative tasks that are listed in Level 2. |
| 300 | Look For | The professional may look for a number of items or people that are listed in Level 2. Select this term when they begin |
| | | looking, and then select what it is they are looking for in Level 2. Leave it selected like this until they either fmd or do not |
| | | find what they are looking for. Then select Found or Not Found in Level 2 accordingly. |
| 450 | Therapy | The professional may conduct a number of therapy activities on a patient. |
| 530 | Conduct | It may not be possible to capture some tasks and activities that are conducted when the professional has left the unit (e.g. |
| | Activities | private meetings behind closed doors). Where possible, select the relevant Level 1 category, but if you are not able to |
| | Off Floor* | determine what activity is taking place, use this field. |
| 540 | Research | Select this anytime a professional is participating in tasks related to this research project (such as signing consent forms |
| | Project* | or talking to WIN support staff). |

Level 2: Sub-activities

| Level 1 Category | | Field Name | Field Description |
|---|---|---|---|
| 20 | Put on glove/ | Put on glove/ | The professional puts on gloves, gown and mask. |
| | gown/mask | gown/mask | |
| 20 | Request | Request | A professional may need help if they have gloved and gowned and can't leave |
| | Assistance | Assistance | the isolation room (e.g. they may have forgotten some necessary supplies). |
| 20 | Take off | Take off | The professional takes off gloves, gown and mask. |
| | glove/gown/mask | glove/gown/mask | |
| 20 | IC Other | IC Other | An infection control activity that is not listed here. Please specify on corrections sheet. |
| 30 | Knowledge | Knowledge | After an interruption the professional may continue a conversation with the person |
| | Exchange | Exchange | who interrupted them. Please continue coding under interruption as long as the |
| | | | conversation lasts. Once the professional begins another activity return to Level 1 |
| | | | and choose the appropriate field. |
| 50 | Greeting patients/ | Greeting patients/ | The professional quickly greets patients or visitors on the unit. This occurs when |
| | visitors | visitors | the professional is travelling through the unit - it is a very quick hello. |
| 50 | Interview - | Interview - | The professional will meet face to face with the patient. This meeting may include other |
| | Patient | Patient | health care professionals such as nurses, doctors, residents, nursing students. Discussions |
| | | | may focus on, but not be limited to the following: how the patient is currently doing/ |
| | | | managing (eating, sleeping, self care), medication side effects, current treatments, |
| | | | patient symptoms, patient's current progress, care plan, discharge plan etc. |
| 50 | Knowledge | Knowledge | The professional may exchange knowledge (communicate) verbally, by telephone, by |
| | Exchange | Exchange | email etc. The mode of communication will be selected at Level 4. The person with |
| | | | whom the professional is communicating is selected and entered at level 5. |
| 50 | Meeting - Family | Meeting - Family | The professional will meet with the patient, the patient's family, and if |
| | | | appropriate, other members of a health care team to discuss the current and future |
| | | | plan of care for the patient. Topics of communication may include the patients current |
| | | | mental status (symptoms), medications, family history, patient's compliance |
| | | | (attending group) on the unit, patient progress etc. |
| 50 | Meeting -Other | Meeting -Other | Use this form of communication when the professional participates in an organized |
| | | | meeting that is not listed elsewhere. |
| 50 | Meeting -Rounds | Meeting -Rounds | The professional attends a multi-disciplinary team meeting (staff from multiple |
| | | | departments). It may include the many staff who are involved in the patient's care |
| | | | such as social workers, therapists, doctors, RN's etc. During this meeting they |
| | | | will review each patient on the floor. |
| 50 | Report | Report | Report is a formal verbal report handover that will occur at the beginning of |
| | | | every shift. The professionals will meet and review the current health status of |
| | | | individual patient's on the unit. |
| 50 | Verbal/Status | Verbal/Status | The professional will provide a verbal or status update on their patients or on |
| | Update | Update | the unit in general to another professional. Note, this is a quick overview rather |
| | | | than the detailed report and can occur any time throughout the day. |
| 60 | Med Room - E1 | Med Room - E1 | This is the medication room where the professionals will access and prepare |
| | | | medication for East 1. |
| 60 | Med Room - W1 | Med Room - W1 | This is the medication room where the professionals will access and prepare |
| | | | medication for West 1. |
| 60 | Nursing | Nursing | The E1 nursing station serves as the administrative centre for unit. It is |
| | Station - E1 | Station - E1 | usually centrally located. |
| 60 | Nursing | Nursing | The W1 nursing station serves as the administrative centre for unit. It is |
| | Station - W1 | Station - W1 | usually centrally located. |
| 60 | Pt Room | Pt Room | A patient's room. Please select the patient number in Level 3 and then |
| | | | return to Level 1. |
| 60 | Supply/Storage | Supply/Storage | Any storage room or closet used for E1 or W1. |
| | Rooms | Rooms | |
| 60 | Building Services | Building Services | This is the room where housekeeping store supplies. Located around the corner |
| | Room - W1 | Room - W1 | from the W1 nursing station |
| 60 | Dining Room - W1 | Dining Room - W1 | The kitchen is set up for the patients to use throughout the day. Food trays are |
| | | | brought to the floor and delivered to the patients in this area. |
| 60 | Documntatn | Documentation/ | Documentation, Education and Resources Room located in W1 around the corner from |
| | Educatn Rm - W1 | Education Room | the nursing station. |
| 60 | Games Room | Games Room | This is where the patients will sit, read, visit, do their laundry, or play music |
| | | | or games. It is located in between the E1 and W1 and is shared by both units. |
| 60 | Hall | Hall | Select this field if the professional stops in the hallway. |
| 60 | Hallway Interview | Hallway Interview | Select this field if the professional stops at either of the inteview areas |
| | Chairs - E1 | Chairs - E1 | located at either end of the hallway. |
| 60 | Hallway Interview | Hallway Interview | Select this field if the professional stops at the inteview area located at |
| | Chairs - W1 | Chairs - W1 | the end of the hallway. |
| 60 | Interview | Interview | The seclusion room for East 1 is where a patient would be placed in isolation |
| | (Seclusion) | (Seclusion) | at any hour of the day or night in which the doors and windows are locked from |
| | Rm - E1 | Rm - E1 | the outside. This action is in effort to decrease stimuli that might be causing |
| | | | or exacerbating the patient's emotional distress. |
| 60 | Interview | Interview | The seclusion room for West 1 is where a patient would be placed in isolation at |
| | (Seclusion) | (Seclusion) | any hour of the day or night in which the doors and windows are locked from the |
| | Rm - W1 | Rm - W1 | outside. This action is in effort to decrease stimuli that might be causing or |
| | | | exacerbating the patient's emotional distress. |
| 60 | Kitchen - E1 | Kitchen - E1 | The kitchen is set up for the patients to use throughout the day. Food trays are |
| | | | brought to the floor and delivered to the patients in this area. |
| 60 | Linen Cart - E1 | Linen Cart - E1 | This is the cart that holds the linen for patient rooms, such as sheets, |
| | | | pillowcases etc for East 1 |
| 60 | Linen Cart - W1 | Linen Cart - W1 | This is the cart that holds the linen for patient rooms, such as sheets, |
| | | | pillowcases etc for West 1. |
| 60 | Lounge TV Room - E1 | Lounge TV Room - E1 | The TV Room located on the right of the hallway or East 1. |
| 60 | Nursing Conference | Nursing Conference | The Conference room is where the professionals will conduct meetings |
| | Room - E1 | Room - E1 | (i.e. staff, rounds) for East 1. |
| 60 | Nursing Lounge - W1 | Nursing Lounge - W1 | This is the room where staff can leave their personal belongings and go for |
| | | | their breaks in West 1. |
| 60 | Patient Lounge - E1 | Patient Lounge - E1 | Lounge area for patients to sit, read, or watch TV in East 1. |
| 60 | Patient Lounge - W1 | Patient Lounge - W1 | Lounge area for patients to sit, read, or watch TV in West 1. |
| 60 | Patient Services | Patient Services | This is the office where the Patient Services Manager works. |
| | Manager - E1 | Manager - E1 | Located in East 1. |
| 60 | Porter | Porter | Select this field when the professional porters equipment. For example, a |
| | Equipment | Equipment | wheelchair or vitals machine. |
| 60 | Porter Pt | Porter Pt | Select this field when the professional porters a patient. They could be |
| | | | in a wheelchair or in a bed. |
| 60 | Social Workers | Social Workers | This is the office or desk where the Social Worker works. |
| | Office | Office | |
| 60 | Walk/Talk | Walk/Talk | Walking and talking at the same time. |
| 60 | Washroom - | Washroom - | There are a number of patient washrooms located on the floor. |
| | Patient | Patient | |
| 60 | Washroom - | Washroom - | Washroom that staff members use. |
| | Staff | Staff | |
| 60 | E1- Other | E1- Other | Any destination on on E1 not listed here. |
| 60 | Leave Floor | Leave Floor | Select this field when the professional leaves the floor. Then return to |
| | | | Level 1 and code Travel followed by the destination in Level 2. |
| 60 | Leave Hospital | Leave Hospital | Any destination that takes the professional out of the hospital. For example, |
| | | | the OT will take patients to the track for a power walking session or the |
| | | | SW will take a patient to the store. |
| 60 | Lobby | Main floor Lobby | The Main floor lobby area of the Health Centre, located outside of the two |
| | | | observed units. |
| 60 | Return Floor | Return Floor | Select this field when the professional arrives back at the ward. Then return |
| | | | to Level 1 and code their next activity. For example, Travel, Unit Clerk Desk. |
| 60 | Travel Other | Travel Other | A travel destination that is not listed here. Please specify on corrections sheet. |
| 60 | W1- Other | W1- Other | Any destination on on W1 not listed here. |
| 70 | Chck Blood | Check Blood | The professional takes the blood from the patient in order to test their |
| | sugars -on patient | sugars -on patient | blood sugar levels. |
| 70 | Check Blood | Check Blood | The professional tests the blood on the ACCU Check or other machine to find out |
| | sugars -machine | sugars -machine | the patient's blood sugar levels. |
| 70 | Check-in with | Check-in with | The professional will travel to one or more patients' rooms to check in on |
| | Patient | Patient | the patient. The check in will typically occur as a first activity in the morning |
| | | | and on the evening/night shift. This is a quick face to face interaction where |
| | | | the professional may greet the patient if they are awake. It also allows the |
| | | | professional to ensure every patient assigned to the unit is accounted for. |
| 70 | Mental Status | Mental Status | The professional is constantly assessing the patient's current mental status |
| | Assessment | Assessment | using therapeutic (verbal and non verbal) communication. The professional may |
| | | | ask questions related to the patient's orientation (date, place and time); their |
| | | | sense of safety on the unit; explore their psychotic symptoms (i.e. “do you have |
| | | | racing thoughts?, trouble concentrating?, sleeping? or with your memory?”) |
| | | | This conversation can happen at any time or occur anywhere on the unit. These and |
| | | | similar type questions should not be confused with social conversation but rather |
| | | | is part of the ongoing assessment of the patient. |
| 70 | Monitor Fluid | Monitor Fluid | The professional will monitor and assess the patient's fluid intake to ensure |
| | Volume | Volume | the patient is not dehydrated. The professional will document the patient's fluid |
| | | | intake and output several times a day. |
| 70 | Nursing | Nursing | Often the new patient or initial assessment is completed prior to the patient |
| | Admission | Admission | being admitted to the unit (e.g. in Emergency Services). However, if the patient |
| | Assessment | Assessment | is a direct admission, the professional is responsible to assess/evaluate the |
| | | | patient. The Nursing Admission Assessment is a paper based assessment that provides |
| | | | baseline information on the patient's physical and mental health, (i.e. patient's |
| | | | physical symptoms, IADLs, alcohol/substance use, general appearance, behaviour, |
| | | | speech, mood, cognitive function, symptoms - delusions and/or hallucinations, |
| | | | personal history - living arrangements, supports, and financial situation) |
| 70 | Physical Routine | Physical Routine | Checking the patient's temperature, respiratory rate, heartbeat (pulse), blood |
| | Vitals | Vitals | pressure etc. This also includes weighing the patient, which happens every Monday. |
| 70 | Rounds - | Rounds - | Each patient on the unit is monitored or observed by a professional at specified |
| | Observational | Observational | times throughout the day/evening/night. For example, a patient who has been considered |
| | | | a high suicide risk would receive constant 1-to-1 supervision. Other patients might |
| | | | require close observation (every 15 minutes), frequent observation (every thirty |
| | | | minutes) or general observation (every hour). |
| 70 | Screen | Screen | The patient is asked a series of questions (Antibiotic Resistant Organism Screening |
| | Patient | Patient | Form) when they are first admitted to the ward. If they answer yes to one or more |
| | | | of these questions, they are then screened for MRSA/VRF/H1N1 as part of the patient's |
| | | | initial assessment. Swabs are taken from the nasal, rectum and any wound sites |
| | | | and then sent to the lab for analysis. |
| 70 | Specimen | Specimen | The professional takes samples of urine, feces, sputum, blood etc. |
| | Collection | Collection | |
| 70 | Staff -Assist | Staff -Assist | The professional assists another professional in an assessment or evaluation. |
| | | | Specify who they are assisting in level five. |
| 70 | Staff -Mentor | Staff -Mentor | The professional watches another professional perform an assessment or evaluation |
| | | | and gives them instruction. Specify who they are teaching in level five. |
| 70 | Staff -Observe | Staff -Observe | The professional observes another professional conduct an assessment or evaluation. |
| | | | Specify who they are observing in level five. |
| 70 | Unit Observation | Unit Observation | The professional will survey the unit (often from the Nursing station or Hallway) |
| | | | and assess patient location and behaviour. |
| 70 | Weigh Patient | Weigh Patient | The professional will weigh the patient. |
| 70 | Assess Other | Assess Other | An assessment or evaluation activity that is not listed here. Please specify on |
| | | | corrections sheet. |
| 80 | Dispose Dirty | Dispose Dirty | The professional disposes of dressings, needles, soiled linens etc. |
| | Linen/Materials | Linen/Materials | |
| 80 | Drop off Drink/ | Drop off Drink/ | The professional drops off a drink, meal or snack for the patient. |
| | Meal/Snack | Meal/Snack | |
| 80 | Drop off Equipment | Drop off Equipment | The professional drops off equipment for the patient to use. |
| 80 | Drop off Linen/ | Drop off Linen/ | The professional drops off linen, blanket or laundered clothes for the patient. |
| | Blankt/laundy | Blanket/Laundry | |
| 80 | Drop off OTHER | Drop off OTHER | The professional drops something off for the patient that is not listed here. |
| | | | Please specify on corrections sheet. |
| 80 | Drop off | Drop off | The professional will drop off patient belongings (e.g. Clothes) |
| | Patient Belongings | Patient Belongings | |
| 80 | Drop off Supplies | Drop off Supplies | The professional drops off supplies. |
| 80 | Hand Out Pt | Hand Out Patient | Patient privileges include day/weekend passes, daily cigarettes and needs (e.g. Razors, |
| | Privileges/Needs | Privileges/Needs | clothes or other patient belongings). The cigarettes/razors are kept at the nursing |
| | | | station and the professional will monitor this activity. |
| 80 | Make Snack/Meal | Make Snack/Meal | The professional makes a snack for a patient between meal times. |
| 80 | Pick up Drink/ | Pick up Drink/ | The professional picks up a drink/meal or snack for the patient. |
| | Meal/Snack | Meal/Snack | |
| 80 | Pick up Equipment | Pick up Equipment | The professional picks up equipment for the patient. |
| 80 | Pick up Linen/ | Pick up Linen/ | The professional picks up linen, blanket or laundry for the patient. |
| | Blankt/Laundy | Blanket/Laundry | |
| 80 | Pick up OTHER | Pick up OTHER | The professional picks something up for the patient that is not listed here. |
| | | | Please specify on corrections sheet. |
| 80 | Pick Up Patient | Pick Up Patient | The professional will pick up patient belongings (e.g. Clothes). Clothes are stored |
| | Belongings | Belongings | in the Dirty Utility Room on the unit |
| 80 | Pick up Supplies | Pick up Supplies | The professional picks up supplies. |
| 80 | Needs Other | Needs Other | A patient need that is not listed here. Please specify on corrections sheet. |
| 90 | Bath/Shower | Bath/Shower | The patient takes a tub bath or a shower. The professional will be assisting them as needed. |
| 90 | Dress Patient | Dress Patient | The professional assists the patient to get dressed or undressed. |
| 90 | Lift | Lift | The professional lifts a patient from one position to another without mechanical |
| | Manual -Alone | Manual -Alone | support. They do this on their own, without help from another professional. |
| 90 | Personal Hygiene | Personal Hygiene | The professional assists with brushing the patient's teeth, hair, or shaving etc. |
| 90 | Prep for Bath/ | Prep for Bath/ | The professional helps the patient get ready for a bath or shower. This could involve |
| | Shower | Shower | covering all necessary areas (i.e. casts) with waterproof covering or regulating water |
| | | | temperature. |
| 90 | Pt Transfer ADL | Pt Transfer ADL | Patient is assisted to move from bed to chair, chair to wheelchair, etc. |
| 90 | Purposeful | Purposeful | Only select this variable if the professional is getting the patient up and |
| | Mobilization | Mobilization | moving with the intent to build strength and functionality. This is not the same |
| | | | as simply walking the patient to the bathroom. You may hear the professional say . . . |
| | | | “Mrs. Smith, let's take a walk down the hall and build up your strength”. |
| 90 | Staff -Assist | Staff -Assist | The professional assists another professional with an ADL activity. Specify |
| | | | who they are assisting in level five. |
| 90 | Staff -Mentor | Staff -Mentor | The professional watches another professional perform an ADL activity and gives |
| | | | them instruction. Specify who they are teaching in level five. |
| 90 | Staff -Observe | Staff -Observe | The professional observes another professional conducting an ADL activity. |
| | | | Specify who they are observing in level five. |
| 90 | Wash Patient | Wash Patient | The professional washes or assists in washing the patient while NOT in the shower or tub. |
| 90 | ADL Other | ADL Other | An ADL activity that is not listed here. Please specify on corrections sheet. |
| 91 | Financial | Financial | The professional assists the patient with basic money management (e.g. daily money |
| | Management - | Management - | management, banking, paying bills). In some instances, the professional may accompany |
| | Basic | Basic | the patient to the bank. |
| 91 | Financial | Financial | The professional assists the patient with more complex money management issues |
| | Managemt - | Management - | (e.g. preparation of taxes). |
| | Complex | Complex | |
| 91 | Housekeeping | Housekeeping | The professional will assist the patient with cleaning and/or tidying their room |
| | | | (making their bed, hanging up their clothes) and/or doing laundry. |
| 91 | IADL Other | IADL Other | An IADL activity that is not listed here. Please specify on corrections sheet. |
| 91 | Shopping | Shopping | The professional assists the patient before, during and after shopping. For example, |
| | | | the professional may help the patient make a shopping list. The professional may also |
| | | | accompany the patient to the local store to assist in purchasing items such as food, |
| | | | clothing or other personal items. Travel to and from the store will be captured |
| | | | separately under travel. |
| 91 | Staff -Assist | Staff -Assist | The professional assists another professional with an IADL activity. Specify who |
| | | | they are assisting in level five. |
| 91 | Staff -Mentor | Staff -Mentor | The professional watches another professional perform an IADL activity and gives |
| | | | them instruction. Specify who they are teaching in level five. |
| 91 | Staff -Observe | Staff -Observe | The professional observes another professional conducting an IADL activity. |
| | | | Specify who they are observing in level five. |
| 100 | Access/Pick | Access/Pick | The professional accesses patient medications from drawers located in the med room |
| | Up Meds | Up Meds | |
| 100 | Administer | Administer | The professional administers meds to a patient. This includes all forms of |
| | Meds | Meds | medication and could be tablets, an injection etc. |
| 100 | Narcotics | Narcotics | Medications are counted by professionals. They are typically counted at the end |
| | Count | Count | of a shift and involve 2 professionals. |
| 100 | Prepare Meds | Prepare Meds | The professional gets the drugs and curative substances ready for the patient. |
| | | | This could include the crushing of pills for easy administering. |
| 100 | Staff -Assist | Staff -Assist | The professional assists another professional in a medication related activity. |
| | | | Specify who they are assisting in level five. |
| 100 | Staff -Mentor | Staff -Mentor | The professional watches another professional perform a Medication related activity |
| | | | and gives them instruction. Specify who they are teaching in level five. |
| 100 | Staff -Observe | Staff -Observe | The professional observes another professional perform a medication activity. |
| | | | Specify who they are observing in level five. |
| 100 | Meds Other | Meds Other | A medication related activity that is not listed here. Please specify on corrections sheet. |
| 110 | Bowel Care | Bowel Care | The professional administers a suppository or provides fibre drink to patient. |
| 110 | Organized | Organized | The professional will engage in activities with the patient such as playing cards or |
| | Therapeutic Acts | Therapeutic | putting together a puzzle. This activity is usually conducted one to one or in small |
| | | Activities | groups on the unit. These activities can facilitate therapeutic growth in patients by |
| | | | reducing anxiety, and improving communication and decision making. DO NOT select this |
| | | | variable if the professional is involved in structured therapy groups with other staff |
| | | | (OT) - these group sessions will be captured under the main role of Therapy. |
| 110 | Prep Patient | Prep Patient | The professional prepares the patient for treatment. This may include ensuring the |
| | for Treatment | for Treatment | patient is dressed in hospital gown or other loose clothing, if the patient is NPO |
| | | | (nothing-by-mouth) ensure they have not consumed any fluids/food prior to treatment, |
| | | | removal of any dentures, glasses, contact lenses, hear aids etc. |
| 110 | Staff -Assist | Staff -Assist | The professional assists another professional with a treatment/therapy. Specify who |
| | | | they are assisting in level five. |
| 110 | Staff -Mentor | Staff -Mentor | The professional watches another professional perform a Treatment/Therapy and gives |
| | | | them instruction. Specify who they are teaching in level five. |
| 110 | Staff -Observe | Staff -Observe | The professional observes another professional conducting a treatment/therapy. |
| | | | Specify who they are observing in level five. |
| 110 | Tubes/ | Tubes/ | The professional performs an activity that involves the tubes, lines and bags of used |
| | Lines/Bags | Lines/Bags | for a patient's care. For example, changing, checking, inserting, or emptying. |
| 110 | Wound Care | Wound Care | The professional will examine the wound; document its size, location, appearance, and |
| | | | the surrounding skin. The health care professional also examines the wound for signs |
| | | | of infection, and drainage, and documents how long the patient has had the wound. Actual |
| | | | components of wound care include cleaning, applying hot compress, dressing, determining |
| | | | frequency of dressing changes, and re- evaluation. |
| 110 | Treatment | Treatment | A treatment activity that is not listed here. Please specify on corrections sheet. |
| | Other | Other | |
| 120 | ADT Report | ADT Report | The ADT report (Admissions Discharges Transfers) is updated with all information |
| | | | related to patient admissions, discharges and transfers. |
| 120 | Book Manual | Book Manual | Material being referred to for care purposes, policies, protocols and procedures, |
| | | | medications etc. |
| 120 | Care Plan | Care Plan | A Care Plan is based on the initial and ongoing assessment of the patient. A Care Plan |
| | | | will review a patient's individual needs and design appropriate patient care outcomes |
| | | | in an effort to facilitate the patient's discharge from the hospital. An essential |
| | | | portion of each care plan is to determine a patient's treatment by nurses, doctors and |
| | | | other healthcare professionals. These documents are considered to be living documents - they |
| | | | will be revised as the patient's conditions and abilities change. The Care Plan |
| | | | is located in patient's MAR. |
| 120 | Directors | Directors | The professional will issue a Director's Warrant (Mental Health Act - Form 21) for |
| | Warrant | Warrant | a patient who is AWOL (Absent Without Leave). The warrant is faxed to the Vancouver City |
| | | | Police and will alert them to the patient's absence from the unit. |
| 120 | Discharge | Discharge | Formal documentation that needs to be completed when a patient is discharged. This will |
| | Paperwork General | Paperwork General | include the patient's personal details, their condition, their length of stay etc. |
| 120 | Discharge | Discharge | A paper based form the professional uses to document findings from rounds. This document is |
| | Planning Sheet | Planning Sheet | maintained in the patient chart. |
| 120 | Doctors/Physicians | Doctors/Physicians | Requests for patient treatment from the doctor, including treatment specifics, medication |
| | Orders | Orders | doses, referrals etc. There is often a specific form for this in the patient chart. |
| 120 | Document - | Document - | The professional is handling multiple documents at one time. |
| | Multiple | Multiple | |
| 120 | Incident | Incident | If there has been an incident (injury, error) that has involved an employee it must be |
| | Report - | Report - | documented on the Employee Incident Form. The professional is required to describe the |
| | Employee | Employee | incident, who was involved, date, contributing factors etc. |
| 120 | Incident | Incident | If there has been an accident or error (e.g. medication) involving a patient and/or a |
| | Report - | Report - | professional this must be documented on an incident reporting form. The professional is |
| | Patient | Patient | required to describe the incident, who was involved, date, contributing factors etc. |
| 120 | Informal Notes | Informal Notes | Staff have various ways of making notes or making reminders to themselves. These include |
| | | | sticky notes, notepads etc. |
| 120 | Kardex | Kardex | The Kardex records the initial plan of care, and is an ongoing updated form regarding |
| | | | the current care status of patients. The Kardex is continually erased and updated over |
| | | | time, while the patient chart is the permanent record. |
| 120 | Lab Report/ | Lab Report/ | Documentation and/or review of the patient's tests results such as Lab tests, |
| | Test Results | Test Results | CT Scans, EEGs - may be paper-based or on the computer. |
| 120 | MAR | MAR | A document called the Medication Assessment Record where all medication needs and |
| | | | administrations are recorded. |
| 120 | Mentl Health | Mental Health | The main purpose of the Mental Health Act is to provide authority, criteria and |
| | Act Fms -Other | Act Forms -Other | procedures for involuntary admission and treatment. However, the Act also contains |
| | | | protections to ensure that these provisions are applied in an appropriate and lawful |
| | | | manner. Safeguards for the rights of people involuntarily admitted to a psychiatric |
| | | | facility include rights notification, medical examinations at specified time periods, |
| | | | second medical opinions on proposed treatment and access to review panels and the court. |
| 120 | Nursing | Nursing | Nursing Admission Assessment: is an initial assessment paper based form used to |
| | Admission | Admission | gather baseline information on the patient. This assessment documents the patient's |
| | Assessment | Assessment | physical symptoms, ADLs, substance use, general appearance, cognitive functioning, symptoms |
| | | | (delusions, hallucinations, personal history etc.) |
| 120 | Pass Tool | Pass Tool | A Pass Tool must be prepared for every patient each time they leave the unit (15 |
| | | | minutes, 1 hour, overnight). The Pass Tool documents what the patient was wearing, contact |
| | | | information, time the patient left etc. |
| 120 | Patient Chart | Patient Chart | This is a permanent record stored in a binder that includes several different forms in |
| | | | it such as screening form, fluid balance, vital signs, assessment sheet, patient progress |
| | | | notes, nursing notes, doctor's orders, and allied health notes. The patient charts |
| | | | are usually found at the nursing station. |
| 120 | Patient List | Patient List | This is a list of all the patients on the ward that day. The list includes the patient |
| | | | name, room number, age, diagnosis etc. The professional may document informal notes related |
| | | | to the patient on this form. |
| 120 | Referral | Referral | Any document relating to referrals - the method whereby the professional directs a patient |
| | Document | Document | to the services of another health professional or facility. This is the act of filling out |
| | | | forms AFTER they have been through the discharge planning and a decision has been made. |
| 120 | Requisition | Requisition | This is any paperwork that formally requests something for the patient. It may be |
| | Document | Document | requesting blood work, transport, dietary needs etc. |
| 120 | Rounds | Rounds | The professional documents when they have finished their observational rounds noting which |
| | Paperwork | Paperwork | patients have been seen. |
| 120 | Staff -Assist | Staff -Assist | The professional assists another professional with their documentation. Specify who they |
| | | | are assisting in level five. |
| 120 | Staff -Mentor | Staff -Mentor | The professional watches another professional document and gives them instruction. Specify |
| | | | who they are teaching in level five. |
| 120 | Staff -Observe | Staff -Observe | The professional observes another professional while documenting. Specify who they are |
| | | | observing in level five. |
| 120 | Staff Schedule | Staff Schedule | The staff schedule indentify the daily staff (Nurses, Unit Clerk etc) scheduled to work |
| | | | on the unit. The professional will review these sheets to see who is working and/or to |
| | | | determine whether there is sufficient coverage for the day. |
| 120 | Transfer | Transfer | Any documentation in regards to the transfer of a patient. This includes transfers on the |
| | Paperwork | Paperwork | floor as well as off the floor. |
| 120 | Workload | Workload | The professional records time spent (each interaction) with each patient. |
| | Recording Form | Recording Form | |
| 120 | Documentation | Documentation | A document that is not listed here. Please specify on corrections sheet. |
| | Other | Other | |
| 130 | Down Time | Down Time | During slow periods there may be nothing for the professional to do. This would be coded |
| | | | as downtime and is not to be confused with social conversation or personal. |
| 130 | Misc Other | Misc Other | A miscellaneous activity that does not fit anywhere within the field list. |
| | | | Please specify on corrections sheet. |
| 131 | Calibrate | Calibrate | The blood sugar testing machine will be reset to ensure the most accurate results. |
| | ACCU Check | ACCU Check | |
| 131 | Equip -Check | Equipment -Check | The professional checks the equipment to ensure that it is working properly. |
| 131 | Staff -Assist | Staff -Assist | The professional assists another professional with equipment related activities. |
| | | | Specify who they are assisting in level five. |
| 131 | Equip Other | Equipment Other | An equipment related activity that is not listed here. Please specify on corrections sheet. |
| 132 | Check Patient's | Check Patient's | The professional will check through the patient's belongings looking for sharp items, |
| | Belongings | Belongings | belts, other medications etc. This task will occur when a new patient has arrived on the unit. |
| 132 | Discharge/ | Discharge/ | Prior to discharge the professional pulls together supplies and packs up the patient's |
| | Transfer Prep | Transfer Prep | clothes and other valuables ready for their discharge or transfer. |
| 132 | Empty Laundry | Empty Laundry | The professional will remove full bags of dirty linen and replace them with new bags. |
| | Carts | Carts | |
| 132 | Empty/Replace | Empty/Replace | The professional will remove the entire used syringe and needle garbage and replace it |
| | Sharp Contain | Sharp Container | with a new one. This is usually a yellow container with biomedical warnings on it. |
| 132 | Housekeeping | Housekeeping | The professional cleans the patient's room. This could involve mopping up spills, |
| | Pts Room | Patients Room | taking out the garbage etc. |
| 132 | Laundry | Laundry | The professional launders the patient's clothes. |
| 132 | Lock/unlock | Lock/unlock | The professional will lock/unlock doors (e.g. Tub room, bathroom). |
| | doors | doors | |
| 132 | Set up Room | Set up Room | The professional assists a NEW patient to settle into their room -hang clothes, |
| | | | set photos out etc. |
| 132 | Space | Space | The professional organizes or rearrange a patient's room. |
| | Organization | Organization | |
| | Pt Room | Pt Room | |
| 132 | Space | Space | The professional organizes or rearranges their workspace. |
| | Orgnization | Organization | |
| | Workspace | Workspace | |
| 132 | Staff -Assist | Staff -Assist | The professional assists another professional with housekeeping related activities. |
| | | | Specify who they are assisting in level five. |
| 132 | Strip/Make Bed | Strip/Make Bed | The professional strips the sheets from a patient's bed and/or makes the bed. This |
| | | | includes changing the bed pad (if necessary), sheet and blanket. |
| 132 | Housekeeping | Housekeeping | A housekeeping activity that is not listed here. Please specify on corrections sheet. |
| | Other | Other | |
| 280 | In-box Related | In-box Related | Any activities related to the professional's in-box whether paper-based or online (email). |
| | | | Specify in level four if they are emailing if online, or checking, filing, etc if offline. |
| 280 | Staff -Assist | Staff -Assist | The professional assists another professional with administrative activities. Specify |
| | | | who they are assisting in level five. |
| 280 | Whiteboard/ | Whiteboard/ | The professional may review or update a whiteboard/assignment board. Specify whether it is |
| | Assignment Board | Assignment Board | reviewing or updating in level four. |
| 280 | Admin Other | Admin Other | An administrative activity that is not listed here. Please specify on corrections sheet. |
| 300 | Equipment | Equipment | The professional looks for any type of equipment. |
| 300 | Food | Food | The professional looks for food. Typically for the patient. |
| 300 | Found | Found | Use this field if the professional finds the item they are looking for. |
| 300 | Medication | Medication | The professional looks for medication. |
| 300 | Not Found | Not Found | Use this field if the professional does not find what they are looking for. |
| 300 | Patient | Patient | The professional looks for the patient. |
| 300 | Patient Chart | Patient Chart | The professional looks for the patient chart. |
| 300 | Pts | Patients | The professional looks for an item that belongs to the patient. |
| | Belongings | Belongings | |
| 300 | Staff | Staff | The professional looks for a staff member. |
| 300 | Supplies | Supplies | The professional looks for supplies. |
| 300 | Document Other | Document Other | The professional looks for any documentation that is NOT the patient chart. |
| 300 | Look Other | Look Other | The professional looks for something that is not listed here. Please specify on |
| | | | corrections sheet. |
| 450 | Therapy Other | Therapy Other | A therapy activity that is not listed here. Please specify on corrections sheet. |

Level 3: Patient Details

| Field Name | Field Description |
|---|---|
| Not | The professional is involved in work NOT related to a specific patient(s), such as stocking |
| Applicable | supplies or professional development etc. |
| Patient | The professional is talking about a patient who has been discharged or transferred from the |
| Discharge | floor/hospital. |
| Patient | The professional is talking to more than one patient at a time. Do not use this if they refer |
| Group | to several patients in one conversation. Keep switching level 3 accordingly. Patient Group |
| | may be a combination of Consent and Non Consent patients. Therefore in may not be possible to |
| | collect data all the way to Level Six. |
| Patient | The patient has just arrived on the ward but has not yet been approached regarding consent |
| New | (e.g. perhaps they are sleeping). Treat this field the same way you would a Patient No Consent. |
| Patient | No consent has been given for this patient and as such you will not collect any information |
| No Consent | while the professional is in direct face to face contact with the patient(s). However if 2 |
| | professionals are discussing a no consent patient, you would code Patient No Consent in Level |
| | 3 and continue through to Level 6 and collect the topic of communication. In addition, if |
| | the professional is documenting on a patient no consent you may collect data up to and |
| | including Level 4. |
| Patient | At times it may be impossible to obtain the patient's name, in which case, please use |
| Unknown | this field for coding. You can use this field to allow you to capture the data in the subsequent |
| | fields. Where possible find out the patient number and mark this on your corrections sheet. |
| Patient 1 | Patient with assigned number |
| Patient 2 | Patient with assigned number |
| Patient 3 | Patient with assigned number |
| Patient 4 | Patient with assigned number |
| Patient 5 | Patient with assigned number |
| Patient 6 | Patient with assigned number |
| Patient 7 | Patient with assigned number |
| Patient 8 | Patient with assigned number |
| Patient 9 | Patient with assigned number |
| Patient 10 | Patient with assigned number |
| Patient 11 | Patient with assigned number |
| Patient 12 | Patient with assigned number |
| Patient 13 | Patient with assigned number |
| Patient 14 | Patient with assigned number |
| Patient 15 | Patient with assigned number |
| Patient 16 | Patient with assigned number |
| Patient 17 | Patient with assigned number |
| Patient 18 | Patient with assigned number |
| Patient 19 | Patient with assigned number |
| Patient 20 | Patient with assigned number |
| Patient 21 | Patient with assigned number |
| Patient 22 | Patient with assigned number |
| Patient 23 | Patient with assigned number |
| Patient 24 | Patient with assigned number |
| Patient 25 | Patient with assigned number |
| Patient 26 | Patient with assigned number |
| Patient 27 | Patient with assigned number |
| Patient 28 | Patient with assigned number |
| Patient 29 | Patient with assigned number |
| Patient 30 | Patient with assigned number |
| Patient 31 | Patient with assigned number |
| Patient 32 | Patient with assigned number |
| Patient 33 | Patient with assigned number |
| Patient 34 | Patient with assigned number |
| Patient 35 | Patient with assigned number |
| Patient 36 | Patient with assigned number |
| Patient 37 | Patient with assigned number |
| Patient 38 | Patient with assigned number |
| Patient 39 | Patient with assigned number |
| Patient 40 | Patient with assigned number |
| Patient 41 | Patient with assigned number |
| Patient 42 | Patient with assigned number |
| Patient 43 | Patient with assigned number |
| Patient 44 | Patient with assigned number |
| Patient 45 | Patient with assigned number |
| Patient 46 | Patient with assigned number |
| Patient 47 | Patient with assigned number |
| Patient 48 | Patient with assigned number |
| Patient 49 | Patient with assigned number |
| Patient 50 | Patient with assigned number |
| Patient 51 | Patient with assigned number |
| Patient 52 | Patient with assigned number |
| Patient 53 | Patient with assigned number |
| Patient 54 | Patient with assigned number |
| Patient 55 | Patient with assigned number |
| Patient 56 | Patient with assigned number |
| Patient 57 | Patient with assigned number |
| Patient 58 | Patient with assigned number |
| Patient 59 | Patient with assigned number |
| Patient 60 | Patient with assigned number |
| Patient 61 | Patient with assigned number |
| Patient 62 | Patient with assigned number |
| Patient 63 | Patient with assigned number |
| Patient 64 | Patient with assigned number |
| Patient 65 | Patient with assigned number |
| Patient 66 | Patient with assigned number |
| Patient 67 | Patient with assigned number |
| Patient 68 | Patient with assigned number |
| Patient 69 | Patient with assigned number |
| Patient 70 | Patient with assigned number |
| Patient 71 | Patient with assigned number |
| Patient 72 | Patient with assigned number |
| Patient 73 | Patient with assigned number |
| Patient 74 | Patient with assigned number |
| Patient 75 | Patient with assigned number |
| Patient 76 | Patient with assigned number |
| Patient 77 | Patient with assigned number |
| Patient 78 | Patient with assigned number |
| Patient 79 | Patient with assigned number |
| Patient 80 | Patient with assigned number |
| Patient 81 | Patient with assigned number |
| Patient 82 | Patient with assigned number |
| Patient 83 | Patient with assigned number |
| Patient 84 | Patient with assigned number |
| Patient 85 | Patient with assigned number |
| Patient 86 | Patient with assigned number |
| Patient 87 | Patient with assigned number |
| Patient 88 | Patient with assigned number |
| Patient 89 | Patient with assigned number |
| Patient 90 | Patient with assigned number |
| Patient 91 | Patient with assigned number |
| Patient 92 | Patient with assigned number |
| Patient 93 | Patient with assigned number |
| Patient 94 | Patient with assigned number |
| Patient 95 | Patient with assigned number |
| Patient 96 | Patient with assigned number |
| Patient 97 | Patient with assigned number |
| Patient 98 | Patient with assigned number |
| Patient 99 | Patient with assigned number |

Level 4: Mode of Main Activity

| Field Name | Field Description |
|---|---|
| Info | A professional is recording and/or updating on the computer. For example, recording |
| Record -Computer | on the Clinical Profile, preparing a consult summary on a template etc. |
| Info | A professional is recording and/or updating a paper based document |
| Record -Offline | |
| Info | The professional reads on a computer. |
| Review -Computer | |
| Info | The professional reads through paper based documents. |
| Review -Offline | |
| Document - | The professional is handing over document, form, chart or any other paper work to |
| Handoff | another professional, patient, community agency or individual etc. |
| Email -Read | The professional reads emails. |
| Email -Write | The professional writes an email to send. |
| Face to Face | The activity in Level 2 is taking place face to face with someone. |
| Fax | A fax is being sent or received. |
| Filing | The professional files away documents/charts/mail etc. |
| Intercom | Contacting someone via the intercom. |
| Not Applicable | Use this field when no mode listed here applies, but you need to enter data |
| | on Level 5 and Level 6. |
| Other | Please specify on Corrections Sheet. |
| Pager | Contacting someone on their pager. |
| Photocopy | When the professional photocopies something. What they are photocopying |
| | will be coded in level 2. |
| Print | The professional prints something off the computer. |
| Research -Computer | The professional researches something on the computer. |
| Research -Paper | The professional researches something in books or documents. |
| based | |
| Take Out/Return | The professional will take out/return paperwork from a folder. Chose the |
| Paperwork | folder it applies to in Level Two. |
| Telephone - | The professional receives an incoming call and transfers the call to another location |
| Transfer call | (e.g. Doctor's office, patient's pay phone). |
| Telephone In | The professional takes an incoming call. |
| Telephone In - | The professional takes a message from the incoming caller. |
| take message | |
| Telephone On Hold | The professional is on hold. |
| Telephone Out | The professional makes a phone call out. |
| Telephone | The professional makes a phone call but no one picks up at the other end. |
| Unanswered | |
| Transcribe | The professional transcribes or transfers the doctor's orders onto another |
| Doctors Orders | document (e.g. patient chart) |
| Voicemail | The professional checks the voicemail. |

Level 5: Communication with Whom

| Field Name | Field Description |
|---|---|
| Care Management | This professional is responsible for the coordination of day-to-day operations and quality |
| Leader | patient care within a designated clinical area(s). This position supports the seamless |
| | movement (patient flow) of patients through the healthcare system and in accessing appropriate |
| | resources. |
| Doctor - GP | The professional is communicating with a GP (General Practitioner). |
| Family Meeting | This meeting will may include family members, patient, doctor, nursing staff, other hospital |
| | staff (social worker, OT) and medical resident. |
| Hospital Security | The professional will contact hospital security if they require assistance with a patient |
| | and/or there has been a crisis incident on the unit. |
| Med Student/ | A medical student, or a physician who is receiving specialist training in the hospital. |
| Resident | |
| Occupational | Occupational Therapists (OT) help people improve their ability to perform tasks in their |
| Therapist (OT) | daily living and working environments. They work with individuals who have conditions that |
| | are mentally, physically, developmentally, or emotionally disabling. They also help them to |
| | develop, recover, or maintain daily living and work skills. |
| Patient | A conversation is taking place with the patient. |
| Patient Group | The professional is talking to more than one patient at a time. Do not use this if they |
| | refer to several patients in one conversation. Keep switching level 3 accordingly. |
| Psychiatrist | A physician who specializes in the prevention, diagnosis and treatment of mental illness. |
| Psychologist | A person trained and educated to perform psychological research, testing, and therapy. |
| Rehab Assistant | The Rehab Assistant (RA) will, under the supervision of the OT, assist with patients |
| | with assigned rehabilitation activities. |
| Registered | Registered Nurse (RN). Responsible for the assessment, planning, implementation and |
| Nurse (RN) | evaluation of client care. Working in collaboration with the interdisciplinary team, |
| | the RN ensures the delivery of client-centred care by assisting individual clients |
| | and their families respond to changing health care needs. |
| Social Worker | Social workers (SWs) provide services to patients and their families to meet their |
| | medically related social and emotional needs as they impinge on their medical condition, |
| | treatment, recovery, and safe transition from one care environment to another. |
| Staff Group | Communication with more than one staff member at a time. This will be used for |
| | general conversations, unit meetings or consultations. |
| Student Nurse | Students nurses. This includes the Employed Student Nurse. |
| Unit Clerk | The UC is responsible for the daily operation of the unit, overseeing the processing/ |
| | implementation of doctor's orders, providing support to the team of professionals, |
| | managing the administrative/clerical functions related to the unit, maintaining unit |
| | records, and managing phone calls. |
| Ambulance Service | Any professional that works with the ambulance service, such as paramedics, and |
| | dispatchers. |
| Central Processing | This hospital department's activities include decontamination, inspection, |
| | assembly, sterilization and distribution of instruments, supplies and equipment. |
| | The professional will contact Central Processing if they require equipment |
| | and/or supplies for the unit. |
| Clinical Nurse | Professional responsible for developing, coordinating and providing programs |
| Educator | to maintain and improve competencies of nursing staff. If there are students on |
| | the ward, be careful not to confuse this with the Student Instructor. |
| Clinical Nurse | This professional has clinical expertise in the diagnosis and treatment of |
| Specialist | illness and the delivery of evidence based interventions. |
| Community Transition | The CCT assists individuals ready for discharge from the hospital who need |
| Team (CTT) | support during the post discharge period |
| Community Case | As part of a therapeutic team, the case manager is responsible for providing |
| Manager | primary therapeutic, case management and mental health support services to assigned |
| | clients in hospital, residential or community settings. |
| Community Mental | Community Mental Health Teams service individuals who have a diagnosis of major |
| Health Team | mental illness schizophrenia and other psychotic disorders mood disorders (bipolar, |
| | major depression) and experience problems that interfere with their functioning. |
| Dietician/ | A registered dietician/nutritionist is uniquely prepared for the practice of |
| Nutritionist | nutrition and therapeutic nutrition care through the study of food and nutrition, |
| | as well as, biological, social and management sciences. |
| Emergency | The number dialled for emergency services. |
| Services - 911 | |
| ER | The Emergency Room is the section of a health care facility for providing rapid |
| | treatment to victims of sudden illness or trauma. |
| Food Services | The food services department provides the meals for the patients in the hospital. |
| Department | The professional may phone them about a patient's missing meal. |
| Friends/Family | Friends or family of a patient. |
| of Patient | |
| Hospital Staff Other | Staff that work at the hospital but are not specifically listed here. |
| Hospital Ward Clerk | The professional who stocks up the ward. (e.g. Linens) |
| Housekeeping | The cleaning staff in the hospital. |
| IT | The professionals responsible for fixing and maintaining the information technology |
| | in the hospital. |
| Lab | The department responsible for the analysis of patient test results (e.g. specimen analysis). |
| Manager | The Program Manager oversees all of the Acute Treatment Services. |
| Medical Records | This hospital department stores patient information (e.g. Patient charts). |
| | The professional will contact Medical Records if an “old chart” is |
| | needed for review on the unit. |
| Multi-disciplinary | A team of health care professionals (OT, PT, SW, Community/Hospital Worker, |
| Team | and Doctor). This field is to be used for rounds and family conferences. |
| NON VGH Services | The professional is speaking with staff from a NON VGH service (e.g. Red Cross). |
| Pastoral Care | Pastoral care is a term applied where people offer help and caring to patients |
| | in the hospital setting. Pastoral care in this sense can be applied to listening, |
| | supporting, encouraging and befriending. |
| Patient and | A conversation is taking place with a patient and their family/friends. |
| Family/Friends | |
| Patient and Staff | A conversation is taking place with a patient and another staff member. |
| Patient and Student | A conversation is taking place with a patient and a student. |
| Peer Support | An individual who has experienced mental health issues and is now assisting/ |
| Worker | supporting patients in their recovery process. |
| Pharmacy | A professional that works at the pharmacy. |
| Plant Maintenance | Plant Maintenance work to maintain the hospital. For example, they will be contacted |
| | if a bed is broken or toilet is plugged on the floor. |
| Police | The Police Department maintains peace, order and public safety through crime |
| | prevention and law enforcement. The professional will contact the City Police |
| | when a patient is AWOL from the unit. |
| Porter | Staff that move patients, equipment, and supplies between different departments |
| | within the hospital. In addition they can transport materials such as blood products, |
| | lab specimens, X-ray results, and charts. |
| Review Panel | A patient may request a review and decision regarding their “certification”. |
| | A certified patient is one who is not voluntarily admitted to the unit, a physician |
| | has determined or certified that the individual has a serious mental illness which |
| | is substantially interfering or limiting one or more areas of their life. A |
| | patient can request the review panel to re- examine their case. If the patient is |
| | successful, they are no longer compelled to remain on the unit. |
| Staffing | Department responsible for providing adequate shift coverage and finding |
| | replacements as necessary. |
| Student Instructor | The professional responsible for the education of student nurses. They will generally |
| | be working with the students while they are assigned to the ward. |
| VGH Other | The professional is speaking with a VGH staff person. For example, Professional |
| | Practice. |
| VGH Services | The professional is communicating with staff from other VGH programs, services |
| | and/or teams (e.g. ACT—community outreach team). |
| Other | Please specify on Corrections Sheet. |
| Unknown | It is not possible to identify who the professional is talking to. If you find |
| | out later, please make a note on the correct sheet. |
| Volunteer | Hospital volunteers work in the health care setting performing tasks and activities |
| | under the direction of a health care professional (e.g. OT). |

Level 6: Topic of Communication

| Field Name | Field Description |
|---|---|
| ADL -General | Any conversations related to the patient activities of daily living. For example, the |
| | professional may discuss the patient's ability to get dressed, wash up etc with |
| | another colleague. |
| ADL -Patient | Relates to a patient's personal hygiene. This could include brushing teeth, |
| Hygiene | combing hair, trimming nails, and shaving. |
| Administrative | The professional discusses any administrative activities. These could include filing, |
| | faxing, photocopying, or printing. It also includes the discussion around meetings |
| | and documentation. |
| ALC—Alternative | ALC may be defined as when a patient is occupying a bed in a hospital and does not |
| Level of Care | require the intensity of resources/services provided in this care setting (Acute, |
| | Complex Continuing Care, Mental Health or Rehabilitation), the patient must be |
| | designated Alternate Level of Care (ALC) at that time by the physician or her/his |
| | delegate. The ALC wait period starts at the time of designation and ends at the |
| | time of discharge/transfer to a discharge destination (or when the patient's |
| | needs or condition changes and the designation of ALC no longer applies). |
| Appoint/Test | A patient may undergo several tests during their hospital stay. The professional |
| | could discuss these tests with the patient, with the professional or with another |
| | department. |
| Arrange/Rearrange | For example, the professional may contact members of the multi-disciplinary team as |
| Meeting/Conference | well as family members to schedule (time, date, location) a family conference with |
| | patient. |
| Arrange Peer | Any conversations related to arranging for the patient to see a peer support worker. |
| Support | i.e. Professionals may be discussing the benefits of the arrangement, the logistics etc. |
| Assessment | Only use this field for general discussions on assessments. You may need to change |
| | to more detailed fields such as Pt Addiction, Physical Routine Vitals, Pt Physical |
| | Activity etc. |
| Bed Availability | The professional is discussing the availability of beds on the unit. “Do we |
| | have any beds available?” |
| Bowel Care | A discussion about the management plan for keeping a healthy bowel. This includes |
| | addressing diet, exercise, medications and fluids etc. |
| Bowel Habits | A discussion about a patient's bowel movements. This may involve describing |
| | the last movement or when it was. |
| Care Plan | A Care Plan will review a patient's individual needs and design appropriate |
| | patient care outcomes in an effort to facilitate the patient's discharge from |
| | the hospital. An essential portion of each care plan is to determine a patient's |
| | treatment by nurses, doctors and other healthcare professionals. |
| Census/Bed | A discussion about which beds are assigned to specific patients on the ward and |
| Assignment | coordinating any necessary changes due to admissions, transfer and discharges. The |
| | professional will also discuss the number of patients on the unit. The unit could |
| | be “over census” - meaning patients are in overflow beds or “under census” - |
| | meaning there are beds available on the unit. |
| Concerns and | Regarding any patient, family, or staff concerns or complaints. |
| Complaints | |
| Cueing Action | The professional advises another professional or student that they are about |
| with Staff/Student | to perform a specific action. |
| Cueing Action | This code is to be entered when the professional is involved in cueing activities |
| with Patient | not related to IADLs. For example, the professional advises a patient that they |
| | are about to perform an action such as check their pulse or take their blood pressure. |
| Death Related | Use this code to capture death related conversations. |
| Diet -Nutrition | The professional discusses a patient's diet and nutritional care. |
| Diet -Patient Meals | The professional discusses a patient's meal. This may be the whereabouts of |
| | the meal, when it is arriving or if a patient has eaten their meal. |
| Directions | The professional provides directions to patients, staff, or family. |
| Discharge | Planning considers the patient's needs after the hospital stay. Depending |
| Options/Planning | on the care needs of the patient, there are a variety of possible options for |
| | discharge. For example, Home alone with family support, Home with private agency |
| | supports, Home with support from community agencies, Residential care etc. They |
| | are discussing the patient's options and should be distinguished from 999 |
| | Referral - Home/Community Care where the decision has already been made. |
| Doctors Orders | The professional discusses the doctor's orders - what they are requesting |
| | or any changes they have made. |
| Doctors Orders -clarify | The professional asks another staff member to assist in clarifying/deciphering |
| | the doctor's orders. |
| Domestic Violence | Domestic violence, also known as domestic abuse, spousal abuse, child abuse or |
| | intimate partner violence (IPV), can be broadly defined as a pattern of abusive |
| | behaviours by one or both partners in an intimate relationship such as marriage, |
| | dating, family, friends or cohabitation. [1] Domestic violence has many |
| | forms including physical aggression (hitting, kicking, biting, shoving, restraining, |
| | throwing objects), or threats thereof; sexual abuse; emotional abuse; controlling |
| | or domineering; intimidation; stalking; passive/covert abuse (e.g., neglect); and |
| | economic deprivation. |
| Emotional Support | Providing emotional support for the patient and their family. |
| for Patient/Family | |
| Encourage and | The professional will encourage and/or motivate the patient at any point throughout |
| Motivate Patient | the day. For example the professional may remind the patient of their upcoming group |
| | session; or a professional (OT) may encourage the patient to continue an activity |
| | while in a therapeutic group session; or to continue a discussion while in a client/ |
| | family meeting. |
| Equipment/ | A discussion about administrative equipment and supplies such as paper, ink, |
| Supplies -Admin | staplers etc. |
| Equipment/ | A discussion about equipment or supplies that they cannot find or have run out. |
| Supplies -Missing | |
| Equipment/ | A discussion about equipment or supplies relating to the patient such as |
| Supplies -Patient | bandages, vitals machine, wheelchairs etc. |
| Hospital Maintenance | A discussion about hospital maintenance. This could be about a broken bed, |
| | blocked toilet etc. |
| Hospital Policies | Any conversation related to hospital organizational policies and procedures. |
| Hospital Security | A discussion about hospital security. |
| Housekeeping - Unit | A discussion about the cleaning and tidying of the ward. |
| Housekeeping -Patient | A discussion about the cleaning and tidying the patient's room. |
| Room | |
| Housing | The professional will discuss issues related to housing (independent living) |
| | such as availability, suitable housing, location of housing, income assistance, |
| | eviction etc. |
| Infection Control | Any discussion around infection control such as washing hands, infection control |
| | attire etc. |
| IT issues | Any conversation related to IT problems such as computer problems, printer |
| | problems etc. |
| Lab/Test Results | The professional discusses lab and test results for a patient. |
| Medication - New | Any discussion related to a medication change for the patient. For example, |
| | the professional may discuss how the patient is tolerating the change (medication |
| | side effects) or what type of behavioural changes might be anticipated. |
| Medication - PRN | Requests for PRN medication. PRN refers to medications taken only as needed. |
| Request | For example, pain medication, sleeping pills and cough medicine. |
| Medication -Administer | Conversations regarding the administering of medications. |
| Medication -Errors | Conversation around errors made with a patient's medication. |
| Medication -General | General conversations about medication that are not already covered. |
| Medication -History | Regarding the medications the patient has been taking prior to their hospital stay. |
| Medication -Missing | Related to missing drugs or curative substances. Medications may be missing from the |
| | med room or computerized medication dispenser. |
| Medication -Order New | The professional orders new medication. |
| Mentor Staff/Student | The professional teaches and mentors another professional in relation to general |
| | health care such as certain documentation (e.g. Care plan) procedures, equipment |
| | use, medications etc. |
| Monitoring | The professional is discussing the monitoring or observational requirements |
| Requirements | related to a patient or patients on the unit. For example, the professional may |
| | discuss increasing the frequency of observing the patient from once every 30 |
| | minutes to every 15 minutes. |
| New Admissions | A conversation regarding a new patient(s) that has been admitted to the ward |
| | or is going to be admitted to the ward. |
| Orientation of | Any conversation related to orienting the new patient to the unit. For example, |
| New Patient | the professional will take the patient on a tour of the unit, show them their |
| | room, where their belongings will be kept etc. |
| Other | Please specify on Corrections Sheet. |
| Page Patient/ | Individuals will be paged (over intercom) to attend group, answer the phone, |
| Staff/Other | come to the nursing station etc. |
| Patient Diagnosis | A discussion about a patient's diagnosis. |
| Patient Flow | Conversations related to patient movement throughout the hospital |
| Patient ID | Conversations related to the patient's identification. The patient may have |
| | lost their ID and the professional is discussing finding or replacing these documents. |
| Patient Sleep | Any discussions related to a patient's ability to sleep, to stay asleep, |
| | medications to assist in sleep etc. |
| Patient Stressors | Any conversations related to stress factors which might be affecting the patient's |
| | mood, behaviour etc. (e.g. Family is having difficulty with the patient's mental |
| | illness and this is causing stress for the patient) |
| Physical Routine | A conversation regarding a patient's physical routine vitals. This includes their |
| Vitals | temperature, respiratory rate, heart beat (pulse), and blood pressure etc. |
| Prioritize Patients | The professional discusses the most urgent patients in need of care and prioritizes them. |
| Patient Addiction | Any conversation related to the patient's addiction or substance abuse (e.g. |
| | alcohol, drugs over the counter medications). |
| Patient Agitation | A conversation related to the heightened emotional/behavioural state of a patient. |
| Patient Absent | Any discussion related to a patient being AWOL (Absent Without Leave) from the unit. |
| Without Leave (AWOL) | |
| Patient Behaviour | A general overview of the patient's behaviour on and off the unit, in group etc. |
| Patient Belongings | A discussion on a patient's personal possessions. It may focus on where a |
| | patient's items have gone after they were admitted to the hospital. It could |
| | also be about a patient's possessions when they are in the hospital. Some items |
| | are stored in their room, and others are kept at the nursing station and/or in |
| | the dirty utility room. |
| Patient Certification/ | Any conversation related to the patient's certification/recertification or |
| Recertification | involuntary status on the unit. |
| Patient Cognitive | A conversation related to the patient's cognitive status. The patient's |
| Status | cognitive status can be assessed by the professional through a mini-mental exam |
| | or series of questions related to orientation (place and time) or memory. It may |
| | also be determined by informal questions such as “How are you feeling today?”, |
| | “How did you sleep?”, “Do you know where you are/what day it is?” |
| Patient Condition | A discussion regarding a patient whose mental health condition is getting worse. |
| Deteriorating | |
| Patient Current | A discussion regarding a patient's current physical health (i.e. conversations |
| Physical Health | related to the patient's respiratory system, cardiovascular system, dental |
| | issues, wounds or other skin conditions etc). |
| Patient Discharge | Any conversation related to the patient's discharge from the unit. For example, |
| | the professional may be informing another hospital department that the patient |
| | has been discharged. |
| Patient Family | Discussions about the patient's family. For example, the professional may ask |
| | whether they have talked to their family recently, or enquire about the next time |
| | they are coming to visit. |
| Patient Financial | Patients can be experiencing financial hardship. The professional may discuss |
| Issues | strategies to address this issue with another professional or may listen to the |
| | patient as they explain their personal situation. |
| Patient Fluid | All of the body's processes (respiration, metabolism, digestion, exertion etc) |
| Balance | are affected by the volume of body fluid present as well as its specific composition. |
| | Disturbances in the fluid or the electrolyte balance may lead to cellular dysfunction |
| | and can seriously jeopardize a patient's life. |
| Patient Glucose | Discussions about a patient's blood sugar level. |
| Level | |
| Patient Legal | Any conversation related to patient past, current or future legal issues. For example, |
| Issues | the discussion may be about a patient's upcoming court appearance or warrant. |
| Patient Mental | Any conversation related to the details of the patient's mental illness. For example, |
| Health | the professional may be discussing the patient's symptoms, whether the patient is |
| | stable or not, the patient's mood, anxiety, depression, isolation, etc. The term |
| | mental illness actually encompasses numerous psychiatric disorders, and just like |
| | illnesses that affect other parts of the body they can vary in severity. Many people |
| | suffering from mental illness may not look as though they are ill or that something |
| | is wrong, while others may appear to be confused, agitated, or withdrawn. Mental |
| | illnesses are often disorders of the brain that disrupt a person's thinking, feeling, |
| | mood, unrelieved anxiety, or an inability to cope with the ordinary demands of life. |
| Patient | Discussions around the promotion of patient movement and functionality. |
| Mobilization | |
| Patient Needs/ | Related to anything the patient may request. For example, patient pass or personal |
| Privileges | items such as a razor, or cigarettes, drink, snack, or blanket. |
| Patient Pain | Related to the degree of patient pain. The professional may ask the patient to rate |
| | their level of pain or discuss it with another professional. |
| Patient Personal | This is a discussion about the patient's personal treatment/therapy goals in |
| Goals | hospital or post discharge. For example, the patient may state that living independently |
| | and having employment is their goal or completing their GED, volunteering, getting |
| | more involved with leisure activities etc. |
| Patient Physical | As part of the patient's assessment the professional will discuss the patient's |
| and Mental Health | past physical and mental health history which may include, but is not limited to: |
| History | conversations related to the psychological and/or social factors which have contributed |
| | to the health and well being of the patient (e.g. psychological factors may include |
| | childhood trauma or loss of a loved one; social factors may include feelings of low |
| | self esteem, stress of unemployment or poverty), substance abuse information, history |
| | of mental illness, past and current health conditions (e.g. cardiovascular, respiratory, |
| | renal). |
| Patient Physical | The patient's level of physical activity and fitness are discussed. Do you |
| Activity | walk? How far? How often? |
| Patient Progress | This is a discussion with others about the patient's change in health status |
| | and the progress they have made. |
| Patient Refuses | The professional has a conversation with a patient who declines to receive any type of |
| Care/Group Activities | care or attend any therapeutic group activity. They could also be discussing this fact |
| | with another professional. |
| Patient Rule | Any conversations related to patients on the unit complying or not complying with the |
| Adherence | rules or regulations as directed by management/staff. For example, the professional |
| | may discuss the rules related to a patient receiving a weekend pass, a fresh air break |
| | or consequences of not attending therapeutic group sessions etc. |
| Patient Safety | The professional may discuss patient's safety on the unit. For example, is the |
| | patient at risk to him/her self (does the patient feel safe) or to other patients on |
| | the unit? |
| Patient Support | The professional discusses what community supports (i.e. programs, services) are |
| in Community | available and/or recommended to the patient after discharge from the hospital. |
| Patient Support | The professional discusses what support a patient will have when they are back |
| in Home | at home with their family/friends. |
| Patient Violent | Regarding the violent behaviour of a patient. |
| Behaviour | |
| Patient Whereabouts | The professional discusses the whereabouts of a patient. |
| Rapport Building | This is when the professional is building a relationship with another professional, |
| | patient or their family. Rapport building establishes a connection between 2 people |
| | and will usually occur at the beginning of a conversation. |
| Referral -Home/ | The professional discusses the patient's referral to a home or community care |
| Community Care | facility. The decision on which option they are taking has been made and they are |
| | now discussing the details of the referral. |
| Referral -In Hospital | The professional discusses the patient's referral within the hospital. |
| Request Assistance | The professional requests help from another staff member to complete a particular task. |
| Research | The professional discusses research topics such as a patient's condition, |
| | medication etc. |
| Restraining Patient | The professional discusses the act or need to restrain a patient. |
| Review Panel | Any conversations related to the details of the patient's ‘certification’ |
| | Review Panel Process. For example, the professional may discuss the review process |
| | with the patient. |
| Social Conversation | This is when professionals are chatting amongst themselves about non-health |
| | related topics (e.g. weather, vacations, personal life etc). |
| Specimen Collection | A conversation related to the collection of blood, sputum, urine or stool samples. |
| Staff - Absence/ | Conversations related to a professional's absence from work due to illness, |
| Vacation | injury, family issues, short or long term leaves etc. and/or conversations |
| | related to a professional's vacation time from work. |
| Staff - Safety/ | Any conversation related to the safety and security of the staff on the unit. |
| Security | For example, a professional may require the assistance of hospital security |
| | because the patient's current condition makes it unsafe for the professional |
| | to be alone with this individual. |
| Staff -General | Any discussion around staff that is not already listed here. |
| Staff -Injuries | A discussion about a staff member who has injured themselves. |
| Staff -Overtime | Any discussion around staff overtime. It could be a professional discussing |
| | the fact that they are working overtime or it could be the professional putting |
| | the schedule together discussing overtime. |
| Staff -Professional | The professional discusses their professional development or the professional |
| Development | development of another staff member. |
| Staff -Scheduling | Conversations related to staff scheduling. This could involve topics such as |
| | staff coverage, replacements needed, rearranging staff among units, etc. |
| Staff -Shifts/Breaks | The professional discusses when they are scheduled to work or when they are |
| | going to go on break. |
| Staff -Stress | The professional discusses their stress levels or the stress levels of another |
| | staff member. |
| Staff -Whereabouts | The professional discusses the whereabouts of a staff member. |
| Student Placement | Any conversation related to a student's (nurse, OT, other) placement on the unit. |
| | Conversation topics may include scheduling, resources required or recommended etc. |
| Students\Residents | The professional is discussing and/or coordinating the students/medical residents |
| | on the floor. |
| Teach Patient IADL - | Conversations related to the patient keeping their room tidy, their bed made, clothes |
| Housekeeping | hung up and laundry clean/folded/put away. The professional may cue, teach or assist |
| | patient with these tasks. For example the professional may ask “have you made |
| | your bed this morning?” |
| Teach Patient IADL - | Conversations related to taking prescribed medication dosages at correct time and/or |
| Medication | keeping track of medications. The professional may prompt, cue or remind the patient. |
| Teach Patient IADL - | Conversations related to traveling to the store and purchasing items for the patient. |
| Shopping | The professional may prompt, cue or remind the patient. |
| Teach Patient IADL- | Conversations related to the patients finances. They could be basic (banking, pay bills), |
| Financial | complex (pay taxes) or any other aspect related to the patient's financial |
| | management. The professional may cue or signal, such as a word or action, used to |
| | prompt the patient. For example, the professional may ask “Did you deposit your |
| | cheque?”, or Have you paid your bills?” |
| Teach Patient Other | Any conversation where the professional teaches the patient about a topic that |
| | is not already listed here. |
| Teach Patient | Psycho education refers to the education offered to people who live with a |
| Psycho-education | psychological disturbance (e.g. patients with schizophrenia, clinical depression, |
| | anxiety disorders, and psychotic illnesses). Family members can also be included. A |
| | goal is for the patient and family to understand and be better able to deal with |
| | the presenting illness. Also, the patient's own strengths, resources and coping |
| | skills are reinforced, in order to avoid relapse and contribute to their own health |
| | and wellness on a long-term basis. |
| Therapeutic Group | Patients will be scheduled to attend a variety of therapeutic group activities |
| Activity | aimed at stabilization, skill development and health promotion throughout the day. |
| | The professional may discuss how the patient felt about the session or other issues |
| | related to the patient's attendance, absence or schedule of this activity. It |
| | may also include general topics of discussion such as: what activity groups particular |
| | patients are scheduled to attend, what is working well in group session, and new |
| | activities to add to group sessions. |
| Transfer Patient | A discussion about the transfer of a patient. This includes transfers within the |
| | ward as well as off the ward. |
| Transportation | The professional discusses transportation for a patient. It could be related |
| | to the patient being taken home from the hospital, taken to another hospital or |
| | care facility, and how they are going to get there. |
| Treatment | Discussions relating to the treatment the patient is currently receiving which |
| | could include group sessions, medication, therapy, counselling etc. It will also |
| | include a patient's response to treatment, for example, the patient may |
| | become more stable, as a result of his treatment. |
| Treatment -Tubes | Related to the tubes, lines and/or bags that the patients may require or are |
| Lines Bags | already using. |
| Treatment -Wound | Treatment of patient sores and openings, often requiring cleaning, bandaging |
| Care | and maintenance of the site. |
| Unknown | It is not possible to identify the topic of conversation. The professional |
| | may have entered a room and you have been asked to remain outside the door. |
| | This may occur even if the patient has consented. |
| Unusual Incident | Any conversation related to an unusual incident occurrence on the unit. The |
| | professional may be discussing a patient's actions, an accident, an error, |
| | follow-up or incident outcome with another professional or patient. |
| VGH/MHAS | Conversations related specifically to the organization. For example, discussions |
| Organizational | around current PHC strategic initiatives, polices, budget planning, procedures, |
| Issues | committees, advisory groups etc. |
| X-Ray and Imaging | Discussions related to medical imaging such as X-Rays, Ultrasounds, CT or MRI scans. |

Level One

| Code | Name | Level One Heading | |
|---|---|---|---|
| 10 | Wash Hands* | 10 | Wash Hands* |
| 20 | Infection Control | 20 | Infection Control |
| 30 | Interruption | 30 | Interruption |
| 50 | Communication | 50 | Communication |
| 60 | Travel | 60 | Travel |
| 70 | Assess Evaluate | 70 | Assess Evaluate |
| 80 | Patient Needs | 80 | Patient Needs |
| 90 | ADL | 90 | ADL |
| 91 | IADLS | 91 | IADLS |
| 100 | Medication | 100 | Medication |
| 110 | Treatment | 110 | Treatment |
| 120 | Documentation | 120 | Documentation |
| 130 | Miscellaneous | 130 | Miscellaneous |
| 131 | Equipment | 131 | Equipment |
| 132 | Housekeeping | 132 | Housekeeping |
| 170 | Call Bell Respond* | 170 | Call Bell Respond* |
| 190 | Listening/Waiting* | 190 | Listening/Waiting* |
| 200 | Lunch/Dinner/Break* | 200 | Lunch/Dinner/Break* |
| 210 | Pause* | 210 | Pause* |
| 220 | Personal* | 220 | Personal* |
| 230 | Code Situation* | 230 | Code Situation* |
| #REF! | #REF! | #REF! | |
| 240 | End of Data Collection* | 240 | End of Data Collection* |
| 270 | Patient No Consent* | 270 | Patient No Consent* |
| 280 | Administration | 280 | Administration |
| 300 | Look For | 300 | Look For |
| 450 | Therapy | 450 | Therapy |
| 530 | Conduct Activities | 530 | Conduct Activities |
| | Off Flo#,z899; | | Off Floor* |
| 540 | FA Research Project* | 540 | FA Research Project* |

| | | |
|---|---|---|
| #REF! | #REF! | #REF! |

Codes

| | |
|---|---|
| 10 | Wash Hands* |
| 20 | Infection Control |
| 30 | Interruption |
| 50 | Communication |
| 60 | Travel |
| 70 | Assess Evaluate |
| 80 | Patient Needs |
| 90 | ADL |
| 91 | IADLS |
| 100 | Medication |
| 110 | Treatment |
| 120 | Documentation |
| 130 | Miscellaneous |
| 131 | Equipment |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look For |
| 450 | Therapy |
| 530 | Conduct Activites Off Floor* |
| 540 | Research Project* |
| 20 | Put on glove/gown/mask |
| 20 | Request Assistance |
| 20 | Take off glove/gown/mask |
| 20 | IC Other |
| 30 | Knowledge Exchange |
| 50 | Greeting patients/visitors |
| 50 | Interview - Patient |
| 50 | Knowledge Exchange |
| 50 | Meeting - Family |
| 50 | Meeting -Other |
| 50 | Meeting -Rounds |
| 50 | Report |
| 50 | Verbal/Status Update |
| 60 | Med Room - E1 |
| 60 | Med Room - W1 |
| 60 | Nursing Station - E1 |
| 60 | Nursing Station - W1 |
| 60 | Pt Room |
| 60 | Supply/Storage Rooms |
| 60 | Building Services Room - W1 |
| 60 | Dining Room - W1 |
| 60 | Documntatn Educatn Rm - W1 |
| 60 | Games Room |
| 60 | Hall |
| 60 | Hallway Interview Chairs - E1 |
| 60 | Hallway Interview Chairs - W1 |
| 60 | Interview (Seclusion) Rm - E1 |
| 60 | Interview (Seclusion) Rm - W1 |
| 60 | Kitchen - E1 |
| 60 | Linen Cart - E1 |
| 60 | Linen Cart - W1 |
| 60 | Lounge TV Room - E1 |
| 60 | Nursing Conference Room - E1 |
| 60 | Nursing Lounge - W1 |
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |
| 999 | Patient 21 |
| 999 | Patient 22 |
| 999 | Patient 23 |
| 999 | Patient 24 |
| 999 | Patient 25 |
| 999 | Patient 26 |
| 999 | Patient 27 |
| 999 | Patient 28 |
| 999 | Info Record -Computer |
| 999 | Info Record -Offline |
| 999 | Info Review -Computer |
| 999 | Info Review -Offline |
| 999 | Document - Handoff |
| 999 | Email -Read |
| 999 | Email -Write |
| 999 | Face to Face |
| 999 | Fax |
| 999 | Filing |
| 999 | Intercom |
| 999 | Not Applicable |
| 999 | Other |
| 999 | Pager |
| 999 | Photocopy |
| 999 | Print |
| 999 | Research -Computer |
| 999 | Research -Paper based |
| 999 | Take Out/Return Paperwork |
| 999 | Telephone - Transfer call |
| 999 | Telephone In |
| 999 | Telephone In - take message |
| 999 | Telephone On Hold |
| 999 | Telephone Out |
| 999 | Telephone Unanswered |
| 999 | Transcribe Doctors Orders |
| 999 | Voicemail |
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Patient Group |
| 999 | Psychiatrist |
| 999 | Psychologist |
| 999 | Rehab Assistant |
| 999 | RN |
| 999 | Social Worker |
| 999 | Staff Group |
| 999 | Student Nurse |
| 999 | Unit Clerk |
| 999 | Ambulance Service |
| 999 | Central Processing |
| 999 | Clinical Nurse Educator |
| 999 | Clinical Nurse Specialist |
| 999 | Commity Transition Tm (CTT) |
| 999 | Community Case Manager |
| 999 | Community Mental Health Tm |
| 999 | Dietician/Nutritionist |
| 999 | Emergency Services - 911 |
| 999 | ER |
| 999 | Food Services Department |
| 999 | Friends/Family of Patient |
| 999 | Hospital Staff Other |
| 999 | Hospital Ward Clerk |
| 999 | Housekeeping |
| 999 | IT |
| 999 | Lab |
| 999 | Manager |
| 999 | ADL -General |
| 999 | ADL -Patient Hygiene |
| 999 | Administrative |
| 999 | ALC |
| 999 | Appoint/Test |
| 999 | Arrange Meeting/Conference |
| 999 | Arrange Peer Support |
| 999 | Assessment |
| 999 | Bed Availability |
| 999 | Bowel Care |
| 999 | Bowel Habits |
| 999 | Care Plan |
| 999 | Census/Bed Assignment |
| 999 | Concerns and Complaints |
| 999 | Cueing Actin wth Staff/Stdnt |
| 999 | Cueing Action with Patient |
| 999 | Death Related |
| 999 | Diet -Nutrition |
| 999 | Diet -Pt Meals |
| 999 | Directions |
| 999 | Discharge Options/Planning |
| 999 | Doctors Orders |
| 999 | Doctors Orders -clarify |
| 999 | Domestic Violence |
| 999 | Emotionl Supprt for Pt/Famly |
| 999 | Encourage and Motivate Pt |
| 999 | Equip/Supplies -Admin |
| 999 | Equip/Supplies -Missing |
| 999 | Equip/Supplies -Patient |
| 999 | Hospital Maintenance |
| 999 | Hospital Policies |
| 999 | Hospital Security |
| 999 | Housekeeping - Unit |
| 999 | Housekeeping -Pt Room |

Field List part 1
1—Main Role and Function

| | |
|---|---|
| 10 | Wash Hands* |
| 20 | Infection Control |
| 30 | interruption |
| 50 | Communication |
| 60 | Travel |
| 70 | Assess Evaluate |
| 80 | Patient Needs |
| 90 | ADL |
| 91 | IADLS |
| 100 | Medication |
| 110 | Treatment |
| 120 | Documentation |
| 130 | Miscellaneous |
| 131 | Equipment |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look for |
| 450 | Therapy |
| 530 | Conduct Activites Off Floor* |

2—Sub-activities

| | |
|---|---|
| 20 | Put on glove/gown/mask |
| 20 | Request Assistance |
| 20 | Take off glove/gown/mask |
| 20 | IC Other |
| 30 | Knowledge Exchange |
| 50 | Greeting patients/visitors |
| 50 | Interview - Patient |
| 50 | Knowledge Exchange |
| 50 | Meeting - Family |
| 50 | Meeting -Other |
| 50 | Meeting -Rounds |
| 50 | Report |
| 50 | Verbal/Status Update |
| 60 | Med Room - E1 |
| 60 | Med Room - W1 |
| 60 | Nursing Station - E1 |
| 60 | Nursing Station - W1 |
| 60 | Pt Room |
| 60 | Supply/Storage Rooms |
| 60 | Building Services Room - W1 |
| 60 | Dining Room - W1 |
| 60 | Documntatn Educatn Rm - W1 |
| 60 | Games Room |
| 60 | Hall |
| 60 | Hallway Interview Chairs - E1 |
| 60 | Hallway Interview Chairs - W1 |
| 60 | Interview (Seclusion) Rm - E1 |
| 70 | Staff -Assist |
| 70 | Staff -Mentor |
| 70 | Staff -Observe |
| 70 | Unit Observation |
| 70 | Weigh Patient |
| 70 | Assess Other |
| 80 | Dispose Dirty Linen/Materials |
| 80 | Drop off Drink/Meal/Snack |
| 80 | Drop off Equipment |
| 80 | Drop off Linen/Blankt/laundy |
| 80 | Drop off OTHER |
| 80 | Drop off Patient Belongings |
| 80 | Drop off Supplies |
| 80 | Hand Out Pt Privileges/Needs |
| 80 | Make Snack/Meal |
| 80 | Pick up Drink/Meal/Snack |
| 80 | Pick up Equipment |
| 80 | Pick up Linen/Blankt/Laundy |
| 80 | Pick up OTHER |
| 80 | Pick Up Patient Belongings |
| 80 | Pick up Supplies |
| 80 | Needs Other |
| 90 | Bath/Shower |
| 90 | Dress Patient |
| 90 | Lilt Manual -Alone |
| 90 | Personal Hygiene |
| 90 | Prep for Bath/Shower |
| 120 | Book Manual |
| 120 | Care Plan |
| 120 | Directors Warrant |
| 120 | Discharge Paperwork General |
| 020 | Discharge Planning Sheet |
| 120 | Doctors/Physicians Orders |
| 120 | Document - Multiple |
| 120 | Incident Report - Employee |
| 120 | Incident Report - Patient |
| 120 | Informal Notes |
| 120 | Kardex |
| 120 | Lab Report/Test Results |
| 120 | MAR |
| 120 | Mentl Health Act Fms -Other |
| 120 | Nursing Admission Assessment |
| 120 | Pass Tool |
| 120 | Patient Chart |
| 120 | Patient List |
| 120 | Referral Document |
| 120 | Requisition Document |
| 120 | Rounds Paperwork |
| 120 | Staff -Assist |
| 120 | Staff -Mentor |
| 120 | Staff -Observe |
| 120 | Staff Schedule |
| 120 | Transfer Paperwork |
| 120 | Workload Recording Form |
| 300 | Supplies |
| 300 | Document Other |
| 300 | Look Other |
| 450 | Therapy Other |

Field List part 2
3—Patient Details

| | |
|---|---|
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |
| 999 | Patient 21 |

4—Mode of Main Activity

| | |
|---|---|
| 999 | Into Record -Computer |
| 999 | Info Record -Offline |
| 999 | Info Review -Computer |
| 999 | Into Review -Offline |
| 999 | Document - Handoff |
| 999 | Email -Read |
| 999 | Email -Write |
| 999 | Face to Face |
| 999 | Fax |
| 999 | Filing |
| 999 | Intercom |
| 999 | Not Applicable |
| 999 | Other |
| 999 | Pager |
| 999 | Photocopy |
| 999 | Print |
| 999 | Research -Computer |
| 999 | Research -Paper based |
| 999 | Take Out/Return Paperwork |
| 999 | Telephone - Transfer call |
| 999 | Telephone In |
| 999 | Telephone In - take message |
| 999 | Telephone On Hold |
| 999 | Telephone Out |
| 999 | Telephone Unanswered |
| 999 | Transcribe Doctors Orders |
| 999 | Voicemail |

5—Communication with Whom

| | |
|---|---|
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Patient Group |
| 999 | Psychiatrist |
| 999 | Psychologist |
| 999 | Rehab Assistant |
| 999 | RN |
| 999 | Social Worker |
| 999 | Staff Group |
| 999 | Student Nurse |
| 999 | Unit Clerk |
| 999 | Ambulance Service |
| 999 | Central Processing |
| 999 | Clinical Nurse Educator |
| 999 | Clinical Nurse Specialist |
| 999 | Comrnity Transition Tm (CTT) |
| 999 | Community Case Manager |
| 999 | Community Mental Health Tm |
| 999 | Dietician/Nutritionist |
| 999 | Emergency Services - 911 |
| 999 | ER |
| 999 | Food Services Department |

6—Topic of Communication

| | |
|---|---|
| 999 | AOL-General |
| 999 | ADL -Patient Hygiene |
| 999 | Administrative |
| 999 | ALC |
| 999 | Appoint/Test |
| 999 | Arrange Meeting/Conference |
| 999 | Arrange Peer Support |
| 999 | Assessment |
| 999 | Bed Availability |
| 999 | Bowel Care |
| 999 | Bowel Habits |
| 999 | Care Plan |
| 999 | Census/Bed Assignment |
| 999 | Concerns and Complaints |
| 999 | Cueing Actin wth Staff/Stdnt |
| 999 | Cueing Action with Patient |
| 999 | Death Related |
| 999 | Diet -Nutrition |
| 999 | Diet -Pt Meals |
| 999 | Directions |
| 999 | Discharge Options/Planning |
| 999 | Doctors Orders |
| 999 | Doctors Orders -clarify |
| 999 | Domestic Violence |
| 999 | Emotionl Supprt for Pt/Famly |
| 999 | Encourage and Motivate Pt |
| 999 | Equip/Supplies -Admin |
| 999 | Pt AWOL |
| 999 | Pt Behaviour |
| 999 | Pt Belongings |
| 999 | Pt Certifion/Recerifion |
| 999 | Pt Cognitive Status |
| 999 | Pt Condition Deteriorating |
| 999 | Pt Current Phy Health |
| 999 | Pt Discharge |
| 999 | Pt Family |
| 999 | Pt Financial Issues |
| 999 | Pt Fluid Balance |
| 999 | Pt Glucose Level |
| 999 | Pt Legal Issues |
| 999 | Pt Mental Health |
| 999 | Pt Mobilization |
| 999 | Pt Needs/Privileges |
| 999 | Pt Pain |
| 999 | Pt Personal Goals |
| 999 | Pt Phys and Mentl Hlth Histy |
| 999 | Pt Physical Activity |
| 999 | Pt Progress |
| 999 | Pt Refuse Care/Grp Activites |
| 999 | Pt Rule Adherence |
| 999 | Pt Safety |
| 999 | Pt Support in Community |
| 999 | Pt Support in Home |
| 999 | Pt Violent Behaviour |

RN_Rank table

| Level 1 Category | | Code | Field Name | Field Description | CSV Name | | Level | RN_Rank |
|---|---|---|---|---|---|---|---|---|
| 10 | Wash Hands* | 10 | Wash Hands* | It is important | 10 | Wash Hands* | 1 | top |
| 20 | Infection Control | 20 | Infection Control | Infection Contr | 20 | Infection Control | 1 | top |
| 30 | Interruption | 30 | Interruption | Actions on the | 30 | Interruption | 1 | top |
| 50 | Communication | 50 | Communication | Professionals w | 50 | Communication | 1 | top |
| 60 | Travel | 60 | Travel | This section re | 60 | Travel | 1 | top |
| 70 | Assess Evaluate | 70 | Assess Evaluate | Identification b | 70 | Assess Evaluate | 1 | top |
| 80 | Patient Needs | 80 | Patient Needs | There are a num | 80 | Patient Needs | 1 | top |
| 90 | ADL | 90 | ADL | Activities of dai | 90 | ADL | 1 | top |
| 91 | IADLS | 91 | IADLS | Instrumental A | 91 | IADLS | 1 | main |
| 100 | Medication | 100 | Medication | Related to the | 100 | Medication | 1 | main |
| 110 | Treatment | 110 | Treatment | Related to spec | 110 | Treatment | 1 | main |
| 120 | Documentation | 120 | Documentation | Any document | 120 | Documentation | 1 | main |
| 130 | Miscellaneous | 130 | Miscellaneous | Activities that f | 130 | Miscellaneous | 1 | main |
| 131 | Equipment | 131 | Equipment | A number of ac | 131 | Equipment | 1 | main |
| 132 | Housekeeping | 132 | Housekeeping | A number of ac | 132 | Housekeeping | 1 | main |
| 190 | Waiting* | 190 | Waiting* | Select this option | 190 | Waiting* | 1 | main |
| 200 | Lunch/Dinner/Break* | 200 | Lunch/Dinner/Break* | The profession | 200 | Lunch/Dinner/Break* | 1 | main |
| 210 | Pause* | 210 | Pause* | If the person yo | 210 | Pause* | 1 | main |
| 220 | Personal* | 220 | Personal* | Personal activit | 220 | Personal* | 1 | main |
| 230 | Unusual Incident - Patient* | 230 | Unusual Incident - Patient* | This is when yo | 230 | Unusual Incident - Patient* | 1 | main |
| 231 | Unusual Incident - Staff* | 231 | Unusual Incident - Staff* | This is when yo | 231 | Unusual Incident - Staff* | 1 | main |
| 240 | End of Data Collection* | 240 | End of Data Collection* | This is the last | 240 | End of Data Collection* | 1 | main |
| 270 | Patient No Consent* | 270 | Patient No Consent* | This field should | 270 | Patient No Consent* | 1 | main |
| 280 | Administration | 280 | Administration | The professional | 280 | Administration | 1 | main |
| 300 | Look For | 300 | Look For | The professional | 300 | Look For | 1 | main |
| 450 | Therapy | 450 | Therapy | The professional | 450 | Therapy | 1 | main |
| 530 | Conduct Activities | 530 | Conduct Activities | It may not be p | 530 | Conduct Activites | 1 | main |
| | Off Floor* | | Off Floor* | | | Off Floor* | | |
| 540 | Research Project* | 540 | Research Project* | Select this anyt | 540 | Research Project* | 1 | main |
| 20 | Infection Control | 20 | Put on glove/gown/mask | The professional | 20 | Put on glove/gown/mask | 2 | main |
| 20 | Infection Control | 20 | Request Assistance | A professional | 20 | Request Assistance | 2 | main |
| 20 | Infection Control | 20 | Take off glove/gown/mask | The professional | 20 | Take off glove/gown/mask | 2 | main |
| 20 | Infection Control | 20 | IC Other | An infection co | 20 | IC Other | 2 | bottom |
| 30 | Interruption | 30 | Knowledge Exchange | After an interru | 30 | Knowledge Exchange | 2 | main |

UC_Rank table

| Level 1 Category | | Code | Field Name | Field Description | CSV Name | | Level | UC_Rank |
|---|---|---|---|---|---|---|---|---|
| 10 | Wash Hands* | 10 | Wash Hands* | It is important to cap | 10 | Wash Hands* | 1 | top |
| 20 | Infection Control | 20 | Infection Control | Infection Control cov | 20 | Infection Control | 1 | main |
| 30 | Interruption | 30 | Interruption | Actions on the part c | 30 | Interruption | 1 | top |
| 50 | Communication | 50 | Communication | Professionals will eng | 50 | Communication | 1 | main |
| 60 | Travel | 60 | Travel | This section records | 60 | Travel | 1 | main |
| 70 | Assess Evaluate | 70 | Assess Evaluate | Identification by a pr | 70 | Assess Evaluate | 1 | main |
| 80 | Patient Needs | 80 | Patient Needs | There are a number | 80 | Patient Needs | 1 | main |
| 120 | Documentation | 120 | Documentation | Any documentation | 120 | Documentation | 1 | main |
| 130 | Miscellaneous | 130 | Miscellaneous | Activities that fit out | 130 | Miscellaneous | 1 | main |
| 131 | Equipment | 131 | Equipment | A number of activitie | 131 | Equipment | 1 | main |
| 132 | Housekeeping | 132 | Housekeeping | A number of activitie | 132 | Housekeeping | 1 | main |
| 190 | Waiting* | 190 | Waiting* | Select this option if y | 190 | Waiting* | 1 | main |
| 200 | Lunch/Dinner/Break* | 200 | Lunch/Dinner/Break* | The professional take | 200 | Lunch/Dinner/Break* | 1 | main |
| 210 | Pause* | 210 | Pause* | If the person you are | 210 | Pause* | 1 | main |
| 220 | Personal* | 220 | Personal* | Personal activities ar | 220 | Personal* | 1 | main |
| 230 | Unusual Incident - Patient* | 230 | Unusual Incident - Patient* | This is when your pro | 230 | Unusual Incident - Patient* | 1 | main |
| 231 | Unusual Incident - Staff* | 231 | Unusual Incident - Staff* | This is when your pro | 231 | Unusual Incident - Staff* | 1 | main |
| 240 | End of Data Collection* | 240 | End of Data Collection* | This is the last entry | 240 | End of Data Collection* | 1 | main |
| 270 | Patient No Consent* | 270 | Patient No Consent* | This field should be u | 270 | Patient No Consent* | 1 | main |
| 280 | Administration | 280 | Administration | The professional may | 280 | Administration | 1 | main |
| 300 | Look For | 300 | Look For | The professional may | 300 | Look For | 1 | main |
| 530 | Conduct Activities | 530 | Conduct Activities | It may not be possibl | 530 | Conduct Activites | 1 | main |
| | Off Floor* | | Off Floor* | | | Off Floor* | | |
| 540 | Research Project* | 540 | Research Project* | Select this anytime a | 540 | Research Project* | 1 | main |
| 20 | Infection Control | 20 | Put on glove/gown/mask | The professional put | 20 | Put on glove/gown/mask | 2 | main |
| 20 | Infection Control | 20 | Take off glove/gown/mask | The professional take | 20 | Take off glove/gown/mask | 2 | main |
| 30 | Interruption | 30 | Knowledge Exchange | After an interruption | 30 | Knowledge Exchange | 2 | main |
| 50 | Communication | 50 | Greeting patients/visitors | The professional quic | 50 | Greeting patients/visitors | 2 | main |

CNL_Rank table

| Field Name | Field Description | CSV Name | | Level | CNL_Rank |
|---|---|---|---|---|---|
| Wash Hands* | It is important to capture the extent to | 10 | Wash Hands* | 1 | main |
| Infection Control | Infection Control covers activities relat | 20 | Infection Control | 1 | main |
| Interruption | Actions on the part of another individu | 30 | Interruption | 1 | main |
| Communication | Professionals will engage in communic | 50 | Communication | 1 | main |
| Travel | This section records the travelling a pro | 60 | Travel | 1 | main |
| Assess Evaluate | Identification by a professional of the r | 70 | Assess Evaluate | 1 | main |
| Patient Needs | There are a number of tasks and activit | 80 | Patient Needs | 1 | main |
| ADL | Activities of daily living (ADLs): The thir | 90 | ADL | 1 | main |
| IADLS | Instrumental Activities of Daily Living (I | 91 | IADLS | 1 | main |
| Medication | Related to the drugs or curative substa | 100 | Medication | 1 | main |
| Treatment | Related to specific patient care and wil | 110 | Treatment | 1 | main |
| Documentation | Any documentation including charting, | 120 | Documentation | 1 | main |
| Miscellaneous | Activities that fit outside the other mai | 130 | Miscellaneous | 1 | main |
| Housekeeping | A number of activities that are related | 132 | Housekeeping | 1 | main |
| Waiting* | Select this option if your professional is | 190 | Waiting* | 1 | main |
| Lunch/Dinner/Break* | The professional takes a scheduled lun | 200 | Lunch/Dinner/Break* | 1 | main |
| Pause* | If the person you are observing needs t | 210 | Pause* | 1 | main |
| Personal* | Personal activities are not related to ar | 220 | Personal* | 1 | main |
| Unusual Incident - Patient* | This is when your professional is direct | 230 | Unusual Incident - Patient* | 1 | main |
| Unusual Incident - Staff* | This is when your professional is direct | 231 | Unusual Incident - Staff* | 1 | main |
| End of Data Collection* | This is the last entry for your day of da | 240 | End of Data Collection* | 1 | main |
| Patient No Consent* | This field should be used when a patien | 270 | Patient No Consent* | 1 | main |
| Administration | The professional may conduct a numbe | 280 | Administration | 1 | main |
| Look For | The professional may look for a numbe | 300 | Look For | 1 | main |
| Conduct Activities Off Floor* | It may not be possible to capture some | 530 | Conduct Activites Off Floor* | 1 | main |
| Research Project* | Select this anytime a professional is pa | 540 | Research Project* | 1 | main |
| Put on glove/gown/mask | The professional puts on gloves, gown | 20 | Put on glove/gown/mask | 2 | main |

Ward Aide table

| | | | | | | | | Ward |
|---|---|---|---|---|---|---|---|---|
| Level 1 Category | | Code | Field Name | Field Description | CSV Name | | Level | Aide_{—} |
| 10 | Wash Hands* | 10 | Wash Hands* | It is important to capture the | 10 | Wash Hands* | 1 | main |
| 20 | Infection Control | 20 | Infection Control | Infection Control covers activ | 20 | Infection Control | 1 | main |
| 30 | Interruption | 30 | Interruption | Actions on the part of anothe | 30 | Interruption | 1 | main |
| 50 | Communication | 50 | Communication | Professionals will engage in c | 50 | Communication | 1 | main |
| 60 | Travel | 60 | Travel | This section records the trave | 60 | Travel | 1 | main |
| 70 | Assess Evaluate | 70 | Assess Evaluate | Identification by a profession | 70 | Assess Evaluate | 1 | main |
| 120 | Documentation | 120 | Documentation | Any documentation including | 120 | Documentation | 1 | main |
| 130 | Miscellaneous | 130 | Miscellaneous | Activities that fit outside the | 130 | Miscellaneous | 1 | main |
| 132 | Housekeeping | 132 | Housekeeping | A number of activities that ar | 132 | Housekeeping | 1 | main |
| 190 | Waiting* | 190 | Waiting* | Select this option if your prof | 190 | Waiting* | 1 | main |
| 200 | Lunch/Dinner/Break* | 200 | Lunch/Dinner/Break* | The professional takes a sche | 200 | Lunch/Dinner/Brea | 1 | main |
| 210 | Pause* | 210 | Pause* | If the person you are observin | 210 | Pause* | 1 | main |
| 220 | Personal* | 220 | Personal* | Personal activities are not rel | 220 | Personal* | 1 | main |
| 230 | Unusual Incident - Patient* | 230 | Unusual Incident - Patient* | This is when your professiona | 230 | Unusual Incident - P | 1 | main |
| 231 | Unusual Incident - Staff* | 231 | Unusual Incident - Staff* | This is when your professiona | 231 | Unusual Incident -S | 1 | main |
| 240 | End of Data Collection* | 240 | End of Data Collection* | This is the last entry for your | 240 | End of Data Collect | 1 | main |
| 270 | Patient No Consent* | 270 | Patient No Consent* | This field should be used whe | 270 | Patient No Consent | 1 | main |
| 280 | Administration | 280 | Administration | The professional may conduc | 280 | Administration | 1 | main |
| 300 | Look For | 300 | Look For | The professional may look for | 300 | Look For | 1 | main |
| 450 | Therapy | 450 | Therapy | The professional may conduc | 450 | Therapy | 1 | main |
| 530 | Conduct Activities | 530 | Conduct Activities | It may not be possible to | 530 | Conduct Activites O | 1 | main |
| | Off Floor* | | Off Floor* | capt | | | | |
| 540 | Research Project* | 540 | Research Project* | Select this anytime a professi | 540 | Research Project* | 1 | main |
| 20 | Infection Control | 20 | Request Assistance | A professional may need help | 20 | Request Assistance | 2 | main |
| 30 | Interruption | 30 | Knowledge Exchange | After an interruption the prof | 30 | Knowledge Exchange | 2 | main |
| 50 | Communication | 50 | Greeting patients/visitors | The professional quickly gree | 50 | Greeting patients/vis | 2 | main |
| 50 | Communication | 50 | Knowledge Exchange | The professional may exchan | 50 | Knowledge Exchange | 2 | main |
| 50 | Communication | 50 | Meeting -Other | Use this form of communicat | 50 | Meeting -Other | 2 | main |

Physician table

| Level 1 Category | | Code | Field Name | Field Description | CSV Name | | Level | Physician_{—} |
|---|---|---|---|---|---|---|---|---|
| 10 | Wash Hands* | 10 | Wash Hands* | It is important t | 10 | Wash Hands* | 1 | main |
| 20 | Infection Control | 20 | Infection Control | Infection Contro | 20 | Infection Control | 1 | main |
| 30 | Interruption | 30 | Interruption | Actions on the | 30 | Interruption | 1 | main |
| 50 | Communication | 50 | Communication | Professionals w | 50 | Communication | 1 | main |
| 60 | Travel | 60 | Travel | This section rec | 60 | Travel | 1 | main |
| 70 | Assess Evaluate | 70 | Assess Evaluate | Identification b | 70 | Assess Evaluate | 1 | main |
| 110 | Treatment | 110 | Treatment | Related to spec | 110 | Treatment | 1 | main |
| 120 | Documentation | 120 | Documentation | Any documents | 120 | Documentation | 1 | main |
| 130 | Miscellaneous | 130 | Miscellaneous | Activities that f | 130 | Miscellaneous | 1 | main |
| 132 | Housekeeping | 132 | Housekeeping | A number of ac | 132 | Housekeeping | 1 | main |
| 190 | Waiting* | 190 | Waiting* | Select this optio | 190 | Waiting* | 1 | main |
| 200 | Lunch/Dinner/Break* | 200 | Lunch/Dinner/Break* | The professiona | 200 | Lunch/Dinner/Break* | 1 | main |
| 210 | Pause* | 210 | Pause* | If the person yo | 210 | Pause* | 1 | main |
| 220 | Personal* | 220 | Personal* | Personal activit | 220 | Personal* | 1 | main |
| 230 | Unusual Incident - Patient* | 230 | Unusual Incident - Patient* | This is when yo | 230 | Unusual Incident - Patient* | 1 | main |
| 231 | Unusual Incident - Staff* | 231 | Unusual Incident - Staff* | This is when yo | 231 | Unusual Incident - Staff* | 1 | main |
| 240 | End of Data Collection* | 240 | End of Data Collection* | This is the last e | 240 | End of Data Collection* | 1 | main |
| 270 | Patient No Consent* | 270 | Patient No Consent* | This field should | 270 | Patient No Consent* | 1 | main |
| 280 | Administration | 280 | Administration | The professiona | 280 | Administration | 1 | main |
| 300 | Look For | 300 | Look For | The professiona | 300 | Look For | 1 | main |
| 530 | Conduct Activities | 530 | Conduct Activities | It may not be p | 530 | Conduct Activites | 1 | main |
| | Off Floor* | | Off Floor* | | | Off Floor* | | |
| 540 | Research Project* | 540 | Research Project* | Select this anyt | 540 | Research Project* | 1 | main |
| 20 | Infection Control | 20 | Put on glove/gown/mask | The professiona | 20 | Put on glove/gown/mask | 2 | main |
| 20 | Infection Control | 20 | Take off glove/gown/mask | The professiona | 20 | Take off glove/gown/mask | 2 | main |
| 30 | Interruption | 30 | Knowledge Exchange | After an interru | 30 | Knowledge Exchange | 2 | main |
| 50 | Communication | 50 | Greeting patients/visitors | The professiona | 50 | Greeting patients/visitors | 2 | main |
| 50 | Communication | 50 | Knowledge Exchange | The professiona | 50 | Knowledge Exchange | 2 | main |

Therapist table

| Level 1 Category | | Code | Field Name | Field Description | CSV Name | | Level | Therapist_{—} |
|---|---|---|---|---|---|---|---|---|
| 10 | Wash Hands* | 10 | Wash Hands* | It is important t | 10 | Wash Hands* | 1 | main |
| 20 | Infection Control | 20 | Infection Control | Infection Contro | 20 | Infection Control | 1 | main |
| 30 | Interruption | 30 | Interruption | Actions on the p | 30 | Interruption | 1 | main |
| 50 | Communication | 50 | Communic ation | Professionals w | 50 | Communication | 1 | main |
| 60 | Travel | 60 | Travel | This section rec | 60 | Travel | 1 | main |
| 70 | Assess Evaluate | 70 | Assess Evaluate | Identification by | 70 | Assess Evaluate | 1 | main |
| 90 | ADL | 90 | ADL | Activities of dai | 90 | ADL | 1 | main |
| 91 | IADLS | 91 | IADLS | Instrumental Ac | 91 | IADLS | 1 | main |
| 120 | Documentation | 120 | Documentation | Any documenta | 120 | Documentation | 1 | main |
| 130 | Miscellaneous | 130 | Miscellaneous | Activities that fi | 130 | Miscellaneous | 1 | main |
| 132 | Housekeeping | 132 | Housekeeping | A number of ac | 132 | Housekeeping | 1 | main |
| 190 | Waiting* | 190 | Waiting* | Select this optio | 190 | Waiting* | 1 | main |
| 200 | Lunch/Dinner/Break* | 200 | Lunch/Dinner/Break* | The professiona | 200 | Lunch/Dinner/Break* | 1 | main |
| 210 | Pause* | 210 | Pause* | If the person yo | 210 | Pause* | 1 | main |
| 220 | Personal* | 220 | Personal* | Personal activit | 220 | Personal* | 1 | main |
| 230 | Unusual Incident - Patient* | 230 | Unusual Incident - Patient* | This is when you | 230 | Unusual Incident - Patient* | 1 | main |
| 231 | Unusual Incident - Staff* | 231 | Unusual Incident - Staff* | This is when you | 231 | Unusual Incident - Staff* | 1 | main |
| 240 | End of Data Collection* | 240 | End of Data Collection* | This is the last e | 240 | End of Data Collection* | 1 | main |
| 270 | Patient No Consent* | 270 | Patient No Consent* | This field should | 270 | Patient No Consent* | 1 | main |
| 280 | Administration | 280 | Administration | The professiona | 280 | Administration | 1 | main |
| 300 | Look For | 300 | Look For | The professiona | 300 | Look For | 1 | main |
| 450 | Therapy | 450 | Therapy | The professiona | 450 | Therapy | 1 | main |
| 530 | Conduct Activities | 530 | Conduct Activities | It may not be po | 530 | Conduct Activites | 1 | main |
| | Off Floor* | | Off Floor* | | | Off Floor* | | |
| 540 | Research Project* | 540 | Research Project* | Select this anyti | 540 | Research Project* | 1 | main |
| 20 | Infection Control | 20 | Put on glove/gown/mask | The professiona | 20 | Put on glove/gown/mask | 2 | main |
| 20 | Infection Control | 20 | Take off glove/gown/mask | The professiona | 20 | Take off glove/gown/mask | 2 | main |
| 30 | Interruption | 30 | Knowledge Exchange | After an interru | 30 | Knowledge Exchange | 2 | main |

SW_Rank table

| Level 1 Category | | Code | Field Name | Field Description | CSV Name | | Level | SW_Rank |
|---|---|---|---|---|---|---|---|---|
| 10 | Wash Hands* | 10 | Wash Hands* | It is important t | 10 | Wash Hands* | 1 | main |
| 20 | Infection Control | 20 | Infection Control | Infection Contro | 20 | Infection Control | 1 | main |
| 30 | Interruption | 30 | Interruption | Actions on the p | 30 | Interruption | 1 | main |
| 50 | Communication | 50 | Communication | Professionals w | 50 | Communication | 1 | main |
| 60 | Travel | 60 | Travel | This section rec | 60 | Travel | 1 | main |
| 70 | Assess Evaluate | 70 | Assess Evaluate | Identification by | 70 | Assess Evaluate | 1 | main |
| 90 | ADL | 90 | ADL | Activities of dail | 90 | ADL | 1 | main |
| 91 | IADLS | 91 | IADLS | Instrumental Ac | 91 | IADLS | 1 | main |
| 120 | Documentation | 120 | Documentation | Any documenta | 120 | Documentation | 1 | main |
| 130 | Miscellaneous | 130 | Miscellaneous | Activities that fi | 130 | Miscellaneous | 1 | main |
| 132 | Housekeeping | 132 | Housekeeping | A number of act | 132 | Housekeeping | 1 | main |
| 190 | Waiting* | 190 | Waiting* | Select this optio | 190 | Waiting* | 1 | main |
| 200 | Lunch/Dinner/Break* | 200 | Lunch/Dinner/Break* | The professiona | 200 | Lunch/Dinner/Break* | 1 | main |
| 210 | Pause* | 210 | Pause* | If the person yo | 210 | Pause* | 1 | main |
| 220 | Personal* | 220 | Personal* | Personal activiti | 220 | Personal* | 1 | main |
| 230 | Unusual Incident - Patient* | 230 | Unusual Incident - Patient* | This is when you | 230 | Unusual Incident - Patient* | 1 | main |
| 231 | Unusual Incident - Staff* | 231 | Unusual Incident - Staff* | This is when you | 231 | Unusual Incident - Staff* | 1 | main |
| 240 | End of Data Collection* | 240 | End of Data Collection* | This is the last e | 240 | End of Data Collection* | 1 | main |
| 270 | Patient No Consent* | 270 | Patient No Consent* | This field should | 270 | Patient No Consent* | 1 | main |
| 280 | Administration | 280 | Administration | The professiona | 280 | Administration | 1 | main |
| 300 | Look For | 300 | Look For | The professiona | 300 | Look For | 1 | main |
| 450 | Therapy | 450 | Therapy | The professiona | 450 | Therapy | 1 | main |
| 530 | Conduct Activities | 530 | Conduct Activities | It may not be po | 530 | Conduct Activites | 1 | main |
| | Off Floor | | Off Floor* | | | Off Floor* | | |
| 540 | Research Project* | 540 | Research Project* | Select this anyti | 540 | Research Project* | 1 | main |
| 20 | Infection Control | 20 | Put on glove/gown/mask | The professiona | 20 | Put on glove/gown/mask | 2 | main |
| 20 | Infection Control | 20 | Take off glove/gown/mask | The professiona | 20 | Take off glove/gown/mask | 2 | main |

Codes

| | |
|---|---|
| 10 | Wash Hands* |
| 20 | Infection Control |
| 30 | Interruption |
| 50 | Communication |
| 60 | Travel |
| 70 | Assess Evaluate |
| 80 | Patient Needs |
| 90 | ADL |
| 91 | IADLS |
| 100 | Medication |
| 110 | Treatment |
| 120 | Documentation |
| 130 | Miscellaneous |
| 131 | Equipment |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look For |
| 450 | Therapy |
| 530 | Conduct Activites Off Floor* |
| 540 | Research Project* |
| 20 | Put on glove/gown/mask |
| 20 | Request Assistance |
| 20 | Take off glove/gown/mask |
| 20 | IC Other |
| 30 | Knowledge Exchange |
| 50 | Greeting patients/visitors |
| 50 | Interview - Patient |
| 50 | Knowledge Exchange |
| 50 | Meeting - Family |
| 50 | Meeting -Other |
| 50 | Meeting -Rounds |
| 50 | Report |
| 50 | Verbal/Status Update |
| 60 | Med Room - E1 |
| 60 | Med Room - W1 |
| 60 | Nursing Station - E1 |
| 60 | Nursing Station - W1 |
| 60 | Pt Room |
| 60 | Supply/Storage Rooms |
| 60 | Building Services Room - W1 |
| 60 | Dining Room - W1 |
| 60 | Documntatn Educatn Rm - W1 |
| 60 | Games Room |
| 60 | Hall |
| 60 | Hallway Interview Chairs - E1 |
| 60 | Hallway Interview Chairs - W1 |
| 60 | Interview (Seclusion) Rm - E1 |
| 60 | Interview (Seclusion) Rm - W1 |
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |
| 999 | Patient 21 |
| 999 | Patient 22 |
| 999 | Info Record -Computer |
| 999 | Info Record -Offline |
| 999 | Info Review -Computer |
| 999 | Info Review -Offline |
| 999 | Document - Handoff |
| 999 | Email -Read |
| 999 | Email -Write |
| 999 | Face to Face |
| 999 | Fax |
| 999 | Filing |
| 999 | Intercom |
| 999 | Not Applicable |
| 999 | Other |
| 999 | Pager |
| 999 | Photocopy |
| 999 | Print |
| 999 | Research -Computer |
| 999 | Research -Paper based |
| 999 | Take Out/Return Paperwork |
| 999 | Telephone - Transfer call |
| 999 | Telephone In |
| 999 | Telephone In - take message |
| 999 | Telephone On Hold |
| 999 | Telephone Out |
| 999 | Telephone Unanswered |
| 999 | Transcribe Doctors Orders |
| 999 | Voicemail |
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Patient Group |
| 999 | Psychiatrist |
| 999 | Psychologist |
| 999 | Rehab Assistant |
| 999 | RN |
| 999 | Social Worker |
| 999 | Staff Group |
| 999 | Student Nurse |
| 999 | Unit Clerk |
| 999 | Ambulance Service |
| 999 | Central Processing |
| 999 | Clinical Nurse Educator |
| 999 | Clinical Nurse Specialist |
| 999 | Commity Transition Tm (CTT) |
| 999 | Community Case Manager |
| 999 | Community Mental Health Tm |
| 999 | Dietician/Nutritionist |
| 999 | Emergency Services - 911 |
| 999 | ER |
| 999 | Food Services Department |
| 999 | Friends/Family of Patient |
| 999 | ADL -General |
| 999 | ADL -Patient Hygiene |
| 999 | Administrative |
| 999 | ALC |
| 999 | Appoint/Test |
| 999 | Arrange Meeting/Conference |
| 999 | Arrange Peer Support |
| 999 | Assessment |
| 999 | Bed Availability |
| 999 | Bowel Care |
| 999 | Bowel Habits |
| 999 | Care Plan |
| 999 | Census/Bed Assignment |
| 999 | Concerns and Complaints |
| 999 | Cueing Actin wth Staff/Stdnt |
| 999 | Cueing Action with Patient |
| 999 | Death Related |
| 999 | Diet -Nutrition |
| 999 | Diet -Pt Meals |
| 999 | Directions |
| 999 | Discharge Options/Planning |
| 999 | Doctors Orders |
| 999 | Doctors Orders -clarify |
| 999 | Domestic Violence |
| 999 | Emotionl Supprt for Pt/Famly |
| 999 | Encourage and Motivate Pt |
| 999 | Equip/Supplies -Admin |
| 999 | Equip/Supplies -Missing |

Codes

| | |
|---|---|
| 10 | Wash Hands* |
| 20 | Infection Control |
| 30 | Interruption |
| 50 | Communication |
| 60 | Travel |
| 70 | Assess Evaluate |
| 80 | Patient Needs |
| 120 | Documentation |
| 130 | Miscellaneous |
| 131 | Equipment |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look For |
| 530 | Conduct Activites Off Floor* |
| 540 | Research Project* |
| 20 | Put on glove/gown/mask |
| 20 | Take off glove/gown/mask |
| 30 | Knowledge Exchange |
| 50 | Greeting patients/visitors |
| 50 | Knowledge Exchange |
| 50 | Meeting -Other |
| 50 | Verbal/Status Update |
| 60 | Med Room - E1 |
| 60 | Med Room - W1 |
| 60 | Nursing Station - E1 |
| 60 | Nursing Station - W1 |
| 60 | Pt Room |
| 60 | Supply/Storage Rooms |
| 60 | Building Services Room - W1 |
| 60 | Dining Room - W1 |
| 60 | Documntatn Educatn Rm - W1 |
| 60 | Games Room |
| 60 | Hall |
| 60 | Hallway Interview Chairs - E1 |
| 60 | Hallway Interview Chairs - W1 |
| 60 | Interview (Seclusion) Rm - E1 |
| 60 | Interview (Seclusion) Rm - W1 |
| 60 | Kitchen - E1 |
| 60 | Linen Cart - E1 |
| 60 | Linen Cart - W1 |
| 60 | Lounge TV Room - E1 |
| 60 | Nursing Conference Room - E1 |
| 60 | Nursing Lounge - W1 |
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |
| 999 | Patient 21 |
| 999 | Patient 22 |
| 999 | Audit Documents |
| 999 | Info Record -Computer |
| 999 | Info Record -Offline |
| 999 | Info Review -Computer |
| 999 | Info Review -Offline |
| 999 | Print |
| 999 | Chart -Assemble |
| 999 | Chart -Take Apart |
| 999 | Chart -Thin |
| 999 | Document - Handoff |
| 999 | Email -Read |
| 999 | Email -Write |
| 999 | Face to Face |
| 999 | Fax |
| 999 | Filing |
| 999 | Intercom |
| 999 | Not Applicable |
| 999 | Other |
| 999 | Pager |
| 999 | Photocopy |
| 999 | Print |
| 999 | Research -Computer |
| 999 | Research -Paper based |
| 999 | Take Out/Return Paperwork |
| 999 | Telephone - Transfer call |
| 999 | Telephone In |
| 999 | Telephone In - take message |
| 999 | Telephone On Hold |
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Patient Group |
| 999 | Psychiatrist |
| 999 | Psychologist |
| 999 | Rehab Assistant |
| 999 | RN |
| 999 | Social Worker |
| 999 | Staff Group |
| 999 | Student Nurse |
| 999 | Unit Clerk |
| 999 | Ambulance Service |
| 999 | Central Processing |
| 999 | Clinical Nurse Educator |
| 999 | Clinical Nurse Specialist |
| 999 | Commity Transition Tm (CTT) |
| 999 | Community Case Manager |
| 999 | Community Mental Health Tm |
| 999 | Dietician/Nutritionist |
| 999 | Emergency Services - 911 |
| 999 | ER |
| 999 | Food Services Department |
| 999 | Administrative |
| 999 | ALC |
| 999 | Appoint/Test |
| 999 | Arrange Meeting/Conference |
| 999 | Arrange Peer Support |
| 999 | Bed Availability |
| 999 | Census/Bed Assignment |
| 999 | Concerns and Complaints |
| 999 | Death Related |
| 999 | Diet -Nutrition |
| 999 | Diet -Pt Meals |
| 999 | Directions |
| 999 | Doctors Orders |
| 999 | Doctors Orders -clarify |
| 999 | Equip/Supplies -Admin |
| 999 | Equip/Supplies -Missing |
| 999 | Equip/Supplies -Patient |
| 999 | Hospital Maintenance |
| 999 | Hospital Policies |
| 999 | Hospital Security |
| 999 | Housekeeping - Unit |
| 999 | Housekeeping -Pt Room |
| 999 | Infection Control |
| 999 | IT issues |
| 999 | Lab/Test Results |
| 999 | Medication - New |
| 999 | Medication - PRN Request |

Codes

| | |
|---|---|
| 10 | Wash Hands* |
| 20 | Infection Control |
| 30 | Interruption |
| 50 | Communication |
| 60 | Travel |
| 70 | Assess Evaluate |
| 80 | Patient Needs |
| 90 | ADL |
| 91 | IADLS |
| 100 | Medication |
| 110 | Treatment |
| 120 | Documentation |
| 130 | Miscellaneous |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look For |
| 530 | Conduct Activites Off Floor* |
| 540 | Research Project* |
| 20 | Put on glove/gown/mask |
| 20 | Take off glove/gown/mask |
| 20 | IC Other |
| 30 | Knowledge Exchange |
| 50 | Greeting patients/visitors |
| 50 | Knowledge Exchange |
| 50 | Meeting - Family |
| 50 | Meeting -Other |
| 50 | Meeting -Rounds |
| 50 | Report |
| 50 | Verbal/Status Update |
| 60 | Med Room - E1 |
| 60 | Med Room - W1 |
| 60 | Nursing Station - E1 |
| 60 | Nursing Station - W1 |
| 60 | Pt Room |
| 60 | Building Services Room - W1 |
| 60 | Dining Room - W1 |
| 60 | Documntatn Educatn Rm - W1 |
| 60 | Games Room |
| 60 | Hall |
| 60 | Hallway Interview Chairs - E1 |
| 60 | Hallway Interview Chairs - W1 |
| 60 | Interview (Seclusion) Rm - E1 |
| 60 | Interview (Seclusion) Rm - W1 |
| 60 | Kitchen - E1 |
| 60 | Linen Cart - E1 |
| 60 | Linen Cart - W1 |
| 60 | Lounge TV Room - E1 |
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |
| 999 | Patient 21 |
| 999 | Patient 22 |
| 999 | Patient 23 |
| 999 | Audit Documents |
| 999 | Info Record -Computer |
| 999 | Info Record -Offline |
| 999 | Info Review -Computer |
| 999 | Info Review -Offline |
| 999 | Document - Handoff |
| 999 | Email -Read |
| 999 | Email -Write |
| 999 | Face to Face |
| 999 | Fax |
| 999 | Filing |
| 999 | Intercom |
| 999 | Not Applicable |
| 999 | Other |
| 999 | Pager |
| 999 | Photocopy |
| 999 | Print |
| 999 | Research -Computer |
| 999 | Research -Paper based |
| 999 | Sorting/Distributing |
| 999 | Take Out/Return Paperwork |
| 999 | Telephone - Transfer call |
| 999 | Telephone In |
| 999 | Telephone In - take message |
| 999 | Telephone On Hold |
| 999 | Telephone Out |
| 999 | Telephone Unanswered |
| 999 | Voicemail |
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Patient Group |
| 999 | Psychiatrist |
| 999 | Psychologist |
| 999 | Rehab Assistant |
| 999 | RN |
| 999 | Social Worker |
| 999 | Staff Group |
| 999 | Student Nurse |
| 999 | Unit Clerk |
| 999 | VGH Other |
| 999 | Bed Flow Coordinator |
| 999 | Central Processing |
| 999 | Clinical Nurse Educator |
| 999 | Clinical Nurse Specialist |
| 999 | Commity Transition Tm (CU) |
| 999 | Community Case Manager |
| 999 | Community Mental Health Tm |
| 999 | Dietician/Nutritionist |
| 999 | Emergency Services - 911 |
| 999 | ER |
| 999 | Food Services Department |
| 999 | Friends/Family of Patient |
| 999 | Bed Availability |
| 999 | Concerns and Complaints |
| 999 | Staff - Absence/Vacation |
| 999 | Staff -General |
| 999 | Staff -Injuries |
| 999 | Staff -Overtime |
| 999 | Staff -Performance |
| 999 | Staff -Professinal Develpmnt |
| 999 | Staff -Scheduling |
| 999 | Staff -Shifts/Breaks |
| 999 | Staff -Stress |
| 999 | Staff -Whereabouts |
| 999 | VGH/MHAS Organiznal Issues |
| 999 | ADL -General |
| 999 | ADL -Patient Hygiene |
| 999 | Administrative |
| 999 | ALC |
| 999 | Appoint/Test |
| 999 | Arrange Peer Support |
| 999 | Assessment |
| 999 | Care Plan |
| 999 | Census/Bed Assignment |
| 999 | Committee Work |
| 999 | Death Related |
| 999 | Diet -Nutrition |
| 999 | Directions |
| 999 | Discharge Options/Planning |
| 999 | Doctors Orders |
| 999 | Doctors Orders -clarify |

Codes

| | |
|---|---|
| 10 | Wash Hands* |
| 20 | Infection Control |
| 30 | Interruption |
| 50 | Communication |
| 60 | Travel |
| 70 | Assess Evaluate |
| 120 | Documentation |
| 130 | Miscellaneous |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look For |
| 450 | Therapy |
| 530 | Conduct Activites Off Floor* |
| 540 | Research Project* |
| 20 | Request Assistance |
| 30 | Knowledge Exchange |
| 50 | Greeting patients/visitors |
| 50 | Knowledge Exchange |
| 50 | Meeting -Other |
| 50 | Meeting -Rounds |
| 50 | Verbal/Status Update |
| 60 | Nursing Station - E1 |
| 60 | Nursing Station - W1 |
| 60 | Psychologist Office |
| 60 | Building Services Room - W1 |
| 60 | Dining Room - W1 |
| 60 | Documntatn Educatn Rm - W1 |
| 60 | E1- Other |
| 60 | Games Room |
| 60 | Hall |
| 60 | Hallway Interview Chairs - E1 |
| 60 | Hallway Interview Chairs - W1 |
| 60 | Interview (Seclusion) Rm - E1 |
| 60 | Interview (Seclusion) Rm - W1 |
| 60 | Kitchen - E1 |
| 60 | Linen Cart -E1 |
| 60 | Linen Cart - W1 |
| 60 | Lobby |
| 60 | Lounge TV Room - E1 |
| 60 | Med Room - E1 |
| 60 | Med Room - W1 |
| 60 | Nursing Conference Room - E1 |
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |
| 999 | Patient 21 |
| 999 | Patient 22 |
| 999 | Info Record -Computer |
| 999 | Info Record -Offline |
| 999 | Info Review -Computer |
| 999 | Info Review -Offline |
| 999 | Document - Handoff |
| 999 | Email -Read |
| 999 | Email -Write |
| 999 | Face to Face |
| 999 | Fax |
| 999 | Filing |
| 999 | Not Applicable |
| 999 | Other |
| 999 | Photocopy |
| 999 | Print |
| 999 | Research -Computer |
| 999 | Research -Paper based |
| 999 | Score Assessment/Test |
| 999 | Sorting/Distributing |
| 999 | Take Out/Return Paperwork |
| 999 | Telephone - Transfer call |
| 999 | Telephone In |
| 999 | Telephone On Hold |
| 999 | Telephone Out |
| 999 | Telephone Unanswered |
| 999 | Voicemail |
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Psychiatrist |
| 999 | Psychologist |
| 999 | RN |
| 999 | Social Worker |
| 999 | Unit Clerk |
| 999 | Clinical Nurse Educator |
| 999 | Clinical Nurse Specialist |
| 999 | Commity Transition Tm (CTT) |
| 999 | Community Case Manager |
| 999 | Community Mental Health Tm |
| 999 | Community Res/Progs - Other |
| 999 | Dietician/Nutritionist |
| 999 | ER |
| 999 | Friends/Family of Patient |
| 999 | Hospital Staff Other |
| 999 | Hospital Ward Clerk |
| 999 | ADL -General |
| 999 | ADL -Patient Hygiene |
| 999 | Administrative |
| 999 | ALC |
| 999 | Appoint/Test |
| 999 | Arrange Meeting/Conference |
| 999 | Assessment |
| 999 | Care Plan |
| 999 | Concerns and Complaints |
| 999 | Cueing Actin wth Staff/Stdnt |
| 999 | Discharge Options/Planning |
| 999 | Doctors Orders |
| 999 | Emotionl Supprt for Pt/Famly |
| 999 | Encourage and Motivate Pt |
| 999 | Grp Progrm Devlopmt |
| 999 | Hospital Policies |
| 999 | Hospital Security |
| 999 | Housing |
| 999 | IT issues |
| 999 | Lab/Test Results |
| 999 | Medication - New |
| 999 | Medication -General |
| 999 | Medication -History |

Field List part 1
1—Main Role and Function

| | |
|---|---|
| 10 | Wash Hands* |
| 20 | Infection Control |
| 30 | interruption |
| 50 | Communication |
| 60 | Travel |
| 70 | Assess Evaluate |
| 80 | Patient Needs |
| 90 | ADL |
| 91 | IADLS |
| 100 | Medication |
| 110 | Treatment |
| 120 | Documentation |
| 130 | Miscellaneous |
| 131 | Equipment |
| 132 | Housekeeping |
| 190 | Waiting* |
| 200 | Lunch/Dinner/Break* |
| 210 | Pause* |
| 220 | Personal* |
| 230 | Unusual Incident - Patient* |
| 231 | Unusual Incident - Staff* |
| 240 | End of Data Collection* |
| 270 | Patient No Consent* |
| 280 | Administration |
| 300 | Look for |
| 450 | Therapy |

2—Sub-activities

| | |
|---|---|
| 20 | Put on glove/gown/mask |
| 20 | Request Assistance |
| 20 | Take off glove/gown/mask |
| 20 | IC Other |
| 30 | Knowledge Exchange |
| 50 | Greeting patients/visitors |
| 50 | Interview - Patient |
| 50 | Knowledge Exchange |
| 50 | Meeting - Family |
| 50 | Meeting -Other |
| 50 | Meeting -Rounds |
| 50 | Report |
| 50 | Verbal/Status Update |
| 60 | Med Room - E1 |
| 60 | Med Room - W1 |
| 60 | Nursing Station - E1 |
| 60 | Nursing Station - W1 |
| 60 | Pt Room |
| 60 | Supply/Storage Rooms |
| 60 | Building Services Room - W1 |
| 60 | Dining Room - W1 |
| 60 | Documntatn Educatn Rm - W1 |
| 60 | Games Room |
| 60 | Hall |
| 60 | Hallway Interview Chairs - E1 |
| 60 | Hallway Interview Chairs - W1 |
| 70 | Staff -Assist |
| 70 | Staff -Mentor |
| 70 | Staff -Observe |
| 70 | Unit Observation |
| 70 | Weigh Patient |
| 70 | Assess Other |
| 80 | Dispose Dirty Linen/Materials |
| 80 | Drop off Drink/Meal/Snack |
| 80 | Drop off Equipment |
| 80 | Drop off Linen/Blankt/laundy |
| 80 | Drop off OTHER |
| 80 | Drop off Patient Belongings |
| 80 | Drop off Supplies |
| 80 | Hand Out Pt Privileges/Needs |
| 80 | Make Snack/Meal |
| 80 | Pick up Drink/Meal/Snack |
| 80 | Pick up Equipment |
| 80 | Pick up Linen/Blankt/Laundy |
| 80 | Pick up OTHER |
| 80 | Pick Up Patient Belongings |
| 80 | Pick up Supplies |
| 80 | Needs Other |
| 90 | Bath/Shower |
| 90 | Dress Patient |
| 90 | Lilt Manual -Alone |
| 90 | Personal Hygiene |
| 120 | Book Manual |
| 120 | Care Plan |
| 120 | Directors Warrant |
| 120 | Discharge Paperwork General |
| 020 | Discharge Planning Sheet |
| 120 | Doctors/Physicians Orders |
| 120 | Document - Multiple |
| 120 | Incident Report - Employee |
| 120 | Incident Report - Patient |
| 120 | Informal Notes |
| 120 | Kardex |
| 120 | Lab Report/Test Results |
| 120 | MAR |
| 120 | Mentl Health Act Fms -Other |
| 120 | Nursing Admission Assessment |
| 120 | Pass Tool |
| 120 | Patient Chart |
| 120 | Patient List |
| 120 | Referral Document |
| 120 | Requisition Document |
| 120 | Rounds Paperwork |
| 120 | Staff -Assist |
| 120 | Staff -Mentor |
| 120 | Staff -Observe |
| 120 | Staff Schedule |
| 120 | Transfer Paperwork |
| 300 | Supplies |
| 300 | Document Other |
| 300 | Look Other |
| 450 | Therapy Other |

Field List part 2
3—Patient Details

| | |
|---|---|
| 999 | Not Applicable |
| 999 | Patient Discharge |
| 999 | Patient Group |
| 999 | Patient New |
| 999 | Patient No Consent |
| 999 | Patient Unknown |
| 999 | Patient 1 |
| 999 | Patient 2 |
| 999 | Patient 3 |
| 999 | Patient 4 |
| 999 | Patient 5 |
| 999 | Patient 6 |
| 999 | Patient 7 |
| 999 | Patient 8 |
| 999 | Patient 9 |
| 999 | Patient 10 |
| 999 | Patient 11 |
| 999 | Patient 12 |
| 999 | Patient 13 |
| 999 | Patient 14 |
| 999 | Patient 15 |
| 999 | Patient 16 |
| 999 | Patient 17 |
| 999 | Patient 18 |
| 999 | Patient 19 |
| 999 | Patient 20 |

4—Mode of Main Activity

| | |
|---|---|
| 999 | Into Record -Computer |
| 999 | Info Record -Offline |
| 999 | Info Review -Computer |
| 999 | Into Review -Offline |
| 999 | Document - Handoff |
| 999 | Email -Read |
| 999 | Email -Write |
| 999 | Face to Face |
| 999 | Fax |
| 999 | Filing |
| 999 | Intercom |
| 999 | Not Applicable |
| 999 | Other |
| 999 | Pager |
| 999 | Photocopy |
| 999 | Print |
| 999 | Research -Computer |
| 999 | Research -Paper based |
| 999 | Take Out/Return Paperwork |
| 999 | Telephone - Transfer call |
| 999 | Telephone In |
| 999 | Telephone In - take message |
| 999 | Telephone On Hold |
| 999 | Telephone Out |
| 999 | Telephone Unanswered |
| 999 | Transcribe Doctors Orders |

5—Communication with Whom

| | |
|---|---|
| 999 | Care Management Leader |
| 999 | Doctor - GP |
| 999 | Family Meeting |
| 999 | Hospital Security |
| 999 | Med Student/Resident |
| 999 | OT |
| 999 | Patient |
| 999 | Patient Group |
| 999 | Psychiatrist |
| 999 | Psychologist |
| 999 | Rehab Assistant |
| 999 | RN |
| 999 | Social Worker |
| 999 | Staff Group |
| 999 | Student Nurse |
| 999 | Unit Clerk |
| 999 | Ambulance Service |
| 999 | Central Processing |
| 999 | Clinical Nurse Educator |
| 999 | Clinical Nurse Specialist |
| 999 | Comrnity Transition Tm (CTT) |
| 999 | Community Case Manager |
| 999 | Community Mental Health Tm |
| 999 | Dietician/Nutritionist |
| 999 | Emergency Services - 911 |
| 999 | ER |

6—Topic of Communication

| | |
|---|---|
| 999 | AOL-General |
| 999 | ADL -Patient Hygiene |
| 999 | Administrative |
| 999 | ALC |
| 999 | Appoint/Test |
| 999 | Arrange Meeting/Conference |
| 999 | Arrange Peer Support |
| 999 | Assessment |
| 999 | Bed Availability |
| 999 | Bowel Care |
| 999 | Bowel Habits |
| 999 | Care Plan |
| 999 | Census/Bed Assignment |
| 999 | Concerns and Complaints |
| 999 | Cueing Actin wth Staff/Stdnt |
| 999 | Cueing Action with Patient |
| 999 | Death Related |
| 999 | Diet -Nutrition |
| 999 | Diet -Pt Meals |
| 999 | Directions |
| 999 | Discharge Options/Planning |
| 999 | Doctors Orders |
| 999 | Doctors Orders -clarify |
| 999 | Domestic Violence |
| 999 | Emotionl Supprt for Pt/Famly |
| 999 | Encourage and Motivate Pt |
| 999 | Pt AWOL |
| 999 | Pt Behaviour |
| 999 | Pt Belongings |
| 999 | Pt Certifion/Recerifion |
| 999 | Pt Cognitive Status |
| 999 | Pt Condition Deteriorating |
| 999 | Pt Current Phy Health |
| 999 | Pt Discharge |
| 999 | Pt Family |
| 999 | Pt Financial Issues |
| 999 | Pt Fluid Balance |
| 999 | Pt Glucose Level |
| 999 | Pt Legal Issues |
| 999 | Pt Mental Health |
| 999 | Pt Mobilization |
| 999 | Pt Needs/Privileges |
| 999 | Pt Pain |
| 999 | Pt Personal Goals |
| 999 | Pt Phys and Mentl Hlth Histy |
| 999 | Pt Physical Activity |
| 999 | Pt Progress |
| 999 | Pt Refuse Care/Grp Activites |
| 999 | Pt Rule Adherence |
| 999 | Pt Safety |
| 999 | Pt Support in Community |
| 999 | Pt Support in Home |

Level 1: Main Role + Function

| Level 1 Category | | Code | Field Name | Field Description | CSV Name | | Level | RN_Rank |
|---|---|---|---|---|---|---|---|---|
| 10 | Wash Hands* | 10 | Wash Hands* | It is important to capture the exten | 10 | Wash Hands* | 1 | top |
| 20 | Infection Control | 20 | Infection Control | Infection Control covers activities re | 20 | Infection Control | 1 | top |
| 30 | Interruption | 30 | Interruption | Actions on the part of another indiv | 30 | Interruption | 1 | top |
| 50 | Communication | 50 | Communication | Professionals will engage in commu | 50 | Communication | 1 | top |
| 60 | Travel | 60 | Travel | This section records the travelling a | 60 | Travel | 1 | top |
| 70 | Assess Evaluate | 70 | Assess Evaluate | Identification by a professional of th | 70 | Assess Evaluate | 1 | top |
| 80 | Patient Needs | 80 | Patient Needs | There are a number of tasks and ac | 80 | Patient Needs | 1 | top |
| 90 | ADL | 90 | ADL | Activities of daily living (ADLs): The | 90 | ADL | 1 | top |
| 91 | IADLS | 91 | IADLS | Instrumental Activities of Daily Livin | 91 | IADLS | 1 | main |
| 100 | Medication | 100 | Medication | Related to the drugs or curative sub | 100 | Medication | 1 | main |
| 110 | Treatment | 110 | Treatment | Related to specific patient care and | 110 | Treatment | 1 | main |
| 120 | Documentation | 120 | Documentation | Any documentation including chart | 120 | Documentation | 1 | main |
| 130 | Miscellaneous | 130 | Miscellaneous | Activities that fit outside the other | 130 | Miscellaneous | 1 | main |
| 131 | Equipment | 131 | Equipment | A number of activities that are relat | 131 | Equipment | 1 | main |
| 132 | Housekeeping | 132 | Housekeeping | A number of activities that are relat | 132 | Housekeeping | 1 | main |
| 190 | Waiting* | 190 | Waiting* | Select this option if your profession | 190 | Waiting* | 1 | main |
| 200 | Lunch/Dinner/Break | 200 | Lunch/Dinner/Break* | The professional takes a scheduled | 200 | Lunch/Dinner/Break* | 1 | main |
| 210 | Pause* | 210 | Pause* | If the person you are observing nee | 210 | Pause* | 1 | main |
| 220 | Personal* | 220 | Personal* | Personal activities are not related t | 220 | Personal* | 1 | main |
| 230 | Unusual Incident - | 230 | Unusual Incident - | This is when your professional is dir | 230 | Unusual Incident - | 1 | main |
| | P | | Patient* | | | Pa | | |
| 231 | Unusual Incident - | 231 | Unusual Incident - | This is when your professional is dir | 231 | Unusual Incident - | 1 | main |
| | S | | Staff* | | | St | | |
| 240 | End of Data Collecti | 240 | End of Data Collection* | This is the last entry for your day of | 240 | End of Data Collectio | 1 | main |
| 270 | Patient No Consent | 270 | Patient No Consent* | This field should be used when a pa | 270 | Patient No Consent* | 1 | main |
| 280 | Administration | 280 | Administration | The professional may conduct a nui | 280 | Administration | 1 | main |

Main Master for Level 1 Codes 10-210

| Code | Database Name | Field Name | Short Name | CSV | Name |
|---|---|---|---|---|---|
| Code | Database Name | Field Name | Short Name | CSV | Name |
| 10 | Wash Hands* | Wash Hands* | Wash Hands* | 10 | Wash Hands* |
| 20 | Infection Control | Infection Control | Infection Control | 20 | Infection Control |
| 30 | Interruption | Interruption | Interruption | 30 | Interruption |
| 50 | Communication | Communication | Communication | 50 | Communication |
| 60 | Travel | Travel | Travel | 60 | Travel |
| 70 | Assess Evaluate | Assess Evaluate | Assess Evaluate | 70 | Assess Evaluate |
| 80 | Patient Needs | Patient Needs | Patient Needs | 80 | Patient Needs |
| 90 | ADL | ADL | ADL | 90 | ADL |
| 91 | IADLS | IADLS | IADLS | 91 | IADLS |
| 100 | Medication | Medication | Medication | 100 | Medication |
| 110 | Treatment | Treatment | Treatment | 110 | Treatment |
| 120 | Documentation | Documentation | Documentation | 120 | Documentation |
| 130 | Miscellaneous | Miscellaneous | Miscellaneous | 130 | Miscellaneous |
| 131 | Equipment | Equipment | Equipment | 131 | Equipment |
| 132 | Housekeeping | Housekeeping | Housekeeping | 132 | Housekeeping |
| 170 | Call Bell Respond* | Call Bell Respond* | Call Bell Respond* | 170 | Call Bell Respond* |
| 190 | Listening/Waiting* | Listening/Waiting* | Listening/Waiting* | 190 | Listening/Waiting* |
| 200 | Lunch/Dinner/Break* | Lunch/Dinner/Break* | Lunch/Dinner/Break* | 200 | Lunch/Dinner/Break* |
| 210 | Pause* | Pause* | Pause* | 210 | Pause* |

| Field Description | Level |
|---|---|
| Field Description | Level |
| It is important to capture the extent to which staff members are washing their hands. This includes washing with soap and | 1 |
| Infection Control covers activities related to the professional protecting themselves against infection by putting on/taking | 1 |
| Actions on the part of another individual(s) that disrupt the professional's work activity. For example, a professional may b | 1 |
| Professionals will engage in communication with other staff, patients, family and physicians throughout the shift. Commun | 1 |
| This section records the travelling a professional does on and off the unit. There are specific destinations of travel noted in | 1 |
| Identification by a professional of the needs, preferences and abilities of a patient. Assessment considers the symptoms an | 1 |
| There are a number of tasks and activities that a professional may do over the shift to address the specific needs of patient | 1 |
| Activities of daily living (ADLs): The things we normally do in daily living, including any daily activity we perform for | 1 |
| self-car | |
| Instrumental Activities of Daily Living (IADL): The activities often performed by a person who is living independently in a | 1 |
| co | |
| Related to the drugs or curative substances used to treat disease and illness. | 1 |
| Related to specific patient care and will include traditional treatments such as wound care, as well as psychosocial intervene | 1 |
| Any documentation including charting, updating of files, filling in forms, and reviewing charts. Please select the correct | 1 |
| form | |
| Activities that fit outside the other main categories. | 1 |
| A number of activities that are related to equipment such as cleaning, fixing or checking | 1 |
| A number of activities that are related to general housekeeping and cleaning This may include cleaning the patient's room | 1 |
| The professional responds to a call bell. The professional may not be able to respond to a call bell immediately. Only enter | 1 |
| Select this option if your professional is waiting to speak to a professional, a patient to arrive, a meeting to begin etc. | 1 |
| The professional takes a scheduled lunch/dinner/break. This is NOT a working lunch. | 1 |

If the person you are observing needs to ask you a question or vice versa then you would put the PDA on pause to ensure y 1

| Level 1 | Category | Default | Default_Rank | RN | RN_Rank | UC | UC_Rank | CNL | CNL_Rank |
|---|---|---|---|---|---|---|---|---|---|
| | | | | yes | | | | | |
| Level 1 | Category | Default | Default_Rank | RN | RN_Rank | UC | UC_Rank | CNL | CNL_Rank |
| 10 | Wash Hands* | yes | top | yes | top | yes | top | yes | main |
| 20 | Infection Control | yes | top | yes | top | yes | main | yes | main |
| 30 | Interruption | yes | top | yes | top | yes | top | yes | main |
| 50 | Communication | yes | top | yes | top | yes | main | yes | main |
| 60 | Travel | yes | top | yes | top | yes | main | yes | main |
| 70 | Assess Evaluate | yes | top | yes | top | yes | main | yes | main |
| 80 | Patient Needs | yes | top | yes | top | yes | main | yes | main |
| 90 | ADL | yes | top | yes | top | yes | main | yes | main |
| 91 | IADLS | yes | main | yes | main | yes | main | yes | main |
| 100 | Medication | yes | main | yes | main | yes | main | yes | main |
| 110 | Treatment | yes | main | yes | main | yes | main | yes | main |
| 120 | Documentation | yes | main | yes | main | yes | main | yes | main |
| 130 | Miscellaneous | yes | main | yes | main | yes | main | yes | main |
| 131 | Equipment | yes | main | yes | main | yes | main | yes | main |
| 132 | Housekeeping | yes | main | yes | main | yes | main | yes | main |
| 170 | Call Bell Respond* | yes | main | yes | main | yes | main | yes | main |
| 190 | Waiting* | yes | main | yes | main | yes | main | yes | main |
| 200 | Lunch/Dinner/Break | yes | main | yes | main | yes | main | yes | main |
| 210 | Pause* | yes | main | yes | main | yes | main | yes | main |

| Ward Aide | Ward Aide_Rar | Therapist | Therapist_Ran | Physician | Physician_Rank | | |
|---|---|---|---|---|---|---|---|
| Ward Aide | Ward Aide_Ra | Therapist | Therapist_Ran | Physician | Physician_Ran | SW | SW_Rank |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |
| yes | main | yes | main | yes | main | yes | main |

### Example 3

A model was developed using a discrete-event simulation package called Arena 11.0 from Rockwell Software along with significant use of Visual Basic for Applications (VBA) for customized logic and to interface with the MS Access relational database management system. Software code is loaded into palm held devices (Palm ZIRE PDAs) and data gatherers collect real-time practice data through one-on-one observations across the six levels of information hierarchy per FIG. 7.

A precursor to running the Simulation Model is a Data Pre-processing and Analysis phase. Several data sources are imported, assembled and processed so as to consolidate the data in a central location (for efficiency aspects upon model initialization) and to address issues such as: duplicate data, inconsistent data formats, inconsistent activity descriptions, potential data collection errors, potential data import errors, lack of information on patient location, lack of information on activity locations, and lack of information on travel origin and destination.

There are four types of data sources:
1. Function Analysis Data (provided as Excel files for each resource type)
2. Discharge Abstract Data (DAD) (provided as Access database)
3. Admission Discharge Transfer (ADT) (provided as Access database)
4. Other reference tables (e.g. patient MRN lookup table, resource shift look up table, etc)

Each data source was imported to a separate Access database and then assembled into one central Access database. ADT data was used to specify which patients were located on which bed at any given time. DAD data was used to enrich the Function Analysis data by including patient episode characteristics such as Case Mix Group and Major Clinical Category. Next, the data was processed to eliminate duplicate records and to correct obvious data collection errors (such as incorrect data collection and/or activity date/times). Fourteen key activity types were identified and activity descriptions were standardized using these key activity types.

The simulation model contains two main elements:
Logic: The logic element is the brain that drives the entire process. It reproduces all processes performed on the ward at any given location, and records the performance of resources and patients.
Animation: The model animation provides a visual representation of the model logic. It recreates the ward [symbol] ¦s floor plan and allows users to visualize patients and resources as they perform their activities, providing a more intuitive perspective of the system [symbol] ¦s behaviour.

The program logic of the simulation model is designed to first generate entities (including resources and patients) and then perform the activities at locations and times as the data dictates. The model records information such as start and end times of the activities, the resource that performed the activity, idle times, non productive times, etc. The recorded data elements are used to analyze the impact of different scenarios such as reassigning activities to other resources, adding new resources, prioritizing activities, etc.

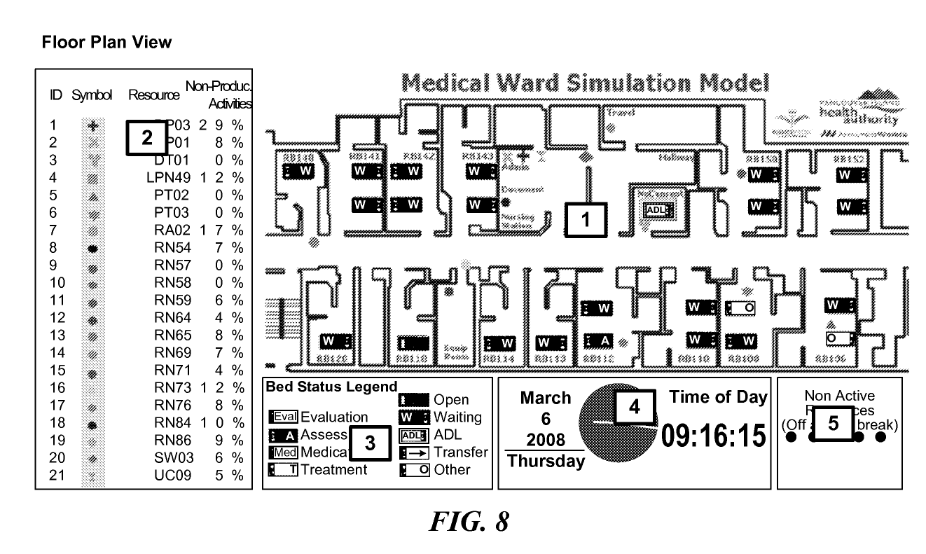

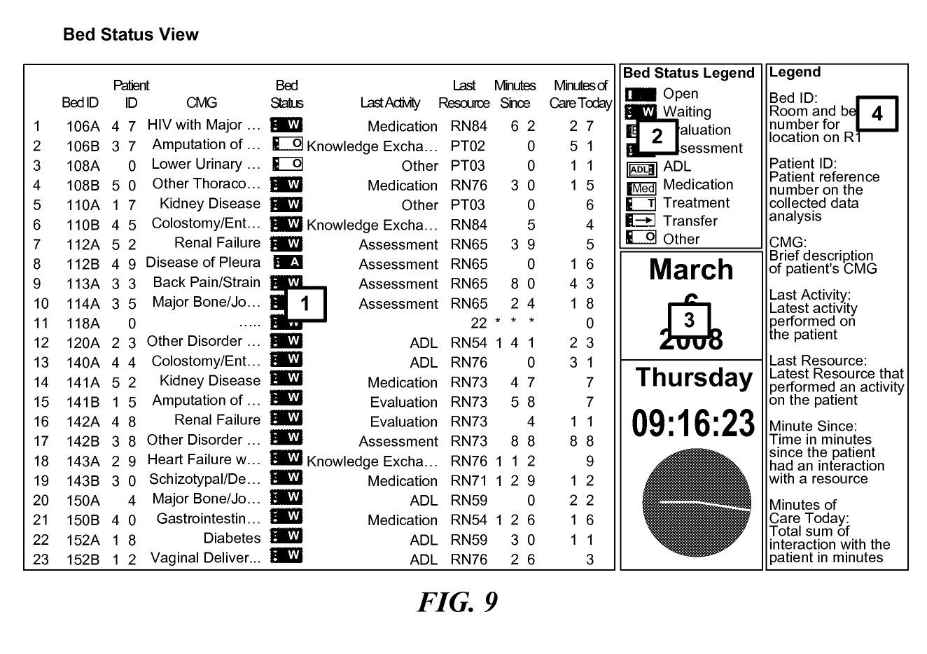

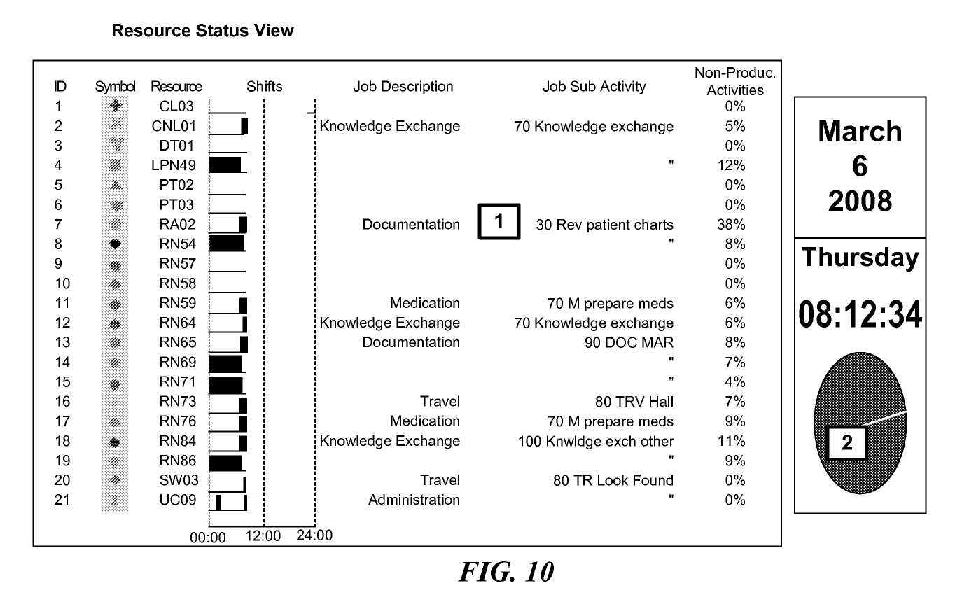

In order to assess the impact of alternate processes, skill mixes, and service demands on resource requirements, a detailed task-level simulation model was designed and developed. The model has three views:
Floor Plan View (FIG. 8)
Bed Status View (FIG. 9)
Resource Status View (FIG. 10)

1. Floor Plan: Shows a simple two dimensional view of the ward. For this exercise, a general nursing station was established as a centralized location. All documentation and administration related activities are performed here.

2. Resources Info: This shows a legend of all resources involved in the activities performed on the current simulation day. Each resource type is classified by a different shape (e.g. all nurses are represented by circles). Percentage of non-productive activities represents the percentage of time spent on non-productive activities performed by each resource. Non-productive activities include travel activities such as looking for equipment, staff, medication and dropping off medications.

3. Bed Status Legend: As activities are performed on the patient, beds will change color to illustrate the type of activity. A green bed signifies that the bed is not occupied, while other activities are represented by different colors and symbols. There is also a patient population that did not give the consent to be identified along with the activities performed on them. In the simulation, these activities are performed on the bed with a yellow frame. In addition, activities performed on patients labeled as “Patient Other” or “Multiple Patient” are performed in this bed as well.

4. Calendar and Clock: This shows the current date and time of the simulation.

5. Non Active Resources: This shows all resources that are currently on breaks or resources waiting for there next shift to start.

1. Bed Status: This shows the following information:
a. Bed ID: All beds have a unique identifier. All beds illustrated on the Floor View are listed here (excluding the yellow no-consent bed).
b. Patient ID: A unique identifier for the patient that is occupying the bed.
c. CMG: Shows a brief description of the Case Mix Group (CMG) of the patient.
d. Bed Status: Shows the current status of the bed (legend below).
e. Last Activity: Indicates the last activity performed on the patient.
f. Last Resource: Shows the code of the resource that performed the last activity on the patient.
g. Minutes Since: Indicates how many minutes have passed since the last activity performed on the patient.
h. Minutes of Care: Shows the total minutes of care (i.e., activities) performed on the patient on the given day.

2. Bed Status Legend: As activities are performed on the patient, beds will change color to illustrate the type of activity. Bed in green signifies the bed is not occupied, while other activities are represented by different colors and symbols.

3. Calendar and Clock: This shows current date and time of the simulation.

4. Legend: Shows a brief explanation of the elements of the Bed Status View.

1. Resource View: This section shows the following information:
a. ID, Symbol, Resources: Identifies resources used during the day, each resource type is classified by a different shape, e.g. all nurses are represented by circles.
b. Shifts: Illustrates when shifts start and end during the day. The blue box represents that the associated resource is on duty within the corresponding time.
c. Job Description: Indicates the current activity being performed by the resource.
d. Job Sub Activity: Describes in more detail the current job being performed. It relates to the second level of activity description “A2” used in the data collection.
e. Patient: Indicates the unique identifier of the patient in care. Note: 54 indicates a “Non Consent Patient”, 55 is for “Other Patient” and 56 refers to “Multiple Patient”.
f. Non-Productive Activities: This column will represent the percentage of time spent on non-productive activities performed by each resource. Non-productive activities include travel activities such as looking for equipment, staff, medication and dropping off medications.

2. Calendar and Clock: This shows current date and time of the simulation.

The ward model logic is structured in six major segments; each of these may be linked to one or more stations, indicating that several stations may follow the same logical processes. Stations represent specific locations on the ward. In our model, the logic for these processes is as follows:
1. Populating Activities Arrays: All the input tables generated during data pre-processing are read here. These include all set up tables and activity related tables. No stations are linked to this process since it is only used for setting up the model at the beginning of the simulation run.
2. Generate Nurses: A “Nurse Home” station is linked to this process where all resources (Nurses, Clerks, Dieticians, etc.) are created to start the simulation. In addition, the resources return to this station when they are done with their activities. The first activity of each resource is assigned here.
3. Admission: Patients are generated and sent to admission where the bed is assigned to the patients. The resource in charge of carrying out the admissions comes through this process to pick up the patient and bring him/her to corresponding bed.
4. Nurse Station: All administrative activities are contained in this block of processes. Stations such as Documentation, Nurse Station, and Administration are all linked here. Also, non-productive activities like travel to hall or looking for equipment are performed through this section of logic.
5. Ward: All beds are linked to this process block. Activities such as medication and treatment take place here.
6. Discharge: For discharge, patients are taken to the Discharge Station were the final process takes place.

Immediately following each process, except admission, resources generate statistics related to the activity they are performing. Then the next activity and destination are assigned as the resource leaves the station. The model was verified against the FA input datasets by matching up output data generated by the simulation model against the FA input data by ensuring equivalency of the activity details (such as activity type, start time, finish times, durations, etc.). Since it is a data-driven model, care was taken to ensure the simulation accurately represented the data it was being fed.

### Initial Findings

The initial study area was in a medical and surgical population (predominantly geriatric in nature). The question was: what is the potential impact of realigning how health care delivery is performed by augmenting the care team with one Assistive Personnel in both a day-shift and a night-shift scenario when a RN is not available?

Three different locations were studied in three acute care hospitals in British Columbia, with a normal 12-hour shift pattern (day shift was 7 am-7 pm).

Key Performance Indicators (KPI) for this study focus on (1) Reduction in Resource RN care hours per patient day and (2) Change in timing or delays in patient care activities.

Table 1 summarizes the outcomes of the study (note: Since wards in Hospital 3 were smaller than at the other two locations, we looked at two scenarios). The methodology was based on real-time practice data collection at each of the hospitals for the number of days indicated—in this case, a full day-shift and night-shift were recorded. Data Pre-processing and Analysis was then performed—this typically compressed the raw collected data by approximately 60%. Following model verification, the analysis was made for the instance of one RN being replaced by one Assistive Personnel. The KPIs are quoted for the day shift only as we found that there were insufficient RN hours during a night shift that could be delegated to Assistive Personnel. Interestingly, if we do review the whole 24 hour period at each hospital, the reduction in RN hours is quite similar, namely Hospital 1 (15%), Hospital 2 (15%) and Hospital 3 (11%).

The predicted outcomes were revealing with a level of consistency across the hospitals when one includes likely ward sizes. Expected outcomes from this work could form the basis for further detailed study, and model enhancements, so as to enable the following:
Compiling files collapse the hierarchical data into one line of data
increased ability for the Health Authority to refine and predict staffing needs;
increased ability for the Health Authority to refine and predict Assistive Personnel needs; and,
increased understanding of RN availability given the use of an additional Assistive Personnel.

The analysis presented through the FA system offers a level of quantifiable insight to all stakeholders that is simply not available through spreadsheets, flowcharts, or PowerPoint presentations. Decision makers can, with this method and system be armed with an understanding of the current state of their organizations and be presented with data which quantifies the impacts of “what-if” change before critical decisions are taken.

TABLE 1
Results Summary

| | | | KPI | | |
|---|---|---|---|---|---|
| | | | Reduc- | Average | |
| | Days of | Replace # | tion | minutes | |
| | Data Col- | of RN with | of RN | delay per | |
| Hospital | lection | Care Aide | Hours* | Task | Comments |
| Hospital | 1 | 1 | 13.0% | 2.9 | |
| 1 | | | | | |
| Hospital | 1 | 1 | 6.3% | 4.7 | |
| 2 | | | | | |
| Hospital | 1 | 0.5 | 4.4% | 4.3 | Two predictive |
| 3 | | | | | runs were made |
| | | | | | as wards were |
| | | | | | smaller |
| | | 1 | | 13.8 | |

*Day Shift only

TABLE 2
Description of the Data Dictionary Typology

| | | Operational Definition: | Criteria (the qualities that determine appropriateness for | |
|---|---|---|---|---|
| | | “description of term as applied to a specific | inclusion and position of elements within the data dictionary} | |
| | | situation to facilitate the collection of | Inclusion Criteria (what is | Exclusion Criteria (what is |
| | | meaningful standardized data” - overarching | considered when deciding to | considered - when deciding to |
| Level | Name | principle | INCLUDE content at this level?) | EXCLUDE content at this level?) |
| Level 1 | Primary Activity | Represents the main roles, functions, and/or | Activities of high cumulative | Ability to |
| | | activities of the person under observation and | duration. | accurately observe. |
| | | includes: | Activities of high | How much data |
| | | Unit/Environment-Related: Activities | importance/relevance that | can an observer |
| | | associated with the nursing | occur instantaneously (occur | reasonably collect? |
| | | unit/environment that are not patient- | in such short duration that | How would this |
| | | specific, including activities related to | subsequent levels of coding | information |
| | | travel, equipment, look for, miscellaneous, | are not feasible). | contribute the |
| | | housekeeping, code situation. | Activities of high | answering the |
| | | FA-Related: Activities associated with the | importance/relevance or | research question? |
| | | Function Analysis study itself; appears as | duration that are related to | |
| | | “Pause”, “FA Research Project” (includes | external circumstances. | |
| | | interview at end of day, speaking about the | | |
| | | project), “End of Data Collection”. | | |
| | | Personal: Personal activities not related to | | |
| | | patient care or unit activities such as lunch, | | |
| | | dinner, breaks, and personal | | |
| | | communication (telephone, email). | | |
| Level 2 | Sub Activity | Represents the sub-activities of Level 1, | May depend upon the | |
| | | providing a greater level of | research question. | |
| | | specificity/refinement to the Level 1 Primary | Can be stated as an action | |
| | | Activity Areas. | verb (e.g., I am patient | |
| | | | charting) | |
| Level 3 | Patient Link | Represents the patient(s) with/for/about whom | None. | |
| | | the Level 1 and 2 activities pertain. | | |
| Level 4 | Mode of Primary | Represents the mode (manner, means or | May depend upon the | |
| | or Sub Activity | method) employed to complete a Level 1/Level | requirements of the research | |
| | | 2 activity. | question. | |
| | | | Can be stated as a noun. | |
| Level 5 | Communication | Represents the people, department, agency or | Includes the network of | |
| | with Whom | organization with whom the professional is | people required to meet the | |
| | | directly interacting. | care needs of the patient | |
| Level 6 | Topic of | Represents the subject of the communication. | | |
| | Communication | | | |

### Example 4

The FA system has been utilized extensively to produce robust scientific classification of health professionals' work activities within their practice settings and to guide strategic decision-making in other participating provincial Health Authorities. The FA protocol is comprehensive and provides both quantitative and qualitative data to inform care delivery model redesign. Expected results from moving to new models of care are aimed at higher quality of services, improved fiscal effectiveness and improved quality of work life for staff.

I claim:

1. An integrated method for optimizing productivity and performance of a workforce (comprising at least one person) within a workspace, comprising the steps of:
a) acquiring at least one real time, continuous, data point set relating to said workforce, which includes data points relating to all activities, roles and functions of a person within a selected time frame, such data set being measured down to the level of a second (the “benchmark data point set”);
b) measuring and comparing the benchmark data point set against previously compiled data points from within a usefully comparable, like workforces within a like workplaces and timeframes (the “comparable data point set”);
c) utilizing differences and similarities between the benchmark data point set and the comparable data point set to produce simulation models which identify and direct specific improvements to be made to increase the productivity and performance of the workforce.

2. The method of claim 1 wherein the workplace is selected from the group consisting of a hospital, an acute care facility, an extended care facility, a psychiatric facility, and a geriatric facility.

3. The method of claim 1 wherein, prior to step a), data dictionaries are created which relate to each person in the workforce.

4. The method of claim 1 wherein the benchmark data point set is continuous and multi-dimensional.

5. The method of claim 1 wherein the benchmark data point set is acquired and recorded by an observer in the workspace using a hand or palm-held electronic device.

6. The method of claim 1 wherein the benchmark data point set comprises granular quantitative data which is augmented by qualitative data.

7. A computer implemented method of optimizing productivity and performance of a workforce (comprising at least one person) within a workspace, comprising the steps of:
a) acquiring at least one real time, continuous, data point set relating to said workforce, which includes data points relating to all activities, roles and functions of a person within a selected time frame, such data set being measured down to the level of a second (the “benchmark data point set”);
b) measuring and comparing the benchmark data point set against previously compiled data points from within a usefully comparable, like workforces within a like workplaces and timeframes (the “comparable data point set”);
c) utilizing differences and similarities between the benchmark data point set and the comparable data point set to produce simulation models which identify and direct specific improvements to be made to increase the productivity and performance of the workforce.

8. A computer-readable storage medium having computer-executable code encoded therein for collecting, analyzing, comparing and displaying the benchmark data point set and comparable data point set of claim 7.
